(19) United States
(12) Patent Application Publication
(10) Pub. No.: US 2016/0231664 A1
(43) Pub. Date: Aug. 11, 2016

(54) IMAGE FORMING APPARATUS

(71) Applicant: CANON KABUSHIKI KAISHA, Tokyo (JP)

(72) Inventor: Norihiko Kubo, Toride-shi (JP)

(21) Appl. No.: 15/015,234

(22) Filed: Feb. 4, 2016

(30) Foreign Application Priority Data
Feb. 6, 2015 (JP) 2015-022736
Feb. 6, 2015 (JP) 2015-022737
Feb. 6, 2015 (JP) 2015-022738

(51) Int. Cl. G03G 15/00

(52) U.S. Cl. CPC G03G 15/0266

(57) ABSTRACT

An image forming apparatus includes a photosensitive member, a charging member, a voltage source, an exposure device, a developing device, a transfer device, and a controller for executing an image forming operation in which the toner image is formed depending on an inputted image signal and then is transferred onto a transfer material which is then outputted and for executing a test operation in which a test image for obtaining information on a remaining lifetime of the photosensitive member is formed and transferred onto the transfer material which is then outputted. The controller applies a voltage in the form of a DC voltage biased with an AC voltage to the charging member during the image forming operation and applies only a DC voltage to the charging member to electrically charge the photosensitive member thereby to form the test image in the test operation.

### FIELD OF THE INVENTION AND RELATED ART

The present invention relates to an image forming apparatus, such as a copying machine, a printer or a facsimile machine, of an electrophotographic type.

As an electrophotographic photosensitive member used in the image forming apparatus of the electrophotographic type, from advantages such as low cost and high productivity, an organic photosensitive member prepared by providing a photosensitive layer (organic photosensitive layer) using an organic material as a photoconductive substance (such as a charge generating substance or a charge transporting substance) on a supporting member comes into wide use. Particularly, a rotatable drum-shaped (cylindrical) photosensitive drum has been widely used.

As the organic photosensitive member, from advantages such as high sensitivity and material design, a photosensitive member having a lamination type photosensitive layer goes main stream. The lamination type photosensitive layer is constituted by laminating a charge generating layer containing a charge generating substance such as a photoconductive dye or a photoconductive pigment and a charge transporting layer containing a charge transporting substance such as a photoconductive polymer or a photoconductive low-molecular-weight compound.

Incidentally, to a surface of the photosensitive member, either one or both of an electrical external force and a mechanical external force are applied in charging, exposure, development and cleaning. For that reason, the photosensitive member is required to have durability against surface damage and generation of abrasion due to these external forces. Specifically, the durability against the surface damage and the generation of the abrasion, i.e., anti-damaging property (scratch resistance) and anti-wearing property are required. As a technique for improving the anti-damaging property and the anti-wearing property of the surface of the photosensitive member, the following photosensitive members are known. That is, the photosensitive members includes a photosensitive member having a cured layer, as a surface layer, using a curable resin as a binder resin, a photosensitive member having a cured charge transporting layer, as a surface layer, formed by curing and polymerizing a composition of a monomer having a carbon-carbon double bond and a charge transporting monomer having a carbon-carbon double bond through heat energy or light energy, and a photosensitive member having a cured charge transporting layer, as a surface layer, formed by curing and polymerizing a hole transporting compound having a chain polymerizable functional group in one molecule through electron beam energy. In this way, in recent years, as the technique for improving the anti-damaging property and the anti-wearing property of a peripheral surface of the photosensitive member, a technique or enhancing a mechanical strength of the surface layer of the photosensitive member by using the cured layer as the surface layer is employed.

However, when image formation is effected using the member having a high hardness, particularly in a high-humidity environment, a blur of an electrostatic latent image which is called an “image deletion (flow” is liable to generate. A cause of the generation of the image deletion would be considered as follows. That is, electric discharge products such as ozone and NOx are generated principally by a charging means and are deposited on the surface of the photosensitive member. The surface of the photosensitive member is not only low in skin-friction coefficient μ but also hard, and therefore is not readily abraded, so that the discharge products deposited thereon is not readily removed. Then, the discharge products which are deposited on the member surface and which are not readily removed take up moisture in the high-humidity environment, and lower charge retentivity of the surface of the photosensitive member, so that the discharge products generation the blur of the electrostatic latent image. Accordingly, particularly in the case where the hardness of the photosensitive member is high, the deposited discharge products are not readily removed further, so that the image deletion is liable to generate.

As a countermeasure against the image deletion, it is in general that a heater is provided inside or in the neighborhood of the photosensitive member and then the surface of the photosensitive member is increased in temperature and thus is dried. However, when the image formation is effected in a stage, such as immediately after main switch actuation, in which an effect of the heater is not sufficiently obtained, the image deletion generates in some instances. Particularly, in recent years, from the viewpoint of energy saving, an image forming apparatus in which the heater is not mounted exists.

Therefore, Japanese Laid-Open Patent Application 2007-233357 discloses, for the purpose of preventing the image deletion, a technique using a photosensitive member having a plurality of independent recessed portions on the surface thereof. However, even in the photosensitive member having a high hardness, after use for a long term, a surface layer is gradually abraded by rubbing or the like with a cleaning blade. With this abrasion, a depth of the recessed portions gradually becomes shallow in the photosensitive member having the recessed portions at the surface of the photosensitive member.

It is turned out that with respect to the image deletion, an effect is higher with deeper recessed portions, so that when the recessed portions become shallow as described above, there is a liability that an image defect due to the image deletion generates. For that reason, in the case where the depth of the recessed portions decreases due to the abrasion of the member, it is desired that the photosensitive member is exchanged at proper timing.

The decrease in depth of the recessed portions can be predicted by estimating an abrasion amount of the photosensitive member by counting an image output sheet number of image formation effected using the photosensitive member, a rotation time of the photosensitive member or a charging time of the photosensitive member. However, in general, the depth of the recessed portions of the photosensitive member surface is several μm at the maximum, so that it is difficult to accurately predict (estimate) a small abrasion amount leading to the decrease in depth of the recessed portions. For that reason, it is required that the decrease in depth of the recessed portions due to the abrasion of the photosensitive member is detected directly with high accuracy and thus a remaining lifetime of the photosensitive member is grasped with accuracy.

### SUMMARY OF THE INVENTION

A principal object of the present invention is to provide an image forming apparatus capable of accurately grasping a remaining lifetime of a photosensitive member depending on a depth of recessed portions on a surface of the photosensitive member.

According to an aspect of the present invention, there is provided an image forming apparatus comprising: a photosensitive member provided with a plurality of independent recessed portions on a surface thereof; a charging member, provided closely to or in contact with the photosensitive member, for electrically charging the photosensitive member; a voltage source for applying, to the charging member, a charging voltage for electrically charging the charging member; an exposure device for exposing, to light, the photosensitive member charged by the charging member to form an electrostatic image; a developing device for developing the electrostatic image formed on the photosensitive member by the exposure device into a toner image with a toner; a transfer device for transferring, onto a transfer material, the toner image formed on the photosensitive member by the developing device; and a controller for executing an image forming operation in which the toner image is formed depending on an inputted image signal and then is transferred onto the transfer material which is then outputted and for executing a test operation in which a test image for obtaining information on a remaining lifetime of the photosensitive member is formed and transferred onto the transfer material which is then outputted, wherein the controller applies a voltage in the form of a DC voltage biased with an AC voltage to the charging member during the image forming operation and applies only a DC voltage to the charging member to electrically charge the photosensitive member thereby to form the test image in the test operation.

Further features of the present invention will become apparent from the following description of exemplary embodiments with reference to the attached drawings.

### BRIEF DESCRIPTION OF THE DRAWINGS

FIG. 1 is a schematic sectional view of an image forming apparatus.

FIG. 2 is a schematic view of an image forming portion.

FIG. 3 is a schematic view of a surface of a photosensitive member having specific recessed portions.

In FIG. 4, (a) and (b) are schematic sectional views each showing a layer structure of a photosensitive member.

FIG. 5 is a graph showing an example of progression of a depth of the specific recessed portions of the surface of the photosensitive member.

In FIG. 6, (a) is a schematic sectional view showing an electric discharge region in the neighborhood of a charging nip, and (b) is a graph showing an example of a relationship between a gap between a charging roller and an electric discharge start voltage.

FIG. 7 is a graph showing a relationship between a maximum gap α in which electric discharge generates and the depth of the recessed portions of the surface of the photosensitive member.

In FIG. 8, (a) to (c) are schematic views each showing an example of a pattern of a test image.

FIG. 9 is a block diagram showing a control embodiment in a test operation.

FIG. 10 is a timing chart showing a sequence of the test operation.

In FIG. 11, (a) is a schematic view showing an example of the test image to be outputted in the test operation, and (b) includes schematic views showing an example of the test image (left side) and an example of a comparison test image (right side).

In FIG. 12, (a) and (b) are schematic views each showing an example of a state of a lateral (horizontal) stripe in an outputted test image.

FIG. 13 is a schematic view showing an example of a corresponding chart for discriminating a remaining lifetime of the photosensitive member.

In FIG. 14, (a) and (b) are schematic views of an optical sensor.

FIG. 15 is a graph showing an example of a density difference ΔD of the test image detected by the optical sensor.

FIG. 16 is a graph showing an example of a relationship between the density difference ΔD of the test image and the remaining lifetime of the photosensitive member.

In FIG. 17, (a) and (b) are schematic views each showing another example of the pattern of the test image.

FIG. 18 is a block diagram showing another example of the control embodiment in the test operation.

FIG. 19 is a timing chart snowing another example of the sequence in the test operation.

In FIG. 20, (a) is a schematic flowchart of the test operation, and (b) is a schematic flowchart of a remaining lifetime notification operation.

FIG. 21 is a graph showing an example of a relationship between a DC voltage value and a charge potential of the photosensitive member in each of a DC charging method and an AC+DC charging method.

FIG. 22 is a schematic view showing a decrease in depth of the recessed portion of the photosensitive member surface caused due to abrasion of the photosensitive member.

FIG. 23 includes tables each for illustrating a relationship between a pre-exposure amount and a generation level of the lateral stripe in an electric discharge pattern of a charging portion of a photosensitive member in Embodiment 5.

FIG. 24 is a block diagram showing a control embodiment in a test operation in Embodiment 5.

FIG. 25 is a timing chart showing a sequence of the test operation in Embodiment 5.

In FIG. 26, (a) is a schematic view showing a test image to be outputted in the test operation in Embodiment 5, and (b) includes schematic views showing a test image (left side) and a comparison (right side).

FIG. 27 is a block diagram showing a control embodiment in a test operation in Embodiment 7.

FIG. 28 is a timing chart showing a sequence of the test operation in Embodiment 7.

In FIG. 29, (a) is a schematic flowchart of a test operation in Embodiment 8, and (b) is a schematic flowchart of a remaining lifetime notification operation in Embodiment 8.

FIG. 30 is a block diagram showing a control embodiment in a test operation in Embodiment 9.

FIG. 31 includes tables each for illustrating a relationship between a rotational speed of a photosensitive member and a generation level of the lateral stripe in an electric discharge pattern of a charging portion of a photosensitive member in Embodiment 9.

FIG. 32 is a timing chart showing a sequence of the test operation in Embodiment 9.

In FIG. 33, (a) is a schematic view showing a test image to be outputted in the test operation in Embodiment 9, and (b) includes schematic views showing a test image (left side) and a comparison (right side).

FIG. 34 is a block diagram showing a control embodiment in a test operation in Embodiment 11.

FIG. 35 is a timing chart showing a sequence of the test operation in Embodiment 11.

In FIG. 36, (a) is a schematic flowchart of a test operation in Embodiment 12, and (b) is a schematic flowchart of a remaining lifetime notification operation in Embodiment 12.

### DESCRIPTION OF THE EMBODIMENTS

An image forming apparatus according to the present invention will be specifically described with reference to the drawings.

### Embodiment 1

### 1. General Structure and Operation of Image Forming Apparatus

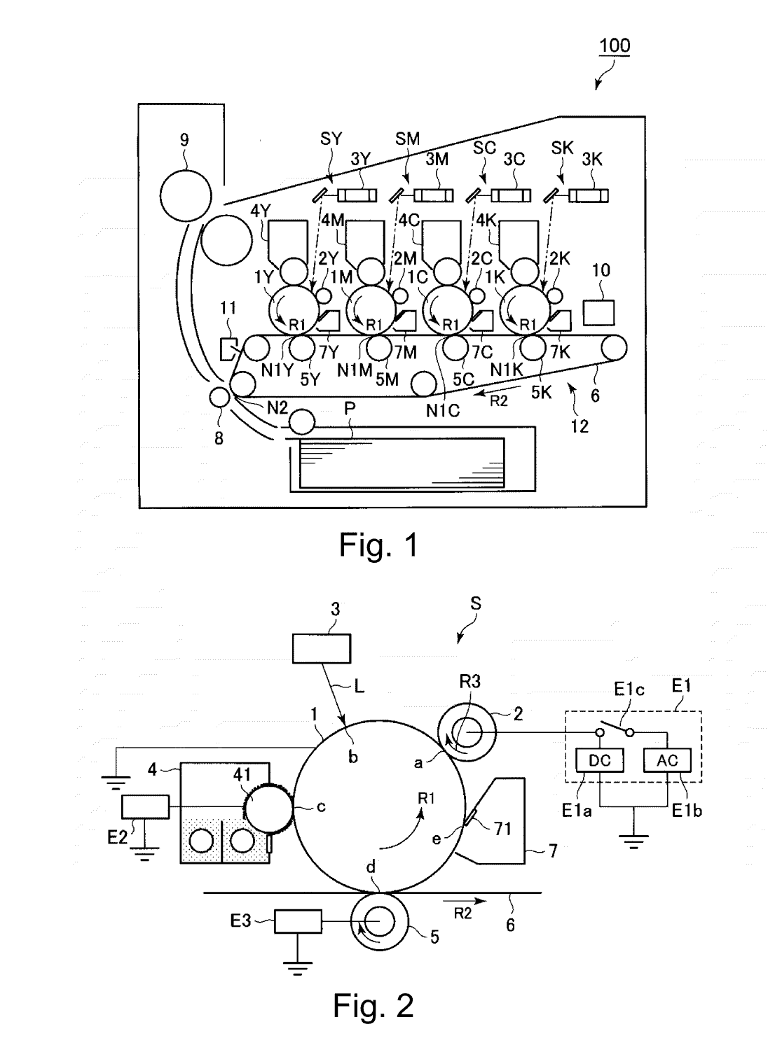

FIG. 1 is a schematic sectional view of an image forming apparatus 100 according to Embodiment 1 of the present invention. The image forming apparatus 100 in this embodiment is a tandem-type full-color laser beam printer which is capable of forming a full-color image using an electrophotographic process and which employs a contact charging type and an intermediary transfer type.

The image forming apparatus 100 includes first to fourth image forming portions SY, SM, SC, SK as a plurality of image forming portions. The image forming portions SY, SM, SC, SK form toner images of colors of yellow (Y), magenta (M), cyan (C), black (K), respectively. In this embodiment, constitutions and operations of the image forming portions SY, SM, SC, SK are substantially the same except that colors of toners used are different from each other. Accordingly, in the case where there is no need to particularly distinguish elements for the colors, suffixes Y, M, C, K for representing the colors for the elements are omitted, and the elements will be collectively described.

FIG. 2 is a schematic sectional view specifically showing a structure of the image forming portion S. In this embodiment, the image forming portion S is constituted by a photosensitive member 1, a charging roller 2, an exposure device 3, a developing device 4, a primary transfer roller 5 and a photosensitive member cleaning device 7.

First, the image forming apparatus 100 includes a rotatable drum-shaped (cylindrical) photosensitive member (photosensitive drum) 1 as an image bearing member. In this embodiment, the photosensitive member 1 is an organic photosensitive member having a negative chargeability as a charging characteristic, and has a lamination structure in which on a surface of an aluminum cylinder (electroconductive support), a photo-charge generating layer formed of an organic material and a charge transporting layer (thickness: about 20 μm) are laminated in this order. Here, a surface (skin) layer of the photosensitive member 1 is a cured layer formed using a curable resin as a binder resin. The photosensitive member 1 is exchangeable (replaceable) in the case where the surface layer of the photosensitive member 1 is abraded by abrasion by use of the member 1, and discrimination that there is a need to exchange the photosensitive member on the basis of a test operation described later is made. The photosensitive member 1 may be configured so that substantially only the photosensitive member 1 is exchangeable so as to be detachably mountable to an apparatus main assembly of the image forming apparatus 100 or may also be configured so that the photosensitive member 1 is assembled with other process devices into a process cartridge which is exchangeable so as to be detachably mountable to the apparatus main assembly. The process cartridge is prepared by Integrally assembling the photosensitive member and at least one of a charging means, a developing means and a cleaning means which are process means actable on the photosensitive member, into a unit (cartridge) which is detachably mountable to the apparatus main assembly of the image forming apparatus 100.

In this embodiment, as the surface layer of the photosensitive member 1, the cured layer using the curable resin as the binder resin was used, but is not limited thereto. As the cured layer, the following layers can be used. That is, the cured layer includes a cured charge transporting layer, formed by curing and polymerizing a composition of a monomer having a carbon-carbon double bond and a charge transporting monomer having a carbon-carbon double bond through heat energy or light energy, and a photosensitive member having a cured charge transporting layer, as a surface layer, formed by curing and polymerizing a hole transporting compound having a chain polymerizable functional group in one molecule through electron beam energy.

In this embodiment, the photosensitive member 1 is 340 mm in length with respect to a longitudinal direction (rotational axis direction) and 30 mm in outer diameter, and is rotated about a center supporting shaft at a process speed (peripheral speed) of 300 nm/sec in an arrow R1 direction in FIG. 2. In this embodiment, on the surface of the photosensitive member, a flat portion and a plurality of recessed portions are formed, and will be described later in detail.

The image forming apparatus 100 includes the charging roller 2 which is a roller-shaped contact charging member as the charging means for electrically charging uniformly the surface of the photosensitive member 1. The charging roller 2 is 330 nm in length with respect to a longitudinal direction (rotational axis direction) and 14 mm in diameter and has a structure in which an electroconductive rubber layer is formed around a core metal (core material) of stainless steel. The charging roller 2 is rotatably supported by bearing members at longitudinal end portions of the core metal and is urged toward the photosensitive member 1 by an urging spring. As a result, the charging roller 2 is press-contacted to the surface of the photosensitive member 1 at a predetermined pressure (urging force), so that a charging nip which is a press-contact nip is formed between the charging roller 2 and the photosensitive member 1. The charging roller 2 is rotated (at a peripheral speed of 300 mm/sec) in an arrow R3 direction in FIG. 2 by rotation of the photosensitive member 1. At a charging portion a, the charging roller 2 charges the photosensitive member 1 by using an electric discharge phenomenon generating at a minute gap between itself and the photosensitive member 1. To the charging roller 2, a charging voltage (charging bias) is applied via the core metal under a predetermined condition by a charging voltage source (high voltage source) E1 as a voltage applying means. In this embodiment, the charging voltage source E1 is constituted by including a DC voltage source portion E1a and an AC voltage source portion E1b. For example, an applied DC voltage component (charging DC voltage) is set at −500 V, and an applied AC voltage component (charging AC voltage) is set at a peak-to-peak voltage value which is twice or more a discharge start voltage in an associated environment. In this case, immediately after passing through the charging portion a, the surface of the rotating photosensitive member 1 is uniformly charged to about −500 V. The charging DC voltage applied during image formation is not limited to this value, but may appropriately be set to a potential suitable for good image formation depending on the environment and a repetitive operation status (operation (use) amount from an initial use) of the photosensitive member 1 and the charging roller 2.

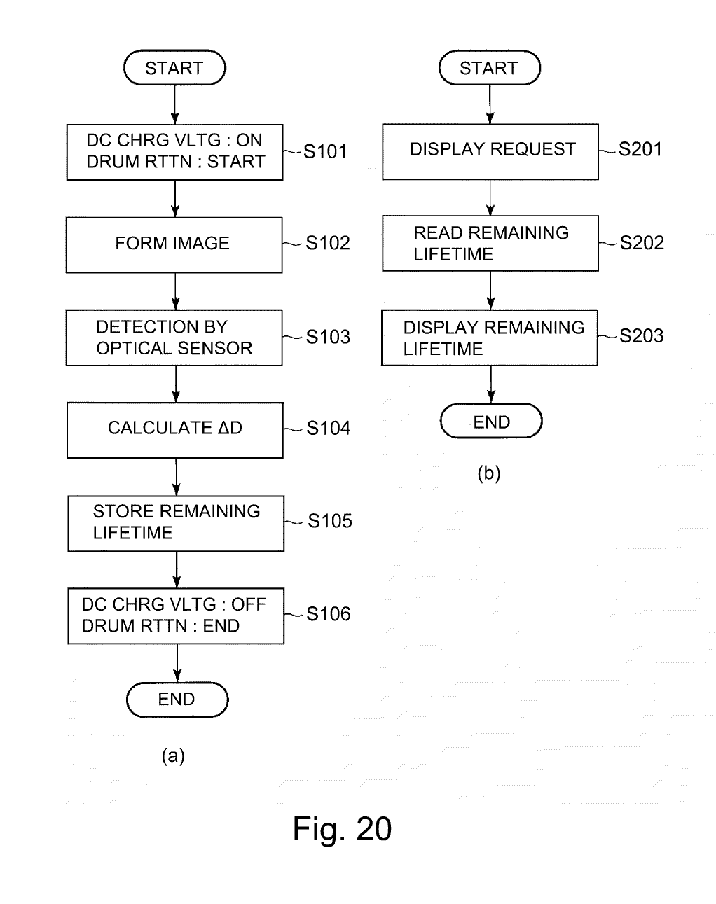

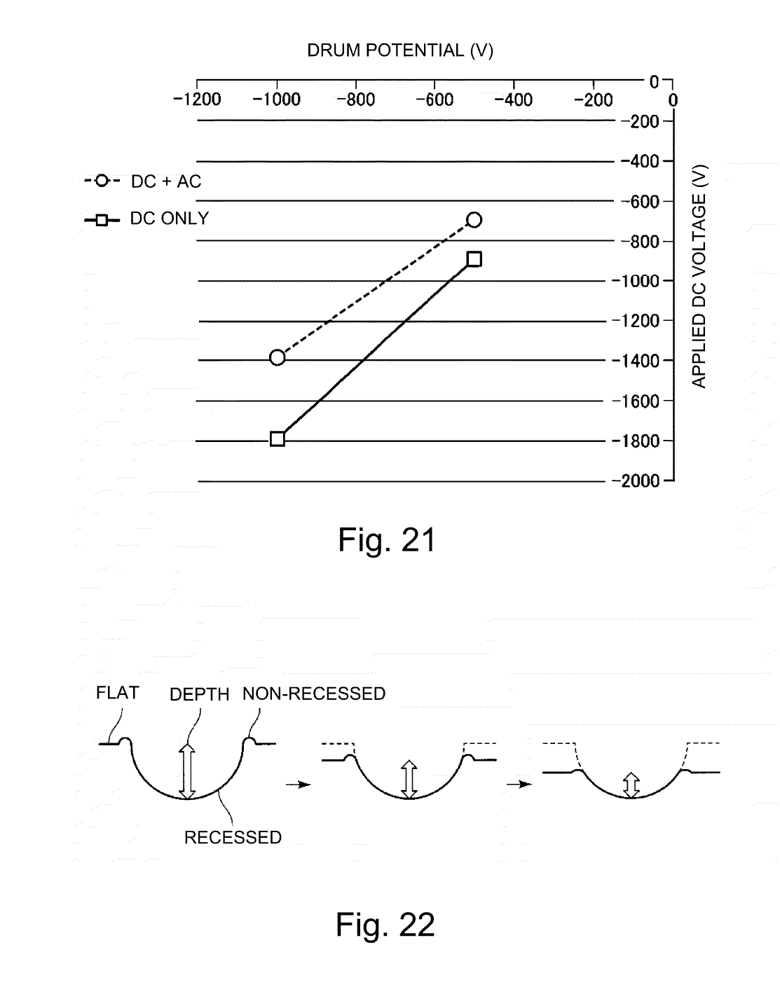

The charging voltage source E1 is placed in a state in which the DC voltage source portion E1a and the AC voltage source portion E1b are connected with the charging roller 2 by a switching portion E1c during normal image formation in which an image to be transferred onto a transfer material P and then to be outputted is formed. As a result, during the normal image formation, to the charging roller 2, the charging voltage in the form of the charging DC voltage biased with the charging AC voltage is applied, so that the photosensitive member 1 is charged. On the other hand, in this embodiment, the charging voltage source E1 is capable of charging the photosensitive member 1 by applying only the DC voltage to the charging roller 2 without superposing the DC voltage with the charging AC voltage. That is, during a test operation for grasping a remaining lifetime of the photosensitive member 1 described later specifically, the charging voltage source E1 is placed by the switching portion E1c in a state in which only the DC voltage source E1a is connected with the charging roller 2. As a result, during the test operation, only the charging DC voltage is applied to the charging roller 2 without superposing the charging DC voltage with the charging AC voltage, so that the photosensitive member 1 is charged. In the case where the photosensitive member 1 is charged only by the charging DC voltage, compared with the case where the charging DC voltage is biased (superposed) with the developing AC voltage, in order to place the surface of the photosensitive member in the same charge potential state, there is a need to apply a charging DC voltage which is about twice the charging DC voltage (in the case of applying only the charging DC voltage) to the charging roller 2. FIG. 21 shows an example of a relationship between the charging DC voltage and the charge potential of the photosensitive member in the case where the charging DC voltage is biased with the charging AC voltage (DC+AC charging method) and in the case of using only the charging DC voltage (DC charging method).

The image forming apparatus 100 includes the exposure device 3 as an information writing means (exposure means) for forming the electrostatic latent image on the charged surface of the photosensitive member 1. In this embodiment, the exposure device 3 is a laser beam scanner using a semiconductor laser. The exposure device 3 outputs laser light L modulated correspondingly to an image signal sent from a host processing device (not shown) such as an image reader or a personal computer to the image forming apparatus 100. As a result, the uniformly charged surface of the rotating photosensitive member 1 is subjected to laser scanning exposure (image exposure) at an exposure portion (exposure position) b. By this laser scanning exposure, an absolute value of a potential of portion of the surface of the photosensitive member 1 irradiated with the laser light L lowers, so that on the surface of the photosensitive member 1, the electrostatic latent image (electrostatic image) is successively formed.

The image forming apparatus 100 includes the developing device 4 as the developing means for supplying the toner to the electrostatic latent image on the photosensitive member 1 to develop the electrostatic latent image into a toner image (developer image). The developing device 4 develops the electrostatic latent image on the photosensitive member 1 by reversal development. That is, the photosensitive member surface is exposed to light after being uniformly charged is lowered in absolute value of the potential at the exposure portion on the photosensitive member 1. On the exposed portion of the photosensitive member 1, the toner charged to the same polarity as a charge polarity (negative in this embodiment) of the photosensitive member 1 is deposited, so that the toner image is formed. The developing device 4 includes a rotatable developing sleeve 31 as a developer carrying member for carrying and feeding the developer to a developing portion c which is an opposing portion to the photosensitive member 1. The developing sleeve 41 is 325 mm in length with respect to a longitudinal direction (rotational axis direction). In this embodiment, the developing sleeve 41 holds a magnetic brush of a two-component developer consisting of the toner and a carrier, and effects development while bringing the magnetic brush into contact with the photosensitive member 1 at the developing portion c. To the developing sleeve 41, a predetermined developing voltage (developing bias) from a developing voltage source (high voltage source) E2 as a voltage applying means. In this embodiment, the developing voltage is an oscillating voltage in the form of a DC voltage (developing DC voltage Vdc) biased with an AC voltage (developing AC voltage Vac). For example, the developing voltage is an oscillating voltage in the form of a predetermined DC voltage biased with a rectangular AC voltage of 8.0 kHz in frequency and 1.8 kV in peak-to-peak voltage. The DC voltage is appropriately set so as to provide a proper fog-removing potential difference relative to the charge potential of the photosensitive member 1 at the developing portion c. The fog-removing potential difference is a potential difference between the charge potential of the photosensitive member 1 and a DC component of the developing voltage applied to the developing sleeve 41, so that the toner charged to a normal charge polarity (negative in this embodiment) is moved toward the developing sleeve 41 side.

The image forming apparatus 100 includes an intermediary transfer device 12 as a transfer device for transferring the toner image from the photosensitive member 1 onto a transfer material (sheet) P. The intermediary transfer device 12 includes an intermediary transfer belt 6, provided opposed to the respective photosensitive members 1, constituted by an endless belt as an intermediary transfer member for temporarily holding and feeding the toner image transferred from the photosensitive member 1. The intermediary transfer belt 6 is stretched around a plurality of stretching rollers in a state in which a predetermined tension is applied thereto. The intermediary transfer belt 6 is rotationally driven in an arrow R2 direction in FIG. 1 by a driving roller which is one of the stretching rollers. On an inner peripheral surface side of the intermediary transfer belt 6, primary transfer rollers SY, SM, SC, SK which are roller-shaped primary transfer members as primary transfer means are provided at opposing positions to the photosensitive members 1Y, 1M, 1C, 1K, respectively. The primary transfer roller 5 is urged (pressed) against the intermediary transfer belt 7 toward the photosensitive member 1, and forms a primary transfer portion (primary transfer nip) N1 where the intermediary transfer belt 6 and the photosensitive member 1 are in contact with each other. On an outer peripheral surface side of the intermediary transfer belt 6, a secondary transfer roller 8 which is a roller-shaped secondary transfer member as a secondary transfer means is provided at an opposing position to a secondary transfer opposite roller which is one of the plurality of stretching rollers. The secondary transfer roller 8 is urged (pressed) against the intermediary transfer belt 6 toward the secondary transfer opposite roller, and forms a secondary transfer portion (secondary transfer nip) N2 where the intermediary transfer belt 6 and the secondary transfer roller 8 are in contact with each other. On the other peripheral surface side of the intermediary transfer belt 6, a belt cleaning device 11 as an intermediary transfer device cleaning means is provided downstream of the secondary transfer portion N2 and voltage of the most upstream primary transfer N1Y with respect to a movement direction of the intermediary transfer belt 6. The primary transfer portion N1, in FIG. 1, which is a press-contact nip formed between the photosensitive member 1 and the intermediary transfer belt 6 by the press-contact of the primary transfer roller 5 with the intermediary transfer belt 6 toward the photosensitive member 1 at a predetermined pressure is a transfer portion d in FIG. 2.

The toner images formed on the photosensitive member 1 are successively transferred (primary-transferred) electrostatically onto the intermediary transfer belt 6 rotationally driven in the arrow R2 direction in FIG. 1 at the primary transfer portions N1 by the action of the primary transfer rollers 5. At this time to the primary transfer rollers 5, a primary transfer voltage (primary transfer bias) which is a DC voltage of an opposite polarity (positive in this embodiment) to the normal charge polarity (charge polarity during the development) of the toner is applied from a primary transfer voltage source E3 as a voltage applying means. In this embodiment, a DC voltage of +600 V is applied as the primary transfer voltage. For example, during full-color image formation, the color toner images formed at the image forming portions SY, SM, SC, SK are successively primary-transferred superposedly onto the intermediary transfer belt 6 at the primary transfer portions N1. As a result, a multiple toner image for a full-color image based on the four color toner images is obtained.

In synchronism with a progress of the primary transfer of the toner images onto the intermediary transfer belt 6, the transfer material P such as a recording sheet is supplied from a transfer material feeding mechanism (not shown) at predetermined timing. Then, the toner images on the intermediary transfer belt 6 are successively transferred (secondary-transferred) electrostatically onto the transfer material P nipped and fed through the secondary transfer portion N2. At this time, to the secondary transfer roller 8, a secondary transfer voltage (secondary transfer bias) which is a DC voltage of the opposite polarity (positive in this embodiment) to the normal charge polarity of the toner is applied from an unshown secondary transfer voltage source as a voltage applying means. During the full-color image formation, the tour color toner images are collectively secondary-transferred from the intermediary transfer belt 6 onto the transfer material P.

The transfer material P which passed through the secondary transfer portion N2 and on which the toner images are transferred is successively separated from the surface of the intermediary transfer belt 6 and then is fed to a fixing device 9 as a fixing means. In this embodiment, the fixing device 9 is a heating roller fixing device, the toner images are fixed on the transfer material P by this fixing device 9, so that the transfer material P is outputted as an image-formed product (print, copy).

A primary transfer residual toner remaining on the surface of the photosensitive member 1 after the primary transfer of the toner image is removed and collected from the surface of the photosensitive member 1 by a photosensitive member cleaning device 7. The photosensitive member cleaning device 7 scrapes off and removes the primary transfer residual toner from the surface of the rotating photosensitive member 1 by a cleaning blade contacting the photosensitive member 1 at a cleaning portion e. In this embodiment, the cleaning blade 71 is a flat plate-like member formed with an urethane rubber and is 330 mm in length with respect to the longitudinal direction (rotational axis direction) of the photosensitive member 1. The cleaning blade 71 is pressed against the photosensitive member 1 at a linear pressure of 30 gf/cm.

A secondary transfer residual toner remaining on the surface of the intermediary transfer belt 6 after the secondary transfer of the toner images is removed and collected from the surface of the intermediary transfer belt 6 by a belt cleaning device 11.

### 2. Surface Shape of Photosensitive Member

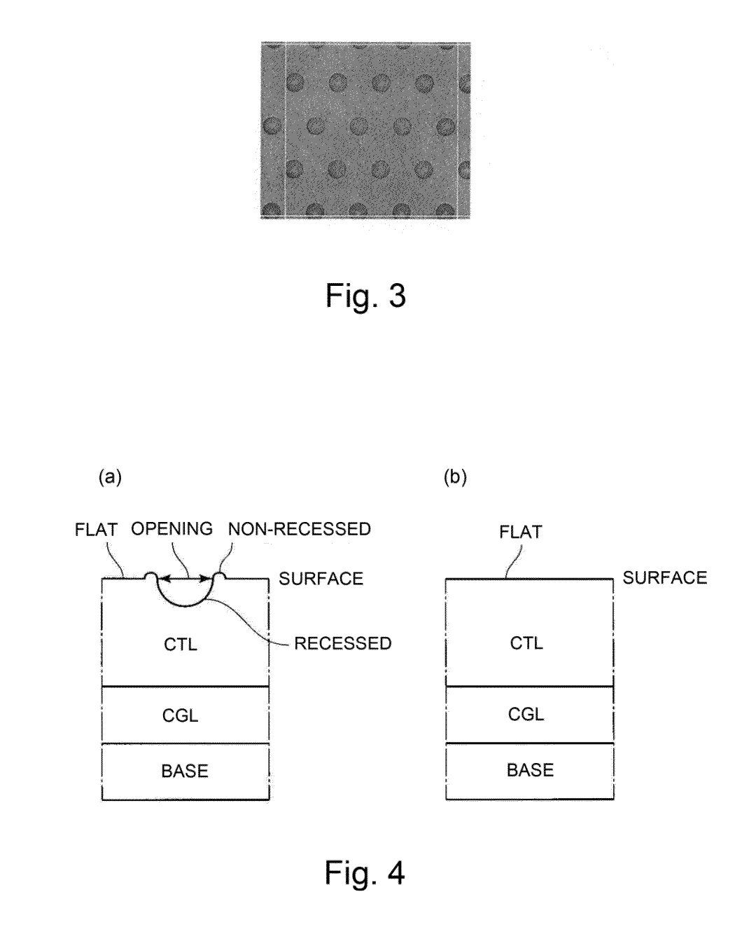

In this embodiment, on the surface of the photosensitive member 1, a plurality of independent recessed portions are formed. FIG. 3 is a schematic view of a region including specific recessed portions on the surface of the photosensitive member 1 as seen in a direction normal to the surface of the photosensitive member 1. In FIG. 3, a circular portion is the specific recessed portion, and another portion is a flat portion. Definition of the specific recessed portion and the flat portion will be described later.

The shape of the specific recessed portion is not limited to a circular shape, but may also be any shape other than the circular shape. For example, an elliptical shape and a polygonal shape such as a square shape, a rectangular shape, a triangular shape, a quadrangular shape, pentagonal shape or a hexagonal shape may also be used. Arrangement of the specific recessed portions is not limited to a regular arrangement but may also be a random arrangement.

In FIG. 4, (a) and (b) are schematic sectional views of the photosensitive member 1 with respect to the longitudinal direction, in which (a) shows a region of the photosensitive member 1 having the specific recessed portion, and (b) shows a region consisting only of the flat portion. As shown in (a) of FIG. 4, in the region having the specific recessed portions, the specific recessed portions are formed with a predetermined areal ratio relative to the flat portion occupying most of an entire area of the surface of the photosensitive member 1. In a manufacturing method of the specific recessed portions, in some cases, a rim-shaped projection which Is a non-recessed portion and a non-flat portion is formed around the specific recessed portions. Of each of the specific recessed portions, a space having a height level of the surface (flat portion) of the photosensitive member 1 is an opening. As shown in (b) of FIG. 4, in the region consisting only of the flat portion, the specific recessed portions and the rim-shaped projection do not exist.

The surface shape of the photosensitive member 1 in this embodiment will be specifically described. On the surface of the photosensitive member 1 at least in an image forming region (a region subjected to formation of the toner image for an image to be outputted onto the transfer material P), in a state before use, a plurality of specific recessed portions each having a depth of 2.5±0.2 μm and a maximum diameter of 20 μm or more and 80 μm or less at the opening are formed. When the specific recessed portions are disposed in a 500 μm-square region having one side parallel to a rotational direction of the photosensitive member 1 at an arbitrary position of the surface of the photosensitive member 1, the specific recessed portions are provided in the square region (500 μm×500 μm) on the surface of the photosensitive member 1 so that an area of the specific recessed portions is 7500 μm² or more and 88000 μm² or less. On the surface of the photosensitive member 1, in addition to the specific recessed portions, the flat portion is provided. When the specific recessed portions and the flat portion are disposed in the square region (500 μm×500 μm) having one side parallel to the rotational direction of the photosensitive member 1 at the arbitrary position of the surface of the photosensitive member 1, the flat portion is provided in the square region on the surface of the photosensitive member 1 so that an area of the flat portion is 81000 μm² or more and 240000 μm² or less.

Definition of the specific recessed portions and the flat portion in the square region (500 μm×500 μm) will be described. The specific recessed portions and the flat portion on the surface of the photosensitive member 1 can be observed through a microscope such as a laser microscope, an optical microscope, an electron microscope, an atomic force microscope. First, the surface of the photosensitive member 1 is observed in an enlarged manner through the microscope or the like. In the case where the surface of the photosensitive member 1 has a curved surface along the rotational direction of the photosensitive member 1, a cross-sectional profile of the curved surface is extracted, so that the curved line is subjected to fitting. The cross-sectional profile is corrected so that the curved line is changed to a rectilinear line, and a resultant rectilinear line is extended in the longitudinal direction of the photosensitive member 1 on a surface as a reference surface. On the basis of the reference surface, a region of ±0.2 μm in height difference is defined as the flat portion in the 500 μm-square region. A region positioned under the flat portion is defined as the recessed portion. A maximum distance from the flat portion to a bottom of the recessed portion is a depth of the recessed portion, a cross-sectional portion defined by the flat portion is the opening of the recessed portion, and a length of a longest line segment of line segments crossing the opening is a maximum diameter of the opening of the recessed portion.

Of the recessed portions positioned in the 500 μm-square region, recessed portions positioned in a range of 0.5 μm or more and 6 μm or less in depth obtained as described above and in a range of 20 μm or more and 80 μm or less in maximum diameter of the opening correspond to the specific recessed portions.

In this embodiment, substantially all of the plurality of recessed portions formed on the surface of the photosensitive member 1 are the specific recessed portions, particularly the specific recessed portions each having the depth of 2.5±0.2 μm and the maximum diameter of the opening, and the recessed portions which do not satisfy this condition with respect to the depth and the maximum diameter of the opening are at a negligible level. On the surface of the photosensitive member 1, the recessed portions which do not correspond to the specific recessed portions with respect to the depth and the maximum diameter of the opening may exist, but it is preferable that the specific recessed portions and the flat portion which satisfy the above-described conditions are disposed. In the following description, the depth of the recessed portions on the surface of the photosensitive member 1 is represented by an average of depths in the image forming region. For example, an average of diameters of the recessed portions in an arbitrary region of 2 μm×2 μm in the image forming region of the photosensitive member 1 is obtained and can be used as the depth of the recessed portions.

The recessed portions of the surface of the photosensitive member 1 can be formed by a method in which a mold having a recessed portion shape is press-contacted to the surface of the photosensitive member 1 to effect shape transfer. For example, the mold is continuously contacted to the surface (peripheral surface) of the photosensitive member 1 while rotating the photosensitive member 1 by a press-contact shape transfer processing device including the mold and then is pressed, whereby the recessed portions can be formed. As another method, a method or the like in which recessed portions having a predetermined shape are formed on the surface of the photosensitive member by laser irradiation has also been known.

### 3. Suppression of Image Deletion (Flow)

As in this embodiment, by using the photosensitive member 1 including the specific recessed portions, it is turned out that an image deletion-suppressing effect is remarkably improved. When the recessed portions are sparsely disposed, an abnormal vibration from the photosensitive member 1 to the cleaning blade 71, i.e., a so-called shuddering is properly suppressed, and not only a stable and good rubbing state is creased but also a pressure of the cleaning blade 71 applied to the recessed portions is reduced, so that a pressure applied to another portion increases. Of the non-recessed portion where the pressure increases, an area of the flat portion where efficient refreshing is readily effected increases, so that such a surface state that a substance, causing the image deletion, deposited on the surface of the photosensitive member 1 is readily removed can be formed. By such a mechanism, it would be considered that the image deletion-suppressing effect is remarkably improved.

However, as described above, when the depth of the specific recessed portions decreases, both of an effect of suppressing the shuddering of the cleaning blade 71 to create the stable and good rubbing state and an effect of reducing the pressure of the cleaning blade 71 applied to the recessed portions to increase the pressure applied to another portion are reduced. For that reason, the image deletion is liable to generate. In order to effectively suppress the image deletion, the depth of the specific recessed portions at least in the image forming region of the photosensitive member 1 may preferably be 1.0 μm or more, further preferably be 1.5 μm or more.

### 4. Suppression of Turning-Up and Abnormal Noise of Cleaning Blade for Photosensitive Member

As in this embodiment, by using the photosensitive member 1 including the specific recessed portions, it is turned out that an effect of suppressing turning-up and abnormal noises of the cleaning blade 71 is remarkably improved. The timing-up and abnormal noise of the cleaning blade 71 are an abnormal phenomenon which is liable to generate in a high-humidity environment particularly in the case where the image formation is effected using the photosensitive member 1 having a high hardness.

That is, it has been known that when the depth of the specific recessed portions decreases, a contact area between the cleaning blade 71 and the surface of the photosensitive member 1 increases and thus a friction coefficient increases, and a shuddering phenomenon of the cleaning blade 71 becomes apparent. Further, a stick-slip amplitude motion becomes large, and the photosensitive member 1 resonates with the vibration of the cleaning blade 71, so that the abnormal noise generates in some cases. Further, the amplitude of the cleaning blade 71 becomes large and thus is reversed, so that the turning-up of the cleaning blade 71 is generated in some cases. In the case where the turning-up of the cleaning blade 71 is generated, an abrupt load is exerted on the photosensitive member 1, so that an image forming operation of the image forming apparatus 100 stops in some cases.

Similarly as in the case of the image deletion, also with respect to the turning-up and abnormal noise of the cleaning blade 71, it is turned out that an effect is higher when deep recessed portions. When the depth of the recessed portions becomes shallow, the abnormal noise of the cleaning blade 71 due to the stick-slip is liable to generate, and a probability that it leads to the turning-up of the cleaning blade 71 increases.

### 5. Setting of Depth of Recessed Portions

In this embodiment, as described above, the average of the depth of the specific recessed portions was sets at 2.5 μm. When the depth of the specific recessed portions is larger than 3.5 μm, a gap between the cleaning blade 71 and the recessed portions of the surface of the photosensitive member 1 is excessively large. For that reason, the toner slips through the gap between the cleaning blade 71 and the recessed portions of the surface of the photosensitive member 1, so that there is a liability that the image is contaminated due to improper cleaning. Further, when the depth of the specific recessed portions is smaller than 1.0 μm, there is a liability that a phenomenon such as the timing-up or abnormal noise of the cleaning blade 71 is generated. For that reason, the depth of the specific recessed portions may most suitably be about 2.5 μm.

### 6. Decrease in Depth of Recessed Portions by Use of Photosensitive Member

When the image formation is effected, a thickness of the surface of the photosensitive member 1 decreases by rubbing or the like with a contact member (principally the cleaning blade 71). At this time, as shown in FIG. 22, in the region where the specific recessed portions exist, the height level of the flat portion lowers, and therefore the depth from the flat portion to the bottom of the specific recessed portions relatively decreases. Further, with the rubbing, also the height of the rim-shaped projected portion which is the non-recessed portion and the non-flat portion decreases. In the region consisting only of the flat portion (not shown), the height level lowers as a whole, but the surface shape is still flat.

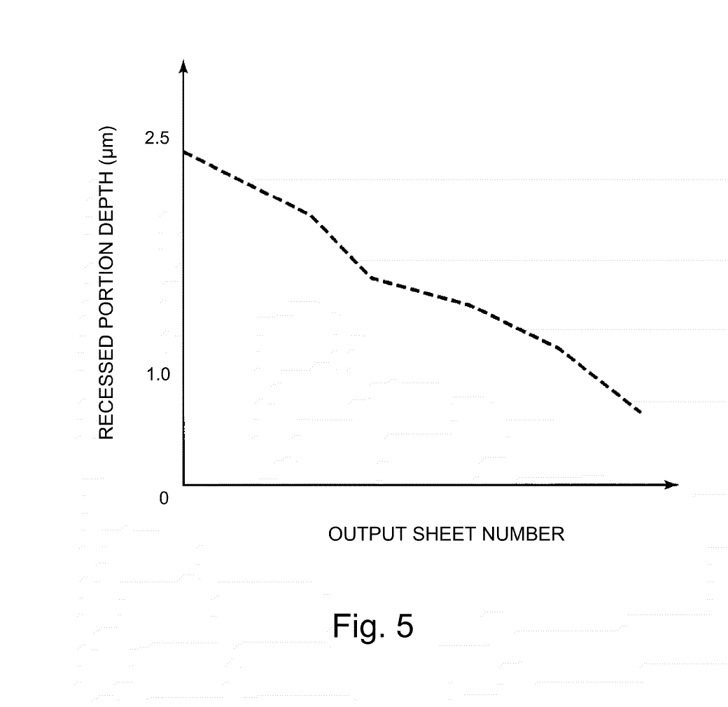

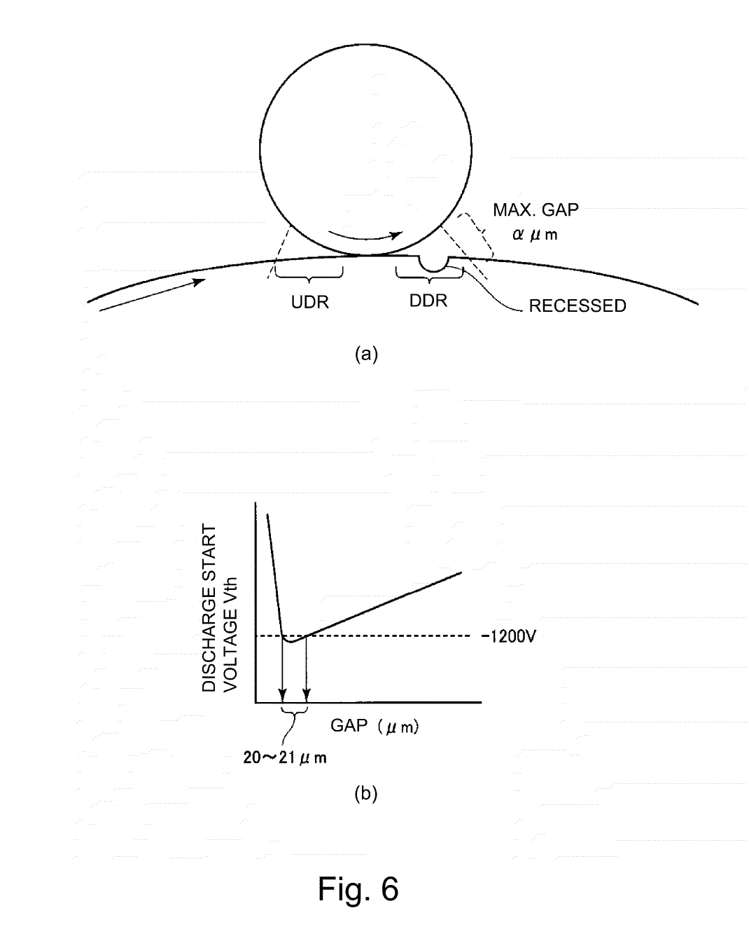

FIG. 5 is a graph, showing a relationship between a repetitive use status (image output number) of the photosensitive member 1 and the depth of the specific recessed portions. From FIG. 5, it is understood that with an increasing image output number, the depth of the specific recessed portions gradually decreases.

### 7. Generation of Lateral Stripe

A lateral (horizontal) stripe (lateral stripe image, lateral stripe phenomenon) is a stripe density non-uniformity appearing on the image along the longitudinal direction (main scan direction) of the photosensitive member 1. The lateral stripe is a phenomenon appearing due to generation of a minute improper charging caused by insufficient charging power to the photosensitive member 1 at the gap between the photosensitive member 1 and the charging roller 2 in or in the neighborhood of the charging nip although the potential of the photosensitive member 1 reaches a desired potential. Accordingly, the lateral stripe is in general not readily generated on the image outputted using the charging voltage in the form of the charging DC voltage biased with the charging AC voltage. On the other hand, the lateral stripe is liable to generate on the image outputted using the charging voltage consisting only of the charging DC voltage.

In the case where the image is outputted using the charging voltage consisting only of charging DC voltage, the image is influenced by a minute fluctuation in magnitude of the gap. For that reason, spark discharge intermittently generates from the charging roller 2, so that the photosensitive member 1 is liable to be in a minute improper charging state, and thus the spark discharge is liable to appear as the lateral stripe on the image as shown in (b) of FIG. 12, for example. On the other hand, in the case where the image is outputted using the charging voltage in the form of the charging DC voltage biased with the charging AC voltage, at the gap between the photosensitive member 1 and the charging roller 2, the spark discharge continuously generates and is a very stable state. This is because AC discharge generates. For that reason, the minute charge non-uniformity generated due to the minute fluctuation in magnitude of the gap or the like is immediately made uniform, so that the improper charging does not readily generate.

In this embodiment, of the charging voltages for charging the photosensitive member 1, the charging voltage in the form of the charging DC voltage biased with the charging AC voltage is also referred to as a first charging voltage (or AC+DC charging voltage), and the charging voltage consisting only of the charging DC voltage is also referred to as a second charging voltage (or DC charging voltage).

### 8. Relationship Between Uneven Shape of Photosensitive Member Surface and Lateral Stripe

The lateral stripe various in degree of generation thereof depending on whether or not the photosensitive member 1 is sufficiently charged at the gap between the photosensitive member 1 and the charging roller in or in the neighborhood of the charging nip. That is, the degree of generation of the lateral stripe varies depending on whether or not stable electric discharge can be realized at the gap between the photosensitive member 1 and the photosensitive member 1 in or in the neighborhood of the charging nip.

A voltage V at which the spark discharge generates between parallel electrodes is represented by the Paschen's law of the following formula 1′

V=f(pd) (formula 1),

where p is atmospheric pressure, d is a distance between the charging member and a member-to-be-charged.

Based on the formula 1, the voltage V at which the spark discharge generates is proportional to each of the atmospheric (ambient) pressure p and the distance d between the charging member and the member-to-be-charged. That is, in the case where the atmospheric pressure is in a certain condition in a state in which the applied voltage is constant, whether or not the spark discharge generates is determined depending on a magnitude of the gap between the photosensitive member 1 and the charging roller 2.

As shown in (a) of FIG. 6, between the surface of the photosensitive member 1 and the charging roller 2, the gap between the photosensitive member 1 and the charging roller 2 is formed on each of an upstream side and a switch side of the charging nip with respect to the movement direction of the surface of the photosensitive member 1. In regions where the upstream-side gap and the downstream-side gap are formed, discharge regions (upstream discharge region and downstream discharge region) where the electric discharge generates exist. A discharge start voltage is determined in accordance with the Paschen's law depending on a magnitude of the gap (distance) formed in the discharge region. In this embodiment, the charging DC voltage is a DC voltage of −1200 V. In this case, as shown in (b) of FIG. 6, from the Paschen's law, it is known that the magnitude of the gap (distance) in which the discharge generates is 20-21 μm.

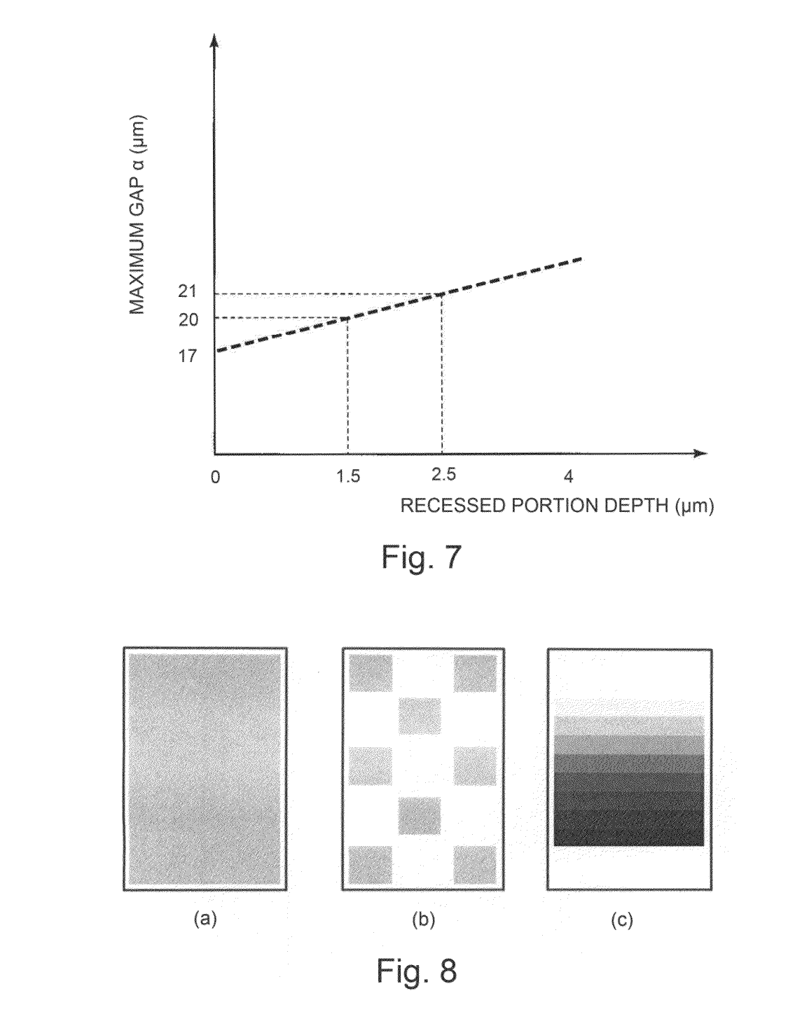

As shown in (a) of FIG. 6, a maximum gap between the photosensitive member 1 and the charging roller 2 in the downstream discharge region where the discharge generates is α (μm). The reason why the downstream discharge region is watched is that the discharge in the downstream discharge finally has the influence on the lateral stripe on the image. FIG. 7 is a graph showing a relationship between the depth of the recessed portions of the surface of the photosensitive member 1 and the maximum gap α between the photosensitive member 1 and the charging roller 2 in the downstream discharge region in which the discharge generates. From FIG. 7, it is understood that the maximum gap fluctuates depending on a change in surface recessed portion depth of the photosensitive member 1. That is, from FIG. 7, it is understood that the gap between the photosensitive member 1 and the charging roller 2 reaches 20-21 μm in a range between 1.5-2.5μ of the surface recessed portion depth of the photosensitive member 1. For that reason, in the case where the image is outputted using the charging DC voltage, when the surface recessed portion depth of the photosensitive member 1 corresponds to the depth range of 1.5-2.5 μm, the lateral stripe generates.

Depending on the constitution of the image forming apparatus 100, outer diameters and physical properties of the photosensitive member 1 and the charging roller 2, a rotational speed of the photosensitive member 1, a penetration amount of the charging roller 2 into the photosensitive member 1, and the like and different. For that reason, depending on setting of these values, the relationship between the maximum gap in the downstream discharge region in which the discharge generates and the surface recessed portion depth of the photosensitive member 1 and a relationship between the surface recessed portion depth of the photosensitive member 1 and the gap between the photosensitive member 1 and the charging roller 2 are different, respectively. In this embodiment, the charging DC voltage was the DC voltage of −1200 V, but in the case where the DC voltage different from this charging DC voltage is used, also the magnitude of the gap (distance) in which the discharge starts is different based on the Paschen's law. Accordingly, in the constitution in this embodiment, the surface recessed portion depth of the photosensitive member 1 in which the lateral stripe generates is 1.5-2.5 μm, but depending on a constitution employed, a relationship between the surface recessed portion depth of the photosensitive member 1 and a generation level of the lateral stripe varies.

In this embodiment, specifically in a test operation described later, in order to obtain information on the surface recessed portion depth of the photosensitive member 1, a test image is outputted by intentionally using the charging DC voltage (second charging voltage) as a state in which the lateral stripe is liable to generate. That is, by outputting the test image using the charging DC voltage, the lateral stripe which does not generate when the image is outputted using the AC+DV charging voltage (first charging voltage) and which is caused by minute improper charging generates. The generation of the lateral stripe is affected by the gap magnitude (distance) between the photosensitive member 1 and the charging roller 2, and therefore the lateral stripe generation level varies depending on a change in surface recessed portion depth of the photosensitive member 1. In the case where the surface recessed portion depth of the photosensitive member 1 is sufficiently deep, when the image is outputted using the charging DC voltage (DC charging voltage), a large unevenness (projections and recessed portions) exists on the surface of the photosensitive member 1 in the discharge region, so that abnormal discharge generates at the portion and thus the lateral stripe generates on the image. On the other hand, when the surface recessed portion depth of the photosensitive member 1 becomes smaller than a predetermined value (1.5 μm in this embodiment), even when the image is outputted using the charging DC voltage, the abnormal discharge does not readily generate and therefore the lateral stripe does not readily generate. By using this characteristic, the test image for obtaining the information on the surface recessed portion depth of the photosensitive member 1 is outputted using the charging DC voltage, so that the lateral stripe generation level is caused to correspond to the surface recessed portion depth of the photosensitive member 1 and is further caused to correspond to a remaining lifetime of the photosensitive member 1. As a result, a level of a decrease in depth of the recessed portions of the surface of the photosensitive member 1 during the test operation is detected, so that whether or not the photosensitive member 1 reaches an exchange (replacement) timing can be discriminated.

### 9. Test Image and Test Operation

The test image and the test operation for obtaining the information on the surface recessed portion depth of the photosensitive member 1 in this embodiment will be described.

In this embodiment, with respect to the first to fourth portions SY, SM, SC, SK, in order to grasp the remaining lifetime of the photosensitive member 1, the substantially same test operation is continuously performed successively at the same timing by a single instruction. In the following description, in order to avoid redundancy, a single image forming portion S will be matched and described.

As the test image, from the viewpoint of ease of check of a generation state of the lateral stripe, a halftone image having a predetermined density may preferably be used. In this embodiment, as the test image, a uniform halftone image was formed in an entire area in an A4-sized image forming region as shown in (a) of FIG. 8. However, the test image is not limited thereto, but may also be an image, formed in a part of the image forming region, such as a halftone image formed in a patch shape in a part of the A4-sized image forming region as shown in (b) of FIG. 8. The test image may also be a gradation pattern capable of checking the lateral stripe generation level in various density regions as shown in (c) of FIG. 3.

The surface of the photosensitive member 1 is not uniformly abraded in an entire region with respect to a main scan direction, but is non-uniformly abraded in same cases depending on a pressure (urging force) distribution of the cleaning blade 71, a pressure distribution of the primary transfer roller 5, and the like. For that reason, the test image may desirably be such an image that a tendency of abrasion of the photosensitive member 1 in the entire image forming region with respect to the main scan direction of the photosensitive member 1 can be grasped. For that purpose, the test image may preferably be formed at least a plurality of portions such as a central portion or both end portions of the image forming region with respect to the main scan direction of the photosensitive member 1, and may more preferably be formed in the entire image forming region with respect to the main scan direction.

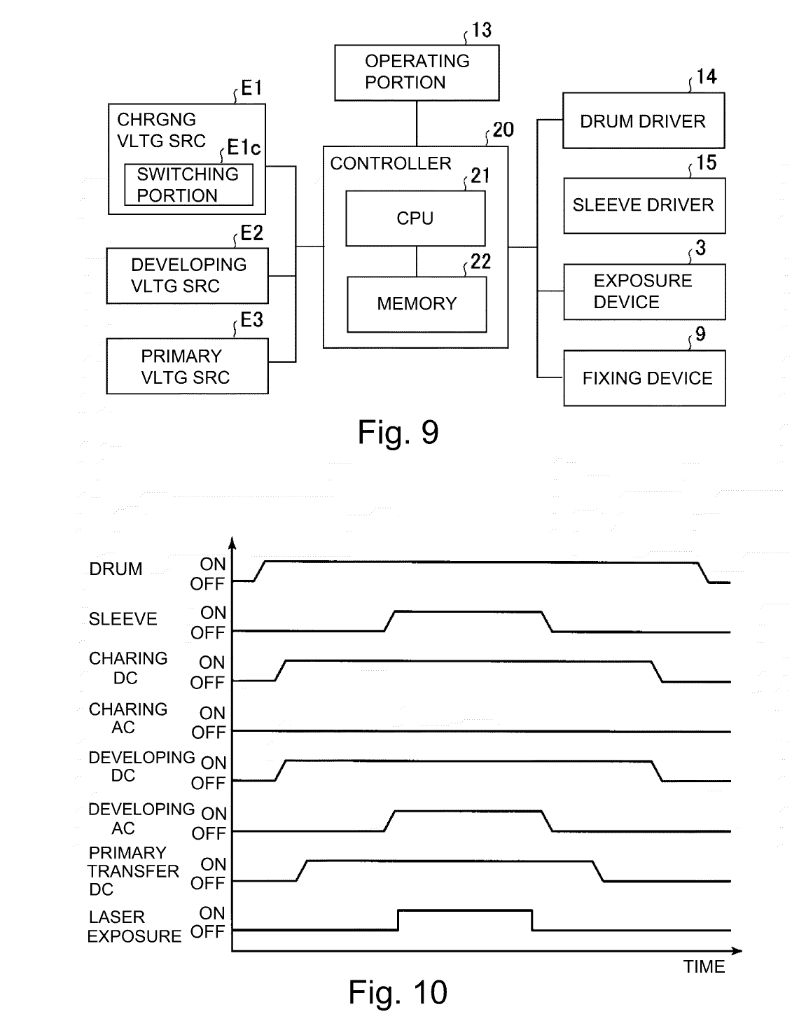

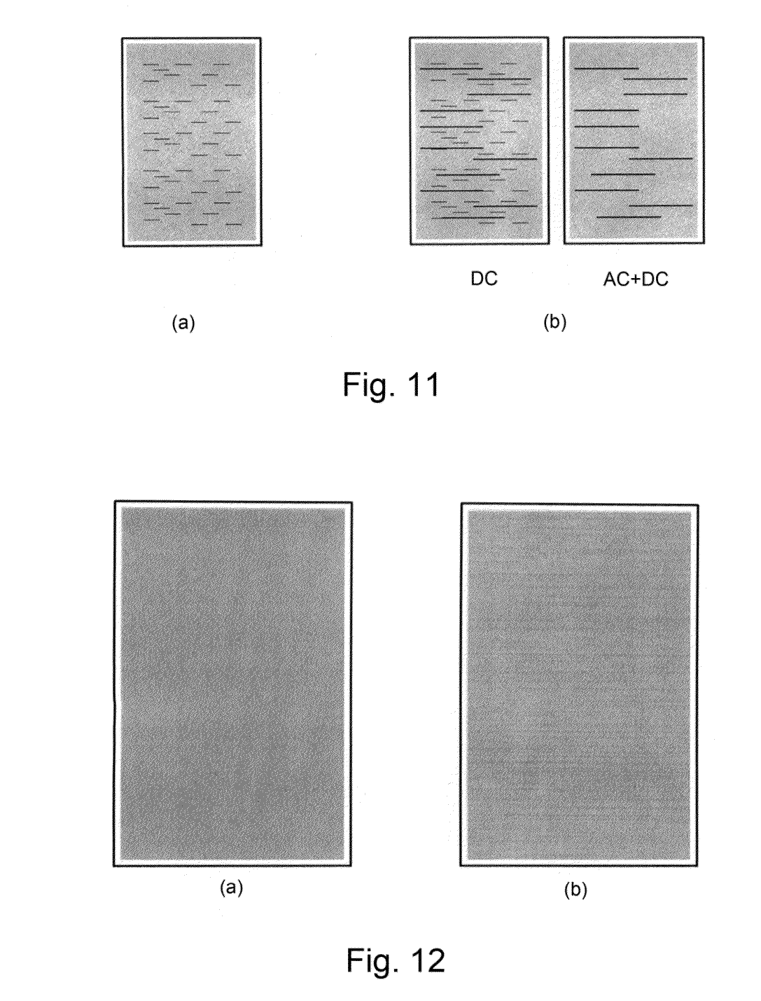

The test operation in this embodiment will be described with reference to FIGS. 9 and 10. FIG. 9 is a block diagram showing a schematic control embodiment of the image forming apparatus 100 in the test operation, and FIG. 10 is a timing chart showing an operation sequence of respective portions in the test operation.

A controller 20 as a control means provided in the image forming apparatus 100 is constituted by including CPU 21 which is a central element for effecting computation, a memory 22 such as ROM or RAM which is storing element (storing portion), and the like. In the RAM, a detection result, a computation result and the like of a sensor are stored, and in the ROM, a control program, a preliminarily obtained data table, and the like are stored. In this embodiment, the controller effect integrated control of the respective portions of the image forming apparatus 100. Particularly, in this embodiment, with the controller 20, the charging voltage source E1, the developing voltage source E2, the primary transfer voltage source E3, an operating portion 13 provided on the apparatus 1 main assembly of the image forming apparatus 100, a photosensitive member driving portion 14, a developing device driving portion 15, the exposure device 3, the fixing device 9, and the like are connected. In this embodiment, the controller 20 executes the test operation (test image outputting mode) depending on an instruction through the operating portion 13 by an operator such as a service person or a user, so that the test image is formed on the transfer material P and then is outputted from the image forming apparatus 100.

The controller 20 goes to the test operation (test image outputting mode) depending on the instruction of the operator through an operation of an operating button provided on the operating portion 13, and starts the rotation of the photosensitive member 1 by the photosensitive member driving portion 14. Then, the controller 20 provides an instruction to the switching portion E1c of the charging voltage source E1 so as to switch the charging voltage to the charging DC voltage (DC charging voltage). Then, the controller 20 starts application of the charging DC voltage (−1200 V in this embodiment) from the charging voltage source E1 to the charging roller 2. At this time, the charging AC voltage is in an off state. Then, the controller 20 starts application of the developing DC voltage (−450 V in this embodiment) from the developing voltage source E2 to the developing sleeve 41 of the developing device 4 and starts application of a primary transfer DC voltage (+700 V in this embodiment) from the primary transfer voltage source E3 to the primary transfer roller 5 immediately after the developing DC voltage application. The reason why the developing DC voltage is applied to the developing sleeve 41 in a state in which rotation of the developing sleeve 41 is not started is that transfer of the toner existing between the photosensitive member 1 and the developing sleeve 41 onto the photosensitive member 1 is suppressed. Then, the controller 20 starts the rotation of the developing sleeve 41 by the developing device driving portion 15. A time from start of the application of the charging voltage to the charging roller 2 and start of the rotation of the developing sleeve 41 is about 1 sec. This is because the charging roller 2 is rotated through two or three full circumferences until the surface potential of the photosensitive member 1 is stabilized. Then, the controller 20 starts application of the developing AC voltage from the developing voltage source E2 to the developing sleeve 41 immediately after the start of the rotation of the developing sleeve 41. Incidentally, although the development is effected under application of only the developing DC voltage, in order to stabilize the density of the toner image, the developing DC voltage may preferably be biased with the developing AC voltage. Then, the controller 20 starts irradiation of the photosensitive member 1 with the laser light from the exposure device 3. At this time, an exposure pattern by the laser light depends on the test image pattern described above in (a) of FIG. 8.

After the exposure by the exposure device 3 is ended, the controller 20 successively stops the application of the developing AC voltage, the rotation of the developing sleeve 41, the application of the primary transfer DC voltage, the application of the developing DC voltage and the application of the charging DC voltage in a reverse order to the procedure described above. Then, the controller 20 stops the rotation of the photosensitive member 1 after the surface of the photosensitive member 1 is sufficiently discharged (charge-removed). In order to discharge the surface of the photosensitive member 1, the surface of the photosensitive member 1 may also be irradiated with light by using a pre-exposure means.

Similarly as in the case of the normal image formation, the toner image for the test image formed on the photosensitive member 1 is primary-transferred from the photosensitive member 1 onto the intermediary transfer belt and then is secondary-transferred from the intermediary transfer belt 6 onto the transfer material P, followed by fixation on the transfer material P by the fixing device 9. In this way, an output product on which the test image showing information on the surface recessed portion depth of the photosensitive member 1 is formed on the transfer material P can be obtained by the operator.

### 10. Test Image Output Product and Remaining Lifetime Discrimination of Photosensitive Member

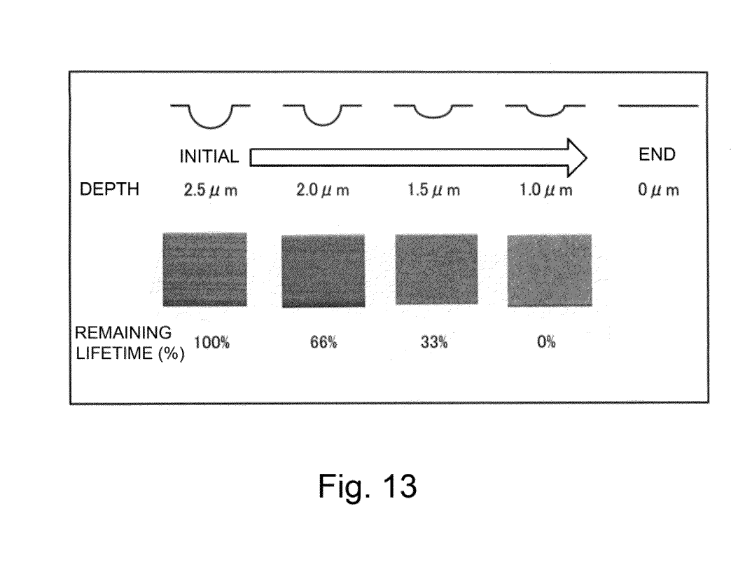

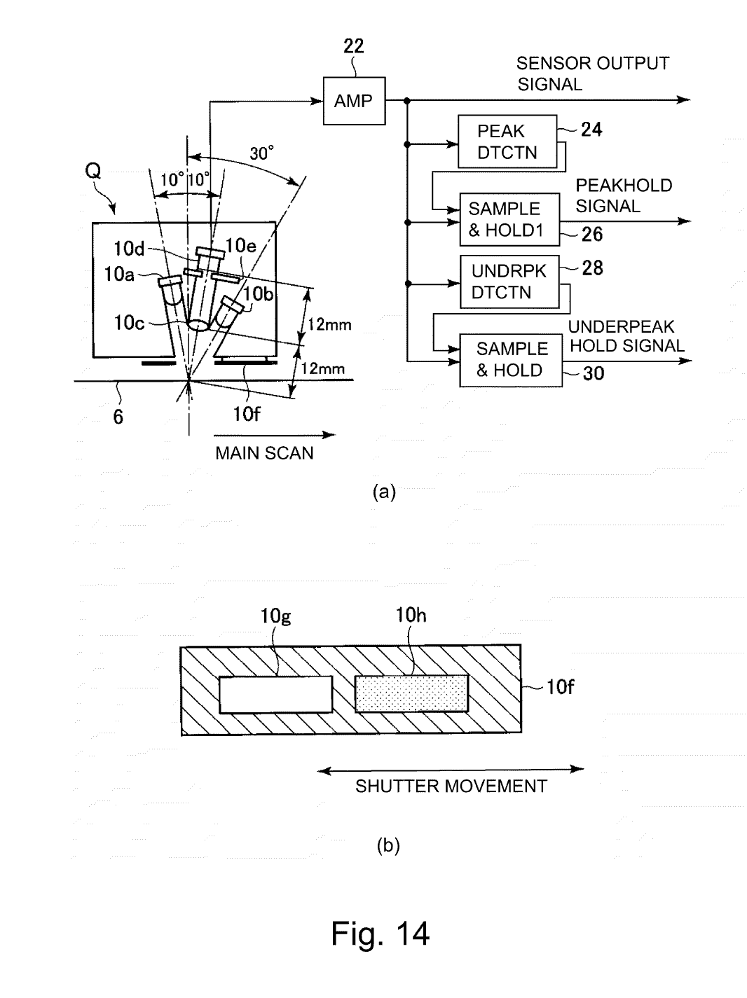

In FIG. 11, (a) schematically shows an example of the test image outputted using the charging DC voltage. In this case, the operator compares an actually outputted test image with a preliminarily prepared corresponding chart, e.g., as shown in FIG. 13, which is a reference image for associating the lateral stripe state (status) on the test image with the remaining lifetime of the photosensitive member 1. In the corresponding chart shown in FIG. 13, the lateral stripe state is associated with the surface recessed portion depth of the photosensitive member 1 and the remaining lifetime of the photosensitive member 1. The corresponding chart can be provided by obtaining a relationship between the lateral stripe state and each of the surface recessed portion depth of the photosensitive member 1 and the remaining lifetime of the photosensitive member 1 in advance through an experiment by a provider of the image forming apparatus 100. Then the operator can discriminate the depth (μm) of the recessed portions of the surface of the photosensitive member 1 during output of the test image and a level of the remaining lifetime of the photosensitive member 1 during the output of the test image.

For example, in the case where the generation level of the lateral stripe on the test image actually outputted is to the extent shown in (a) of FIG. 12, from the corresponding chart of FIG. 13, the operator can grasp that the surface recessed portion depth of the photosensitive member 1 is about 1.0 μm and that the remaining lifetime of the photosensitive member 1 is about 0%. That is, as described above, when the surface recessed portion depth of the photosensitive member 1 is about 1.0 μm or less, there is a liability that the image deletion generates and the turning-out and the abnormal noise of the cleaning blade 71 generate. For this reason, in this case, the operator can grasp that the photosensitive member 1 should be early exchanged (replaced).

For example, in the case where the generation level of the lateral stripe on the test image actually outputted is to the extent shown in (b) of FIG. 12, from the corresponding chart of FIG. 13, the operator can grasp that the surface recessed portion depth of the photosensitive member 1 is still about 2.0 μm and that the remaining lifetime of the photosensitive member 1 is about 66%. In this case, the operator can grasp that there is no need to exchange the photosensitive member 1 for some time.

In this way, the information on the surface recessed portion depth of the photosensitive member 1 is obtained by checking the test image formed using the charging DC voltage, so that the remaining lifetime of the photosensitive member 1 can be grasped.

In FIG. 11, (b) schematically shows a test image (left side), as a modified embodiment, outputted using the charging DC voltage in the test operation and a comparison test image (right side) outputted using the AC r DC charging voltage. In this example, the test image and the comparison test image are formed and outputted on separate transfer materials P. The comparison test image is formed substantially in the same condition, such as the density and pattern of the halftone image, as that in the case of the test image except that the AC+DC charging voltage similar to that during the normal image formation is used as the charging voltage. In this case, it becomes possible to detect a stripe density non-uniformity caused by a factor other than the lateral stripe generating depending on the surface recessed portion depth of the photosensitive member 1. That is, the comparison test image is outputted using the AC+DC charging voltage, and therefore the lateral stripe depending on the surface recessed portion depth of the photosensitive member 1 does not readily generate. Accordingly, it can be discriminated that the stripe density non-uniformity generating correspondingly to both of the test image (left side) and the comparison test image (right side) generates independently of the surface recessed portion depth of the photosensitive member 1. For that reason, when the surface recessed portion depth of the photosensitive member 1 and the remaining lifetime of the photosensitive member 1 are discriminated through observation of the test image, the test image and the corresponding chart can be checked by the neglect of the stripe density non-uniformity. As a result, a level of accuracy of the remaining lifetime of the photosensitive member 1 grasped by the operator can be improved.

The output of the comparison test image can be performed subsequently to the output of the above-described test image in the test operation. However, the order of the output of the test image and the comparison test image may also be reverse order and the test image and the comparison test image may also be outputted on the same transfer material P if possible.

As described above, in this embodiment, the image forming apparatus 100 includes the controller 20 for executing the image forming operation and the test operation. In the image forming operation, the toner image depending on arbitrary image information is formed and then transferred and outputted on the transfer material P. In the test operation, the test image for obtaining the information on the remaining lifetime of the photosensitive member 1 is formed and then transferred and outputted on the transfer material P. Then, the controller 20 forms the test image in the test operation by charging the photosensitive member 1 under application of the charging voltage consisting only of the DC voltage to the charging member 2. The charging voltage source E1 is capable of selectively applying the first charging voltage, in the form of the DC voltage biased with the AC voltage, applied during the image forming operation and the second charging voltage consisting only of the DC voltage applied during the test operation. In the test operation, the controller 20 can transfer and output, on the transfer material P, the comparison test image which is capable of being compared with the test image and which is formed using the first charging voltage as the charging voltage.

According to this embodiment, the surface recessed portion depth of the photosensitive member 1 varying depending on the abrasion by use is detected with high accuracy, so that the remaining lifetime of the photosensitive member 1 can be grasped with high accuracy. As a result, the photosensitive member 1 is exchanged at proper timing, so that it is possible to suppress generation of the problems such as the image deletion, the turning-up and the abnormal discharge of the cleaning blade. In addition, the remaining lifetime of the photosensitive member 1 can be accurately grasped, and therefore necessity of the early exchange of the photosensitive member 1 with a margin is reduced, so that it can contribute to lifetime extension of the photosensitive member 1. Further, by such a simple method that the charging type is changed without changing a hardware constitution of the image forming apparatus 100, the remaining lifetime of the photosensitive member 1 can be grasped with high accuracy, so that it can also contribute to simplification of the structure of the image forming apparatus 100.

### Embodiment 2

Next, another embodiment of the present invention will be described. In this embodiment, basic constitution and operation of the image forming apparatus are the same as those in Embodiment 1. Therefore, elements having the same or corresponding functions and constitutions as those in Embodiment 1 are represented by the same reference numerals or symbols and will be omitted from detailed description.

In this embodiment, similarly as in Embodiment 1, in the test operation for grasping the remaining lifetime of the photosensitive member 1, the test image formed using the charging DC voltage as shown in (a) of FIG. 8 for example is outputted. In addition, in this embodiment, in the test operation, the corresponding chart which is the reference image, e.g., as shown in FIG. 13, formed using the AC+DC charging voltage is outputted. In this embodiment, the test image and the corresponding chart are continuously outputted at the same timing in the test operation performed in accordance with a single instruction. The information of the corresponding chart is obtained in advance through an experiment or the like and is stored in the memory 22 of the controller 20.

As described above, in this embodiment, the test image and the corresponding chart used for discriminating the remaining lifetime of the photosensitive member 1 by the operator are outputted at the same timing in the test operation. That is, in this embodiment, the controller 20 transfers and outputs, on the transfer material P, the reference image which is formed using the first charging voltage as the charging voltage in the test operation and which is capable of associating the density non-uniformity with the remaining lifetime of the photosensitive member 1. As a result, such a need that the operator prepares the corresponding chart in advance and then stores or carries the corresponding chart as in Embodiment 1 is eliminated, so that it becomes possible to grasp the remaining lifetime of the photosensitive member 1 with use of the corresponding chart outputted on that occasion as needed.

The corresponding chart is outputted using the AC+DC charging voltage, and therefore the lateral stripe depending on the surface recessed portion depth of the photosensitive member 1 does not readily generate and can be used as the reference image.

In the test operation, whether or not the corresponding chart is outputted in the test operation may also be selected by the operator through the operating portion 13 or the like for example. Further, similarly as in the modified embodiment of Embodiment 1, the comparison test operation may also be outputted in the test operation.

As described above, according to this embodiment, not only an effect similar to the effect in Embodiment 1 but also it becomes possible to grasp the remaining lifetime of the photosensitive member 1 without a hitch as needed while eliminating troublesomeness of the storage and carrying of the corresponding chart.

### Embodiment 3

Next, another embodiment of the present invention will be described. In this embodiment, basic constitution and operation of the image forming apparatus are the same as those in Embodiment 1. Therefore, elements having the same or corresponding functions and constitutions as those in Embodiment 1 are represented by the same reference numerals or symbols and will be omitted from detailed description.

In this embodiment, the density non-uniformity of the test image is detected using a sensor provided in the image forming apparatus 100, and the remaining lifetime of the photosensitive member 1 is automatically detected by the image forming apparatus 100, so that notification of a detection result thereof can be provided. Particularly, in this embodiment, the density non-uniformity of the toner image for the test image is detected on the intermediary transfer belt 6.

### 1. Optical Sensor

In this embodiment, as shown in FIG. 1, an optical sensor 10 as a density detecting means is provided so that the density of the toner image for the test image transferred onto the intermediary transfer belt 6 can be detected. Specifically, at a position downstream of the most downstream primary transfer portion N1k and upstream of the secondary transfer portion N2 with respect to a movement direction of the intermediary transfer belt 6, the optical sensor 10 is disposed so that the density of the toner image on the intermediary transfer belt 6 in the image forming region can be detected.

In FIG. 14, (a) is a schematic view of the optical sensor 10 in this embodiment. In (a) of FIG. 14, a left-right direction is the main scan direction (a direction substantially perpendicular to the movement direction of the intermediary transfer belt 6). The optical sensor 10 is roughly constituted by including an optical system Q, an amplifier (AMP) 22, a peak detecting circuit 24, a sample and hold circuit 26, an under peak detecting circuit 28 and a sample and hold circuit 30. The optical system Q is constituted by an illumination optical system including a specular reflection LED 10a and a diffusion LED 10b and a light-receiving optical system including a lens 10c, a photodiode 10d and a mask 10e. The specular reflection LED 10a is used for measuring the density of the toner image of black and irradiates the toner image on the intermediary transfer belt 6 with light with an angle of 10 deg. with respect to a normal to a plane of the intermediary transfer belt 6. The diffusion LED 10b is used for measuring the density of the toner image of magenta and irradiates the toner image on the intermediary transfer belt 6 with an angle of 30 deg. with respect to the normal to the plane of the intermediary transfer belt 6. The light-receiving optical system is disposed with an angle of 10 deg. with respect to the normal to the plane of intermediary transfer belt 6. As a result, illumination light emitted from the specular reflection LED 10a and specularly reflected by the plane of the intermediary transfer belt 6 can be received. The specular reflection LED 10a does not receive illumination light emitted from the diffusion LED 10b and specularly reflected by the plane of the intermediary transfer belt 6 and can receive only diffused light from the toner. As the lens 10c of the light-receiving optical system, a lens 3 mm in diameter and 6 mm in focal length is used, and a distance from the surface of the intermediary transfer belt 6 to the lens 10c and a distance from the lens 10c to the photodiode 10d are equal to each other and are 12 mm, so that a magnification of the optical system 1. Immediately in front of the photodiode 10d, the mask 10e for regulating a detection area of the sensor is provided. In this embodiment, a detection window of the mask 10e is a rectangle of 1 mm×1 mm. A portion other than the detection window of the mask 10e is colored black for preventing stray light. By disposing the light-receiving optical system in such a manner, in each of the cases of the specularly reflected light and the diffusely-reflected light, the detection area of the optical sensor 10 can be made 1 mm×1 mm which is equal to the size of the detection window of the mask 10e.

When an optical image of the toner image on the intermediary transfer belt 6 is projected on a light-receiving surface of the photodiode 10d, the photodiode 10d outputs a current changed depending on the density of the optical image. The current outputted from the photodiode 10d is subjected to current-voltage conversion and is amplified, and then is supplied as a sensor output signal to the controller 20, the peak detection circuit 24, the under peak detection circular 28 and the two sample and hold circuits 26 and 30. In the peak detection circuit 24, a maximum peak position of the sensor output signal is detected and is supplied as a peak detection signal to the sample and hold circuit 26. In the sample and hold circuit 26, using the peak detection signal outputted from the peak detection circuit as a trigger, a sensor output signal outputted from the AMP 22 is held. As a result, a maximum value of the sensor output signal is held and is outputted as a hold signal to the controller 20. The controller 20 calculates an image density on the basis of the hold signal and controls the image density. In the number peak detection circuit 28, a minimum peak position of the sensor output signal is detected and supplied as an under peak detection signal to the sample and hold circuit 30. In the sample and hold circuit 30, using the under peak detection signal outputted from the under peak detection circuit 28 as a trigger, a sensor signal outputted from the AMP 22 is held. As a result, a minimum value of the sensor output signal is held and outputted as an under peak hold signal to the controller 20. The controller 20 calculates the image density on the basis of the hold signal and detects the lateral stripe. Incidentally, as the AMP 22, the peak detection circuit 24, the under peak detection circuit 28 and the sample and hold circuits 26 and 30, general-purpose electric circuits are used and will be omitted from description.

The optical sensor 10 includes a shutter 10f. In FIG. 14, (b) is a schematic view showing a structure of the shutter 10f. In (b) of FIG. 14, the shutter 10f as seen from an LED/PD side is shown. The shutter 10f is provided with a measuring window 10g and a reference plate 10h for obtaining a reference of an output voltage of the sensor. The optical sensor 10 further includes a mechanism for moving the shutter 10f in the left-right direction in (b) of FIG. 14 by an unshown driving device. The shutter 10f is in such a position that the reference plate 10n is disposed on a light-receiving optical axis in a closed state thereof in general, and opens only during measurement, and an opening measuring window 10g moves so as to be disposed on the light-receiving optical axis.

### 2. Detection of Lateral Stripe and Calculation of Remaining Lifetime

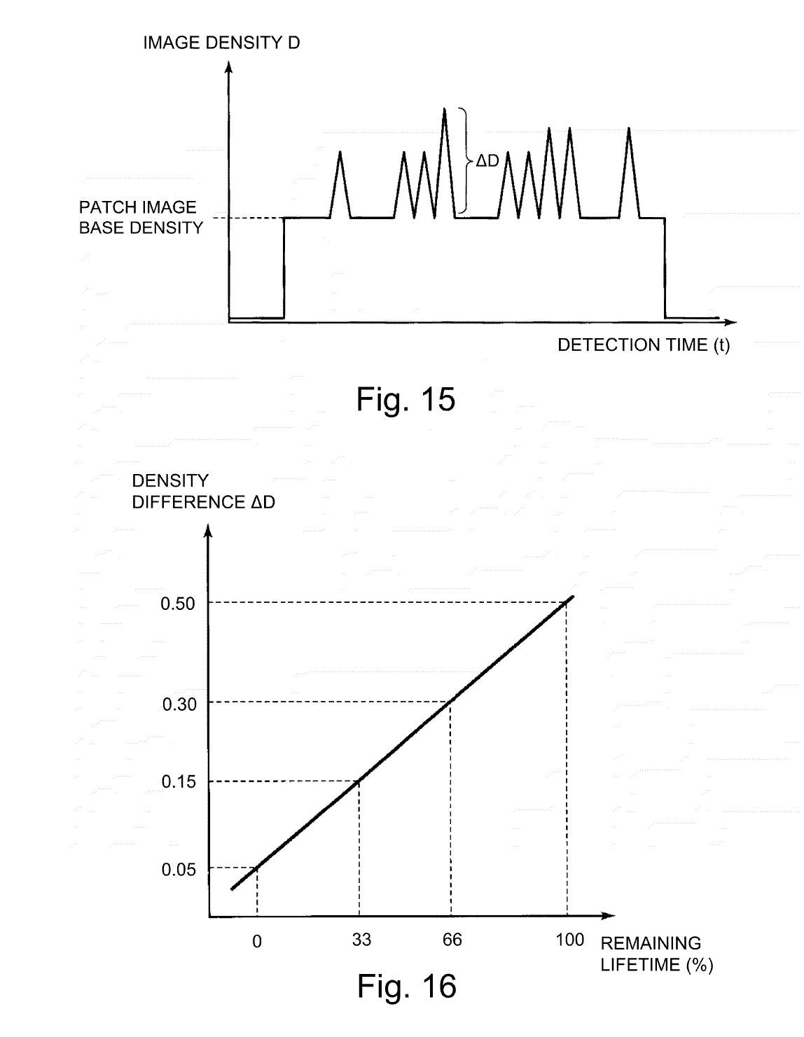

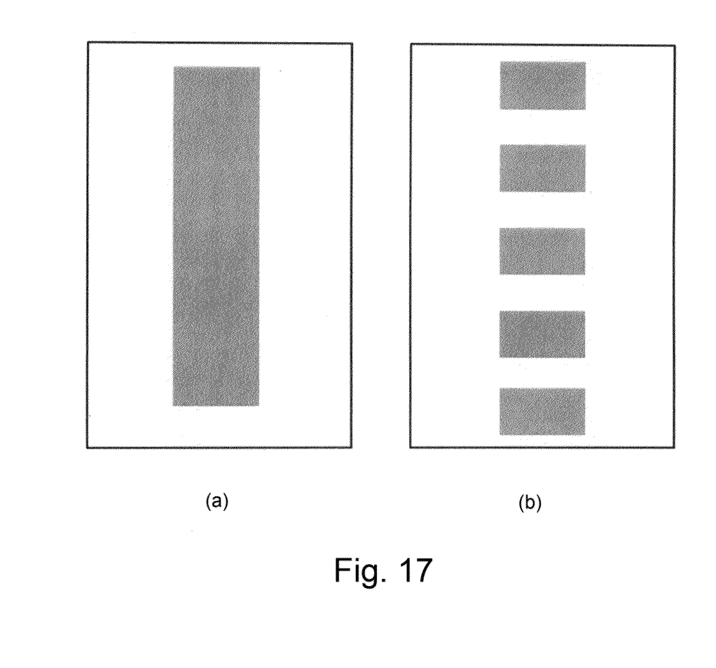

FIG. 15 shows an output result of conversion of the under peak hold signal into an image density D when the lateral stripe generates. The image density D fluctuates by generation of the lateral stripe on the test image outputted on the intermediary transfer belt 6. The test image is formed at certain density setting as a reference, and therefore such a density difference ΔD that the density is higher than a density level as a reference generates. Accordingly, the controller 20 calculates the density difference AD from the reference density as a base thereof. Information showing a relationship between the density difference ΔD and the remaining lifetime of the photosensitive member 1 as shown in FIG. 16 is obtained through an experiment or the like in advance, and is stored in the memory 22 of the controller 20. As a result, from the calculated density difference AD, the controller 20 can obtain the remaining lifetime of the photosensitive member 1 by using the information showing the relationship between the density difference ΔD and the remaining lifetime of the photosensitive member 1 as shown in FIG. 16. As information on the density difference ΔD obtained from information showing a relationship between a detection time (detection position) and the image develop D as shown in FIG. 15, arbitrary information such as a maximum, a minimum or an average can be associated with the remaining lifetime of the photosensitive member 1. In this embodiment, the maximum (value) of the density difference ΔD obtained from the information showing the relationship as shown in FIG. 15 and the remaining lifetime of the photosensitive member 1 are associated with each other.

In this embodiment, the controller 20 stores the obtained information showing a current remaining lifetime of the photosensitive member 1 in the memory 22. Then, the controller 20 enables obtaining of the information showing the remaining lifetime of the photosensitive member 1 by the operator by causing the information to be displayed on demand of the operator.

### 3. Test Image and Test Operation

The test image and the test operation for obtaining the information on the surface recessed portion depth of the photosensitive member 1 in this embodiment will be described.

In this embodiment, with respect to the first to fourth portions SY, SM, SC, SK, in order to grasp the remaining lifetime of the photosensitive member 1, the substantially same test operation is continuously performed successively at the same timing by a single instruction. In the following description, in order to avoid redundancy, a single image forming portion S will be matched and described.

Similarly as in the case of Embodiment 1, as the test image formed on the intermediary transfer belt 6, a halftone image having a predetermined density may preferably be used. In this embodiment, as the test image, a uniform halftone image was formed with a detectable width of the optical sensor 10 with respect to the main scan direction and in a length corresponding to one full circumferential length of the photosensitive member 1 as shown in (a) of FIG. 17. However, the test image is not limited thereto, but may also be a plurality of patch-shaped halftone images formed with respect to a sub-scan direction. As a result, toner consumption can be suppressed.

In this embodiment, the optical sensor 10 is provided in a fixed state at a central portion with respect to the main scan direction. Accordingly, the test image is formed at a central portion with respect to the main scan direction corresponding to a fixed position of the optical sensor 10.

Here, as described in Embodiment 1, the test image may desirably be such an image that a tendency of abrasion of the photosensitive member 1 in the entire image forming region with respect to the main scan direction of the photosensitive member 1 can be grasped. For that purpose, for example, the optical sensor 10 may be constituted so as to be movable in the main scan direction or may be provided at a plurality of positions with respect to the main scan direction, so that the density difference ΔD can be detected at the plurality positions, preferably in the entire region with respect to the main scan direction.

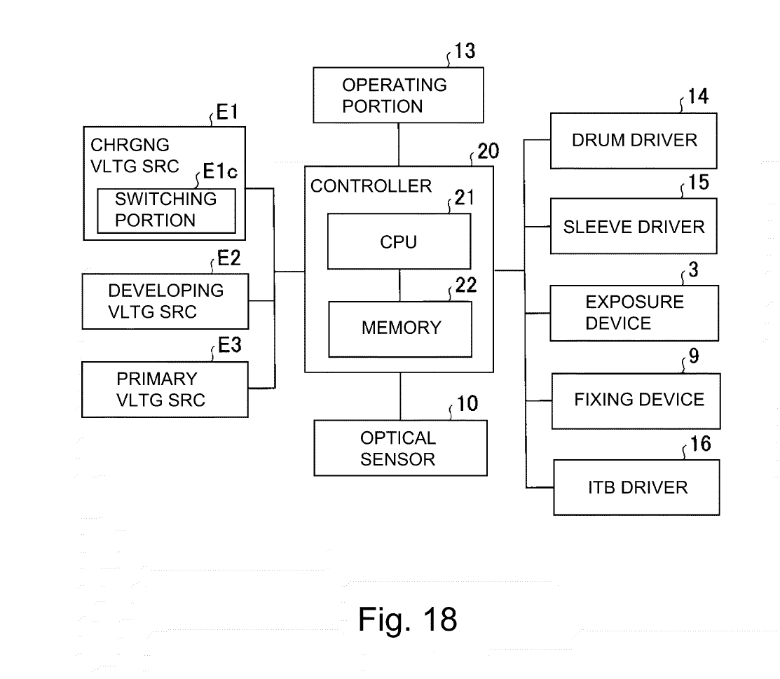

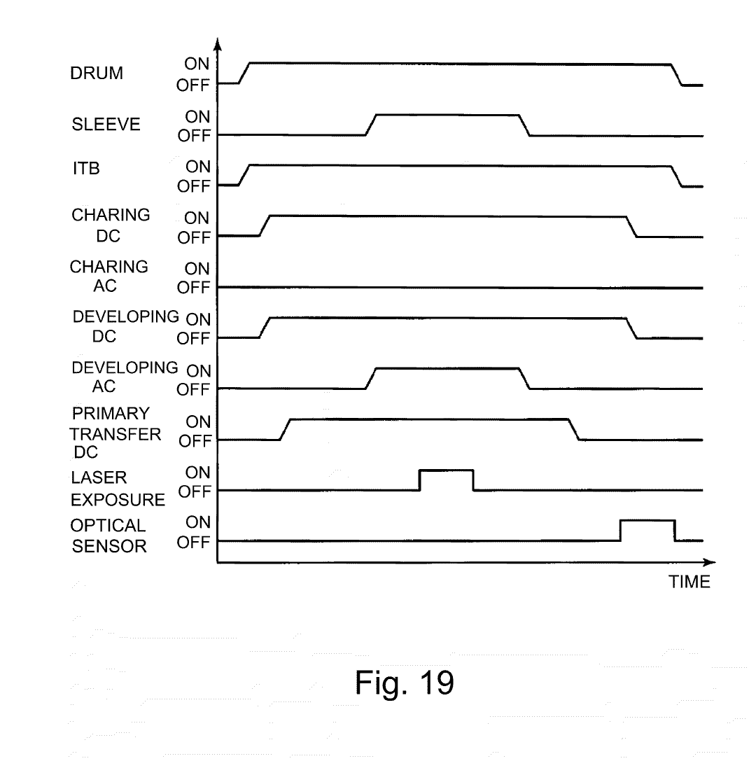

The test operation in this embodiment will be described with reference to FIGS. 18 and 19. FIG. 18 is a block diagram showing a schematic control embodiment of the image forming apparatus 100 in the test operation, and FIG. 19 is a timing chart snowing an operation sequence of respective portions in the test operation.

A control embodiment in the test operation in this embodiment is similar to that in Embodiment 1, but particularly in relation with this embodiment, the optical sensor 10 and the intermediary transfer belt driving portion 16 are further connected with the controller 20. In this embodiment, the controller 20 executes the test operation (photosensitive member plurality detection mode) at predetermined timing and detects the remaining lifetime of the photosensitive member 1, and then stores a detection result thereof. Further, the controller 20 causes the stored information showing the remaining lifetime of the photosensitive member 1 to be displayed in accordance with an instruction of the operator.

The controller 20 goes to the test operation (photosensitive member remaining lifetime detection mode) when a main switch of the image forming apparatus 100 is turned on or the image forming apparatus 100 is restored from a sleep state. The controller 20 starts the rotation of the photosensitive member 1 by the photosensitive member driving portion 14, and starts the rotation of the intermediary transfer belt 6 by the intermediary transfer belt driving portion 16. Then, the controller 20 provides an instruction to the switching portion E1c of the charging voltage source E1 so as to switch the charging voltage to the charging DC voltage (DC charging voltage). Then, the controller 20 starts application of the charging DC voltage from the charging voltage source E1 to the charging roller 2. At this time, the charging AC voltage is in an off state. Then, the controller 20 starts application of the developing DC voltage from the developing voltage source E2 to the developing sleeve 41 of the developing device 4 and starts application of a primary transfer DC voltage from the primary transfer voltage source E3 to the primary transfer roller 5 immediately after the developing DC voltage application. Then, the controller 20 starts the rotation of the developing sleeve 41 by the developing device driving portion 15. Then, the controller 20 starts application of the developing AC voltage from the developing voltage source E2 to the developing sleeve 41 immediately after the start of the rotation of the developing sleeve 41. Then, the controller 20 starts irradiation of the photosensitive member 1 with the laser light from the exposure device 3. At this time, an exposure pattern by the laser light depends on the test image pattern described above in (a) of FIG. 17.

After the exposure by the exposure device 3 is ended, the controller 20 successively stops the application of the developing AC voltage, the rotation of the developing sleeve 41, the application of the primary transfer DC voltage, the application of the developing DC voltage and the application of the charging DC voltage in a reverse order to the procedure described above. Then, the controller 20 stops the rotation of the photosensitive member 1 after the surface of the photosensitive member 1 is sufficiently discharged (charge-removed), and substantially at the same time, also stops the rotation of the intermediary transfer belt 6. In order to discharge the surface of the photosensitive member 1, the surface of the photosensitive member 1 may also be irradiated with light by using a pre-exposure means.

Similarly as in the case of the normal image formation, the toner image for the test image formed on the photosensitive member 1 is primary-transferred from the photosensitive member 1 onto the intermediary transfer belt 6. Then, the optical sensor 10 receives the specularly reflected light as described above at timing when the toner image for the test image transferred on the intermediary transfer belt 6 passes through a detection region of the optical sensor 10. Then, the controller 20 converts the specularly reflected light into density information D on the basis of a light quantity of the light received by the optical sensor 10, and calculates a density difference ΔD which is a density difference component of the density D. Then, the controller 20 derives the remaining lifetime of the photosensitive member 1 from the calculated density difference ΔD using the information showing the relationship between the density difference ΔD and the remaining lifetime of the photosensitive member 1 as shown in FIG. 16, and stores the information showing the remaining lifetime of the photosensitive member 1 in the memory 22. Therefore, the toner image for the test image on the intermediary transfer belt 6 is removed and collected from the intermediary transfer belt 6 by the belt cleaning device 11.

In FIG. 20, (a) is a flowchart showing an outline of a flow of a procedure of the test operation. As described above, when the test operation is started, the controller 20 successively starts the rotation of the photosensitive member 1 and the charging process at the charging DC voltage (S101), so that the toner image for the test image is formed on the intermediary transfer belt (S102). Then, the controller 20 causes the optical sensor 10 to detect the density of the toner image for the test image on the intermediary transfer belt 6 (S103), and calculates the density difference ΔD (S104) to obtain the remaining lifetime of the photosensitive member 1, and then stores the photosensitive member remaining lifetime in the memory (S105). Thereafter, the controller 20 ends the test operation (S106). In FIG. 20, (b) is a flowchart showing an outline of a procedure of an operation for providing notification of the remaining lifetime of the photosensitive member 1. In accordance with an instruction through an operation of an operating button, provided on the operating portion 13, by the operator (S201), the controller 20 reads the information showing the remaining lifetime of the photosensitive member 1 stored in the memory (3202). Then, the controller 20 sends the information showing a current remaining lifetime of the photosensitive member 1 to the operating portion 13 and then causes a display portion (display) provided on the operating portion 13 to display the information showing a current remaining lifetime of the photosensitive member 1 (S203).

In this embodiment, timing when the test operation is executed is the timing of the turning-on of the main switch and the timing of restoration from the sleep state, but is not limited thereto. For example, the test operation can be executed at predetermined timing set depending on a cumulative image output sheet number of the image forming apparatus 100. However, a degree of abrasion of the photosensitive member 1 does not change so large at a level of the image output sheet number in one day, and therefore also the surface recessed portion depth of the photosensitive member 1 does not charge so large. Accordingly, as in this embodiment, a progression of the abrasion of the photosensitive member 1 can be sufficiently grasped by executing the test operation only at the timing of the turning-on of the main switch and at the timing of the restoration from the sleep state. The test operation requires a certain time, and therefore when the test operation is excessively executed frequently, productivity of the image forming apparatus 100 is rather lowered. For this reason, in view of a balance with the productivity of the image forming apparatus 100, it is desirable that the test operation execution timing is determined.

The information showing the remaining lifetime of the photosensitive member 1 may also be stepwise advance notice (message) such as “Still usable sufficiently.”, “Lifetime ends soon. Please prepare for exchange.” or “Lifetime reaches the end. Please exchange the photosensitive member immediately.” A notification method of the information showing the remaining lifetime of the photosensitive member 1 is not limited to display using characters, but may also be in any form such as lighting of a warning lamp or voice.

According to this embodiment, the image forming apparatus 100 can automatically detect the remaining lifetime of the photosensitive member 1. Accordingly, the display is not limited to the display of the information showing the remaining lifetime of the photosensitive member 1 in accordance with the instruction from the operator, but the information showing the remaining lifetime of the photosensitive member 1 may also be automatically displayed at the operating portion 13. For example, in the case where the remaining lifetime is less than a predetermined threshold which is set in advance, the controller 20 can display the information showing the remaining lifetime of the photosensitive member 1 at the operating portion 13. In this case, a plurality of thresholds are provided stepwisely depending on the level of the remaining lifetime of the photosensitive member 1, so that the stepwise advance notice as described above can be displayed, for example.

The information showing the remaining lifetime of the photosensitive member 1 is not limited to that displayed at the display portion of the operating portion 13 provided in the apparatus main assembly of the image forming apparatus 100. For example, in the case where the image forming apparatus 100 is connect with a network, the controller 20 can send the information to a device, connected communicatably with the image forming apparatus 100, such as a device provided at a service station at predetermined timing automatically or in accordance with the instruction. As a result, for example, at the service station, it becomes possible to determine, on the basis of the information, whether or not a service person should be sent to a destination.

As described above, in this embodiment, the image forming apparatus 100 includes, as the sensor 10 for detecting the density of the toner image on the photosensitive member or a transfer-receiving member, the optical sensor for detecting the density of the toner image on the intermediary transfer member as the transfer-receiving member. The image forming apparatus 100 further includes the controller 20 for executing the test operation in which the test image for obtaining the information on the remaining lifetime of the photosensitive member 1 is formed and the toner image density of the test image is detected. In the test operation, the controller forms the test image by charging the photosensitive member 1 under application of the charging voltage consisting of the DC voltage to the charging member 2 and on the basis of the detection result of the test image by the sensor 10, outputs the signal for providing notification of the information showing the remaining lifetime of the photosensitive member 1. The controller 20 is capable of outputting the signal for providing the notification to the storing portion for storing the information showing the remaining lifetime of the photosensitive member 1. The controller outputs the signal for providing the notification to the operating portion 13 provided on the image forming apparatus 100, and is capable of providing the notification showing the remaining lifetime of the photosensitive member 1 at the operating portion 13. The controller 20 outputs the signal for providing the notification to the device connected communicatably with the image forming apparatus 100, and is capable of providing the information showing the remaining lifetime of the photosensitive member 1 in the device.

As described above, according to this embodiment, it is possible for the operator to not only accurately grasp the remaining lifetime of the photosensitive member 1 similarly as in Embodiment 1 but also quickly obtain the information showing the remaining lifetime of the photosensitive member 1 held in the image forming apparatus 100 without forcedly outputting the test image.

### Embodiment 4

Next, another embodiment of the present invention will be described. In this embodiment, basic constitution and operation of the image forming apparatus are the same as those in Embodiment 1. Therefore, elements having the same or corresponding functions and constitutions as those in Embodiment 1 are represented by the same reference numerals or symbols and will be omitted from detailed description.

In this embodiment, similarly as in the modified embodiment of Embodiment 1, in a single test operation, the test image using the DC charging voltage and the comparison test image using the DC t AC charging voltage are formed so that these test images can be compared with each other. For example, the test image and the comparison test image can be continuously formed on the intermediary transfer belt 6. Then, on the basis of a detection result of the toner image density of the test image by the optical sensor 10 and a detection result of the toner image density of the comparison test image by the optical sensor 10, the remaining lifetime of the photosensitive member 1 is detected.

In this embodiment, evaluation can be made in such a manner that the density difference generating in the test image is superposed with the density difference generating in the comparison test image. Accordingly, in this embodiment, on the basis of a difference as the density difference (such as the maximum, the minimum or the average) between the respective test images, the remaining lifetime of the photosensitive member 1 can be obtained. That is, the density difference ΔD may be calculated by the formula: ΔD1−ΔD2. In this formula, ΔD1 is the density difference in the test image formed using the DC charging voltage (charging DC voltage), and ΔD2 is the density difference in the comparison test image formed using the DC+AC charging voltage.

As described above, in this embodiment, the controller 20 outputs the signal for providing the notification of the information showing the remaining lifetime of the photosensitive member 1 on the basis of the detection result of the test image by the sensor 10 and the detection result of the comparison test image by the sensor 10. Particularly, in this embodiment, the controller 20 obtains the information on the density non-uniformity in the test image and in the comparison test image on the basis of the detection results of the test image and the comparison test image, respectively, by the sensor 10. Then, on the basis of the difference between the information on the density non-uniformity in the test image and the information on the comparison test image, the controller 20 outputs the signal for providing notification of the information showing the remaining lifetime of the photosensitive member 1. In this embodiment, the information on the density non-uniformity is a magnitude of the density difference generating with respect to a reference density of the test image.

Similarly as described in the modified embodiment of embodiment 1, for example, the density non-uniformity existing in both of the test image and the comparison test image can be evaluated as being not the lateral stripe generating depending on the recessed portion depth of the photosensitive member 1 in some cases. In this case, by comparing pieces of the information, obtained for the respective test images, showing the relationship between the detection time (detection position) and the image density D as shown in FIG. 15, the remaining lifetime of the photosensitive member 1 can be obtained on the basis of the density difference ΔD other than the detection time (detection position) generating in the test image and the comparison test image. Also in this case, on the basis of the maximum, the minimum, the average or the like of the density difference ΔD other than the factor to be excluded, the remaining lifetime of the photosensitive member 1 can be obtained from the relationship between the density difference ΔD and the remaining lifetime of the photosensitive member 1 as shown in FIG. 16.

As described above, Embodiments 1 to 4 are specifically explained, but the present invention is not limited thereto.

For example, in Embodiments 3 and 4, the density non-uniformity of the test image is detected on the intermediary transfer belt 6 as the transfer-receiving member, but the present invention is not limited thereto. The density non-uniformity of the test image may also be detected on the photosensitive member or on the transfer material as the transfer-receiving member. In the case where the density non-uniformity of the test image is detected on the transfer material, the detection can be made not only in a state in which the toner image is not fixed on the transfer material but also in a state in which the toner image is fixed on the transfer material.

In the above-described embodiments, the image forming apparatus of the intermediary transfer type is described, but the type of the image forming apparatus is not limited thereto. The image forming apparatus may also be of a type in which the toner image is directly transferred from the photosensitive member onto the transfer material. For example, a type in which a transfer material carrying member for carrying and feeding the transfer material is provided in place of the intermediary transfer member in the above-described embodiments and the toner images are successively transferred from the plurality of photosensitive members onto the transfer material carried on the transfer material carrying member is well known. As the transfer material carrying member, a transfer material carrying belt or the like similar to the Intermediary transfer belt in the above-described embodiments is used. In this case, the transfer material carrying member, a transfer member contacting the transfer material carrying member toward the photosensitive member, and the like constitute a transfer device for transferring the toner image from the photosensitive member onto the transfer material. In such an image forming apparatus, in the case where the density non-uniformity of the test image is detected by the optical sensor as in Embodiments 3 and 4, the detection can be made on any one of the photosensitive member, the transfer material carrying member as the transfer-receiving member and the transfer material as the transfer-receiving member. The image forming apparatus is not limited to the color image forming apparatus, but may also be a monochromatic (single color) image forming apparatus for a single color such as black.

In the above-described embodiments, the charging member is described as the contact charging member contacting the photosensitive member, but may also be provided in non-contact with and closely to the photosensitive member if the charging member can charge the photosensitive member by the above-described discharge phenomenon in the gap between the charging member and the photosensitive member.

### Embodiment 5

Next, another embodiment of the present invention will be described. In this embodiment, basic constitution and operation of the image forming apparatus are the same as those in Embodiment 1. Therefore, elements having the same or corresponding functions and constitutions as those in Embodiment 1 are represented by the same reference numerals or symbols and will be omitted from detailed description.

In this embodiment, to the charging roller 2, a charging voltage (charging bias) is applied via the core metal under a predetermined condition by a charging voltage source (high voltage source) E1 as a voltage applying means. In this embodiment, the charging voltage source E1 is constituted by a DC voltage source from which a charging voltage (charging DC voltage) consisting only of a DC voltage component is applied to the charging roller 2.

### 1. Generation of Lateral Stripe

A lateral (horizontal) stripe (lateral stripe image, lateral stripe phenomenon) is a stripe density non-uniformity appearing on the image along the longitudinal direction (main scan direction) of the photosensitive member 1. The lateral stripe is a phenomenon appearing due to generation of a minute improper charging caused by insufficient charging power to the photosensitive member 1 at the gap between the photosensitive member 1 and the charging roller 2 in or in the neighborhood of the charging nip although the potential of the photosensitive member 1 reaches a desired potential. Accordingly, the lateral stripe is in general not readily generated on the image outputted using the charging voltage in the form of the charging DC. voltage biased with the charging AC voltage. On the other hand, the lateral stripe is liable to generate on the image outputted using the charging voltage consisting only of the charging DC voltage.

In the case where the image is outputted using the charging voltage consisting only of charging DC voltage, the image is influenced by a minute fluctuation in magnitude of the gap. For that reason, spark discharge intermittently generates from the charging roller 2, so that the photosensitive member 1 is liable to be in a minute improper charging state, and thus the spark discharge is liable to appear as the lateral stripe on the image as shown in (b) of FIG. 12, for example. On the other hand, in the case where the image is outputted using the charging voltage in the form of the charging DC voltage biased with the charging AC voltage, at the gap between the photosensitive member 1 and the charging roller 2, the spark discharge continuously generates and is a very stable state. This is because AC discharge generates. For that reason, the minute charge non-uniformity generated due to the minute fluctuation in magnitude of the gap or the like is immediately made uniform, so that the improper charging does not readily generate.

The surface recessed portions of the photosensitive member 1 have a large influence on an electric discharge state at the charging portion. Between the surface of the photosensitive member 1 and the charging roller 2, the gap between the photosensitive member 1 and the charging roller 2 is formed on each of an upstream side and a switch side of the charging nip with respect to the movement direction of the surface of the photosensitive member 1. In regions where the upstream-side gap and the downstream-side gap are formed, discharge regions (upstream discharge region and downstream discharge region) where the electric discharge generates exist.

In the case where the DC charging method is employed, even when the surface unevenness of the photosensitive member 1 generates, control is effected so as not to generate an abnormal image such as the lateral stripe by controlling the discharge state in the downstream discharge region. That is, first, in the case where the discharge state in the downstream discharge region is a state in which the discharge little generates, the potential of the photosensitive member 1 is not disturbed by the discharge of the charging roller 2, so that the abnormal image does not generate. Second, in the case where the discharge state in the downstream discharge region is a state in which the discharge stably generates, the potential of the photosensitive member 1 is not disturbed by the discharge of the charging roller 2, so that the abnormal image does not generates.

On the other hand, it is known that in the case where a potential difference between the photosensitive member 1 and the charging roller 2 in the downstream discharge region is, e.g., 10-20 V, where unstable discharge starts to generate between the charging roller 2 and the photosensitive member 1, abnormal discharge generates and thus the abnormal image generates. When such a surface unevenness of the photosensitive member 1 that the gap between the photosensitive member 1 and the charging roller 2 is abruptly generated exists in the downstream discharge Legion placed in the unstable discharge state, unstable discharge is started from the region as a starting point, so that the image defect such as the lateral stripe generates.

As a system constitution for suppressing the generation of the lateral stripe, the following two patterns exist. One is a system, such as use of the photosensitive member 1 which does not readily generate dark decay of the surface potential, in which the discharge in the downstream discharge region is not generated to the possible extent. Here, the photosensitive member 1 which does not readily generate the dark decay of the surface potential is a photosensitive member or the like showing a remarkably small value of dielectric loss tan δ in a frequency band corresponding to, e.g., a time in which a certain surface part of the photosensitive member 1 passes through the charging nip. Specifically, in the system in which the discharge is not generated to the possible extent, the potential difference between the photosensitive member 1 and the charging roller 2 in the downstream discharge region is set so as to be less than 10 V. The other one is a system, such as use of the charging roller 2 on which an electric resistance is high and the charge potential is not readily ensured in the upstream discharge region, in which the degree of the discharge in the downstream discharge region is large. Specifically, in the system in which the degree of the discharge in the downstream discharge region is large, the potential difference between the photosensitive member 1 and the charging roller 2 in the downstream discharge region is set so as to exceed 20 V.

In the system in which the discharge in the downstream discharge region is not generated to the possible extent, the light quantity of the pre-exposure is made stronger than a normal light quantity set so as not to generate the lateral stripe. As a result, a dark decay amount of the surface potential of the photosensitive member 1 during passing through the charging nip becomes large, and therefore the discharge state in the downstream discharge region can be changed to such a discharge state that the lateral stripe generates. In this case, specifically, the pre-exposure light quantity is made large so that the potential difference between the photosensitive member 1 and the charging roller 2 in the downstream discharge region falls within a range from 10 V to 20 V.

In the system in which the degree of the discharge in the downstream discharge region is large, the light quantity of the pre-exposure is made weaker than a normal light quantity set so as not to generate the lateral stripe. As a result, a dark decay amount of the surface potential of the photosensitive member 1 during passing through the charging nip becomes small, and therefore the discharge state in the downstream discharge region can be changed to such a discharge state that the lateral stripe generates. In this case, specifically, the pre-exposure light quantity is made small so that the potential difference between the photosensitive member 1 and the charging roller 2 in the downstream discharge region falls within a range from 10 V to 20 V.

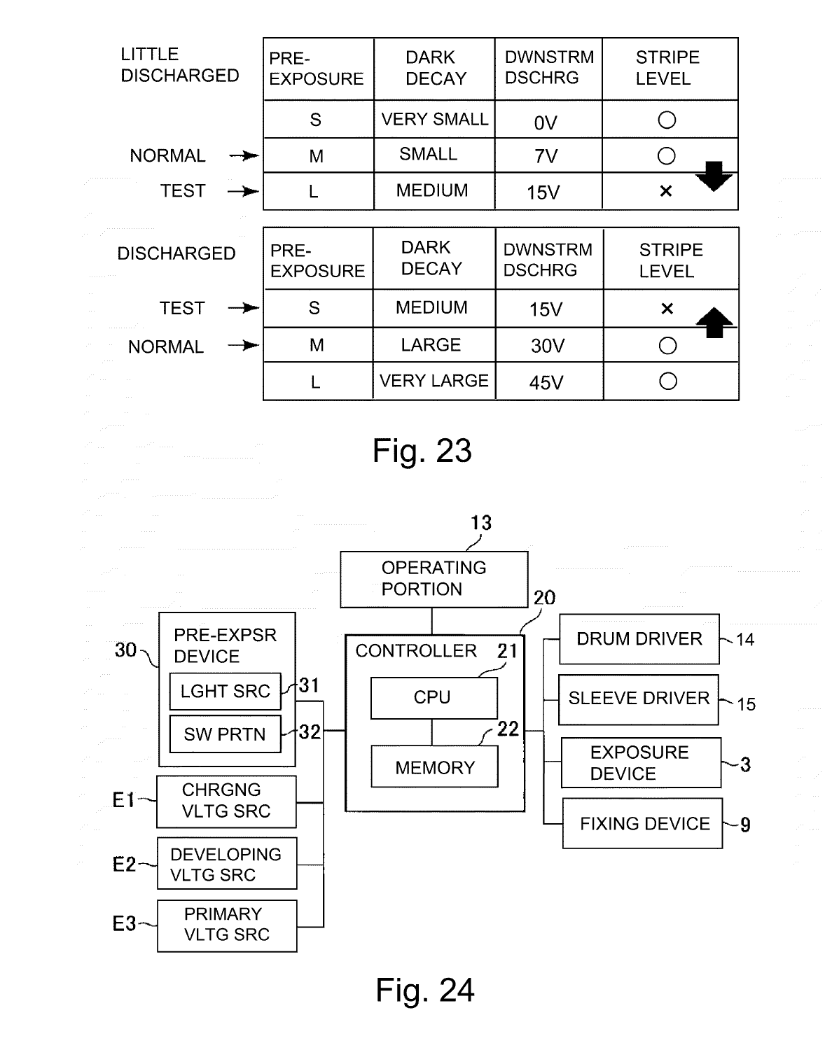

FIG. 23 shows a relationship between the pre-exposure light quantity and the lateral stripe generation level in the above-described two systems. The reason why the downstream discharge region is watched is that the discharge in the downstream discharge region finally has the influence on the lateral stripe on the image.

That is, in the constitution in which the image is formed by the DC charging method, when the photosensitive member 1 is placed in a state in which the lateral stripe does not generate at a pre-exposure amount during the normal image formation, the state is intentionally changed to a state in which the lateral stripe is liable to generate by changing the pre-exposure amount. As a result, depending on the lateral stripe generation level, the surface recessed portion depth of the photosensitive member 1 is detected, so that the remaining lifetime of the photosensitive member 1 can be grasped.

As described above, in the case where a surface potential dark decay amount of the photosensitive member is large, an amount of the discharge generating between the photosensitive member 1 and the charging roller 2 in the downstream discharge region is made small by intentionally making the pre-exposure amount smaller than that during the normal image formation. As a result, the photosensitive member 1 can be intentionally placed in a state in which the lateral stripe which is a barometer of the remaining lifetime of the photosensitive member 1 is liable to generate.

On the other hand, in the case where a surface potential dark decay amount of the photosensitive member is small, an amount of the discharge generating between the photosensitive member 1 and the charging roller 2 in the downstream discharge region is made large by intentionally making the pre-exposure amount larger than that during the normal image formation. As a result, the photosensitive member 1 can be intentionally placed in a state in which the lateral stripe which is a barometer of the remaining lifetime of the photosensitive member 1 is liable to generate.

### 8. Test Image and Test Operation

The test image and the test operation for obtaining the information on the surface recessed portion depth of the photosensitive member 1 in this embodiment will be described.

In this embodiment, with respect to the first to fourth portions SY, SM, SC, SK, in order to grasp the remaining lifetime of the photosensitive member 1, the substantially same test operation is continuously performed successively at the same timing by a single instruction. In the following description, in order to avoid redundancy, a single image forming portion S will be matched and described.

In this embodiment, a system, such as use of the photosensitive member 1 showing a large dark decay of the surface potential, in which the degree of the discharge in the downstream discharge region is large will be described. In this case, the pre-exposure light quantity in the test operation is changed from a pre-exposure light quantity (first light quantity (normal pre-exposure amount) in this embodiment) during the normal image formation to a pre-exposure light quantity (second light quantity (low pre-exposure amount in this embodiment) lower than the first light quantity.

As the test image, from the viewpoint of ease of check of a generation state of the lateral stripe, a halftone image having a predetermined density may preferably be used. In this embodiment, as the test image, a uniform halftone image was formed in an entire area in art A4-sized image forming region as shown in (a) of FIG. 8. However, the test image is not limited thereto, but may also be an image, formed in a part of the image forming region, such as a halftone image formed in a patch shape in a part of the A4-sized image forming region as shown in (b) of FIG. 8. The test image may also be a gradation pattern capable of checking the lateral stripe generation level in various density regions as shown in (c) of FIG. 8.

The surface of the photosensitive member 1 is not uniformly abraded in an entire region with respect to a main scan direction, but is non-uniformly abraded in same cases depending on a pressure (urging force) distribution of the cleaning blade 71, a pressure distribution of the primary transfer roller 5, and the like. For that reason, the test image may desirably be such an image that a tendency of abrasion of the photosensitive member 1 in the entire image forming region with respect to the main scan direction of the photosensitive member 1 can be grasped. For that purpose, the test image may preferably be formed at least a plurality of portions such as a central portion or both end portions of the image forming region with respect to the main scan direction of the photosensitive member 1, and may more preferably be formed in the entire image forming region with respect to the main scan direction.

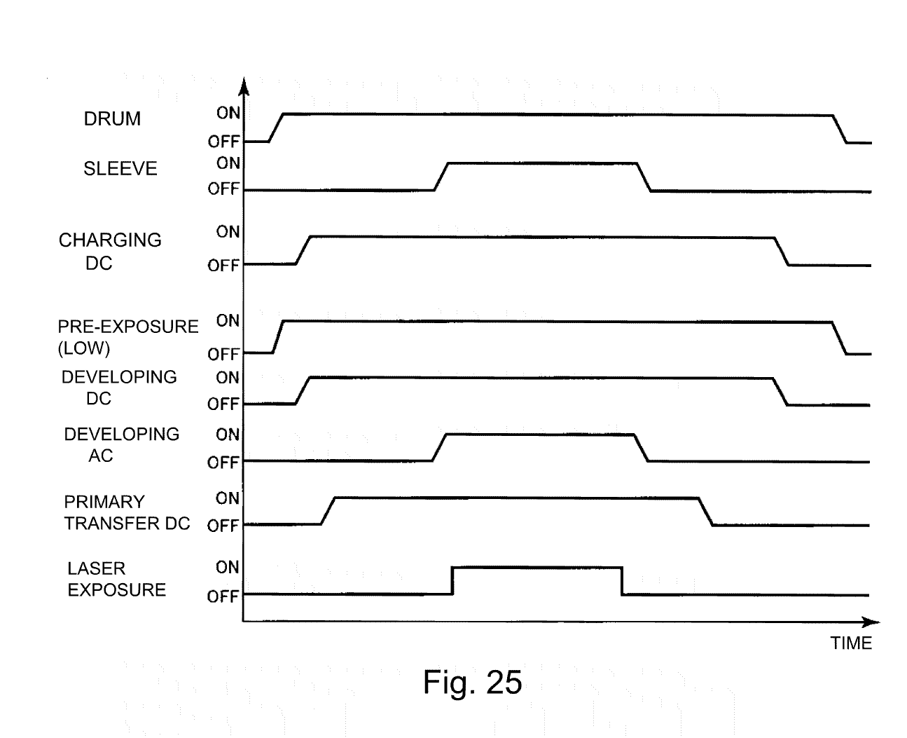

The test operation in this embodiment will be described with reference to FIGS. 24 and 25. FIG. 24 is a block diagram showing a schematic control embodiment of the image forming apparatus 100 in the test operation, and FIG. 25 is a timing chart showing an operation sequence of respective portions in the test operation.

A controller 20 as a control means provided in the image forming apparatus 100 is constituted by including CPU 21 which is a central element for effecting computation, a memory 22 such as ROM or RAM which is storing element (storing portion), and the like. In the RAM, a detection result, a computation result and the like of a sensor are stored, and in the ROM, a control program, a preliminarily obtained data table, and the like are stored. In this embodiment, the controller effect integrated control of the respective portions of the image forming apparatus 100. Particularly, in this embodiment, with the controller 20, the charging voltage source E1, the developing voltage source E2, the primary transfer voltage source E3, an operating portion 13 provided on the apparatus main assembly of the image forming apparatus 100, a photosensitive member driving portion 14, a developing device driving portion 15, the exposure device 3, the fixing device 9, a pre-exposure device 30, and the like are connected. In this embodiment, the controller executes the test operation (test image outputting mode) depending on an instruction through the operating portion 13 by an operator such as a service person or a user, so that the test image is formed on the transfer material P and then is outputted from the image forming apparatus 100.

The controller 20 goes to the test operation (test image outputting mode) depending on the instruction of the operator through an operation of an operating button provided on the operating portion 13, and starts the rotation of the photosensitive member 1 by the photosensitive member driving portion 34. Then, the controller 20 provides an instruction to a switching portion 32 of the pre-exposure device 30 so as to switch the pre-exposure amount to the low pre-exposure amount, so that irradiation of the photosensitive member 1 with the pre-exposure light at the low pre-exposure amount is started substantially at the same timing with start of rotation of the photosensitive member 1. In this embodiment, in the case where the pre-exposure amount was measured on the surface of the photosensitive member 1 through an optical power meter (manufactured by ADVANTEST Corp.), the pre-exposure amount was 20 μW during the normal image formation and was 2 μmW during the test operation. Then, the controller 20 starts application of the charging DC voltage (−1200 V in this embodiment) from the charging voltage source E1 to the charging roller 2. Then, the controller 20 starts application of the developing DC voltage (−450 V in this embodiment) from the developing voltage source E2 to the developing sleeve 41 of the developing device 4 and starts application of a primary transfer DC voltage (+700 V in this embodiment) from the primary transfer voltage source E3 to the primary transfer roller 5 immediately after the developing DC voltage application. The reason why the developing DC voltage is applied to the developing sleeve 41 in a state in which rotation of the developing sleeve 41 is not started is that transfer of the toner existing between the photosensitive member 1 and the developing sleeve 41 onto the photosensitive member 1 is suppressed. Then, the controller 20 starts the rotation of the developing sleeve 41 by the developing device driving portion 15. A time from start of the application of the charging voltage to the charging roller 2 and start of the rotation of the developing sleeve 41 is about 1 sec. This is because the charging roller 2 is rotated through two or three full circumferences until the surface potential of the photosensitive member 1 is stabilized. Then, the controller 20 starts application of the developing AC voltage (e.g., a rectangular wave, frequency: 10 kHz, peak-to-peak voltage: 1.4 kVpp) from the developing voltage source E2 to the developing sleeve 41 immediately after the start of the rotation of the developing sleeve 41. Incidentally, although the development is effected under application of only the developing DC voltage, in order to stabilize the density of the toner image, the developing DC voltage may preferably be biased with the developing AC voltage. Then, the controller 20 starts irradiation of the photosensitive member 1 with the laser light from the exposure device 3. At this time, an exposure pattern by the laser light depends on the test image pattern described above in (a) of FIG. 8.

After the exposure by the exposure device 3 is ended, the controller 20 successively stops the application of the developing AC voltage, the rotation of the developing sleeve 41, the application of the primary transfer DC voltage, the application of the developing DC voltage and the application of the charging DC voltage in a reverse order to the procedure described above. Then, the controller 20 stops the rotation of the photosensitive member 1 after the surface of the photosensitive member 1 is sufficiently discharged (charge-removed), and substantially at the same time, stops the irradiation of the photosensitive member 1 with the pre-exposure light by the pre-exposure device 30.

Similarly as in the case of the normal image formation, the toner image for the test image formed on the photosensitive member 1 is primary-transferred from the photosensitive member 1 onto the intermediary transfer belt and then is secondary-transferred from the intermediary transfer belt 6 onto the transfer material P, followed by fixation on the transfer material P by the fixing device 9. In this way, an output product on which the test Image showing information on the surface recessed portion depth of the photosensitive member 1 is formed on the transfer material P can be obtained by the operator.

### 9. Test Image Output Product and Remaining Lifetime Discrimination of Photosensitive Member

In FIG. 26, (a) schematically shows an example of the test image outputted using the low pre-exposure amount. In this case, the operator compares an actually outputted test image with a preliminarily prepared corresponding chart, e.g., as shown in FIG. 13, which is a reference image for associating the lateral stripe state (status) on the test image with the remaining lifetime of the photosensitive member 1. In the corresponding chart shown in FIG. 13, the lateral stripe state is associated with the surface recessed portion depth of the photosensitive member 1 and the remaining lifetime of the photosensitive member 1. The corresponding chart can be provided by obtaining a relationship between the lateral stripe state and each of the surface recessed portion depth of the photosensitive member 1 and the remaining lifetime of the photosensitive member 1 in advance through an experiment by a provider of the image forming apparatus 100. Then the operator can discriminate the depth (μm) of the recessed portions of the surface of the photosensitive member 1 during output of the test image and a level of the remaining lifetime of the photosensitive member 1 during the output of the test image.

For example, in the case where the generation level of the lateral stripe on the test image actually outputted is to the extent shown in (a) of FIG. 12, from the corresponding chart of FIG. 13, the operator can grasp that the surface recessed portion depth of the photosensitive member 1 is about 1.0 μm and that the remaining lifetime of the photosensitive member 1 is about 0%. That is, as described above, when the surface recessed portion depth of the photosensitive member 1 is about 1.0 Jim or less, there is a liability that the image deletion generates and the turning-out and the abnormal noise of the cleaning blade 71 generate. For this reason, in this case, the operator can grasp that the photosensitive member 1 should be early exchanged (replaced).

For example, in the case where the generation level of the lateral stripe on the test image actually outputted is to the extent shown in (b) of FIG. 12, from the corresponding chart of FIG. 13, the operator can grasp that the surface recessed portion depth of the photosensitive member 1 is still about 2.0 μm and that the remaining lifetime of the photosensitive member 1 is about 66%. In this case, the operator can grasp that there is no need to exchange the photosensitive member 1 for some time.

In this way, the information on the surface recessed portion depth of the photosensitive member 1 is obtained by checking the test image formed using the low pre-exposure amount, so that the remaining lifetime of the photosensitive member 1 can be grasped.

In FIG. 26, (b) schematically shows a test image (left side), as a modified embodiment, outputted using the low pre-exposure amount in the test operation and a comparison test image (right side) outputted using the normal pre-exposure amount. In this example, the test image and the comparison test image are formed and outputted on separate transfer materials P. The comparison test image is formed substantially in the same condition, such as the density and pattern of the halftone image, as that in the case of the test image except that the normal pre-exposure amount similar to that during the normal image formation is used as the pre-exposure amount. In this case, it becomes possible to detect a stripe density non-uniformity caused by a factor other than the lateral stripe generating depending on the surface recessed portion depth of the photosensitive member 1. That is, the comparison test image is outputted using the normal pre-exposure amount, and therefore the lateral stripe depending on the surface recessed portion depth of the photosensitive member 1 does not readily generate. Accordingly, it can be discriminated that the stripe density non-uniformity generating correspondingly to both of the test image (left side) and the comparison test image (right side) generates independently of the surface recessed portion depth of the photosensitive member 1. For that reason, when the surface recessed portion depth of the photosensitive member 1 and the remaining lifetime of the photosensitive member 1 are discriminated through observation of the test image, the test image and the corresponding chart can be checked by the neglect of the stripe density non-uniformity. As a result, a level of accuracy of the remaining lifetime of the photosensitive member 1 grasped by the operator can be improved.

The output of the comparison test image can be performed subsequently to the output of the above-described test image in the test operation. However, the order of the output of the test image and the comparison test image may also be reverse order and the test image and the comparison test image may also be outputted on the same transfer material P if possible.

As described above, in this embodiment, the image forming apparatus 100 includes the controller 20 for executing the image forming operation and the test operation. In the image forming operation, the toner image depending on arbitrary image information is formed and then transferred and outputted on the transfer material P. In the test operation, the test image for obtaining the information on the remaining lifetime of the photosensitive member 1 is formed and then transferred and outputted on the transfer material P. Then, the controller 20 irradiates, during the image forming operation, the photosensitive member 1 with discharge light having the first light quantity which is a light quantity per unit time by the pre-exposure device 30. Further, during the test operation, the controller 20 irradiates the photosensitive member with discharge light having a second light quantity different in light quantity per unit time from the first light quantity by the pre-exposure device 30. Then, the controller 20 forms the test image in the test operation by charging the photosensitive member 1 under application of the charging voltage consisting only of the DC voltage to the charging member 2. Then, the controller 20 can transfer and output, on the transfer material P, the comparison test image which is capable of being compared with the test image and which is formed using the first light quantity as the light quantity for the discharge light.

According to this embodiment, the surface recessed portion depth of the photosensitive member 1 varying depending on the abrasion by use is detected with high accuracy, so that the remaining lifetime of the photosensitive member 1 can be grasped with high accuracy. As a result, the photosensitive member 1 is exchanged at proper timing, so that it is possible to suppress generation of the problems such as the image deletion, the turning-up and the abnormal discharge of the cleaning blade. In addition, the remaining lifetime of the photosensitive member 1 can be accurately grasped, and therefore necessity of the early exchange of the photosensitive member 1 with a margin is reduced, so that it can contribute to lifetime extension of the photosensitive member 1. Further, by such a simple method that the pre-exposure amount is changed without changing a hardware constitution of the image forming apparatus 100, the remaining lifetime of the photosensitive member 1 can be grasped with high accuracy, so that it can also contribute to simplification of the structure of the image forming apparatus 100.

### Embodiment 6

Next, another embodiment of the present invention will be described. In this embodiment, basic constitution and operation of the image forming apparatus are the same as those in Embodiment 5.

In this embodiment, similarly as in Embodiment 5, in the test operation for grasping the remaining lifetime of the photosensitive member 1, the test image formed using the low pre-exposure amount as shown in (a) of FIG. 8 for example is outputted. In addition, in this embodiment, in the test operation, the corresponding chart which is the reference image, e.g., as shown in FIG. 13, formed using the normal pre-exposure amount is outputted. In this embodiment, the test image and the corresponding chart are continuously outputted at the same timing in the test operation performed in accordance with a single instruction. The information of the corresponding chart is obtained in advance through an experiment or the like and is stored in the memory 22 of the controller 20.

As described above, in this embodiment, the test image and the corresponding chart used for discriminating the remaining lifetime of the photosensitive member 1 by the operator are outputted at the same timing in the test operation. That is, in this embodiment, the controller 20 transfers and outputs, on the transfer material P, the reference image which is formed using the first light quantity as the discharge light quantity in the test operation and which is capable of associating the density non-uniformity with the remaining lifetime of the photosensitive member 1. As a result, such a need that the operator prepares the corresponding chart in advance and then stores or carries the corresponding chart as in Embodiment 1 is eliminated, so that it becomes possible to grasp the remaining lifetime of the photosensitive member 1 with use of the corresponding chart outputted on that occasion as needed.

The corresponding chart is outputted using the normal pre-exposure amount, and therefore the lateral stripe depending on the surface recessed portion depth of the photosensitive member 1 does not readily generate and can be used as the reference image.

In the test operation, whether or not the corresponding chart is outputted in the test operation may also be selected by the operator through the operating portion 13 or the like for example. Further, similarly as in the modified embodiment of Embodiment 5, the comparison test operation may also be outputted in the test operation.

As described above, according to this embodiment, not only an effect similar to the effect in Embodiment 1 but also it becomes possible to grasp the remaining lifetime of the photosensitive member 1 without a hitch as needed while eliminating troublesomeness of the storage and carrying of the corresponding chart.

### Embodiment 7

Next, another embodiment of the present invention will be described. In this embodiment, basic constitution and operation of the image forming apparatus are the same as those in Embodiment 5.

In this embodiment, the density non-uniformity of the test image is detected using a sensor provided in the image forming apparatus 100 described in Embodiment 3, and the remaining lifetime of the photosensitive member 1 is automatically detected by the image forming apparatus 100, so that notification of a detection result thereof can be provided. Particularly, in this embodiment, the density non-uniformity of the toner image for the test image is detected on the intermediary transfer belt 6.

### 1. Test Image and Test Operation

The test image and the test operation for obtaining the information on the surface recessed portion depth of the photosensitive member 1 in this embodiment will be described.

In this embodiment, with respect to the first to fourth portions SY, SM, SC, SK, in order to grasp the remaining lifetime of the photosensitive member 1, the substantially same test operation is continuously performed successively at the same timing by a single instruction. In the following description, in order to avoid redundancy, a single image forming portion S will be matched and described.

Similarly as in the case of Embodiment 5, as the test image formed or, the intermediary transfer belt 6, a halftone image having a predetermined density may preferably be used. In this embodiment, as the test image, a uniform halftone image was formed with a detectable width of the optical sensor 10 with respect to the main scan direction and in a length corresponding to one full circumferential length of the photosensitive member 1 as shown in (a) of FIG. 17. However, the test image is not limited thereto, but may also be a plurality of patch-shaped halftone images formed with respect to a sub-scan direction. As a result, toner consumption can be suppressed.

In this embodiment, the optical sensor 10 is provided in a fixed state at a central portion with respect to the main scan direction. Accordingly, the test image is formed at a central portion with respect to the main scan direction corresponding to a fixed position of the optical sensor 10.

Here, as described in Embodiment 5, the test image may desirably be such an image that a tendency of abrasion of the photosensitive member 1 in the entire image forming region with respect to the main scan direction of the photosensitive member 1 can be grasped. For that purpose, for example, the optical sensor 10 may be constituted so as to be movable in the main scan direction or may be provided at a plurality of positions with respect to the main scan direction, so that the density difference ΔD can be detected at the plurality positions, preferably in the entire region with respect to the main scan direction.

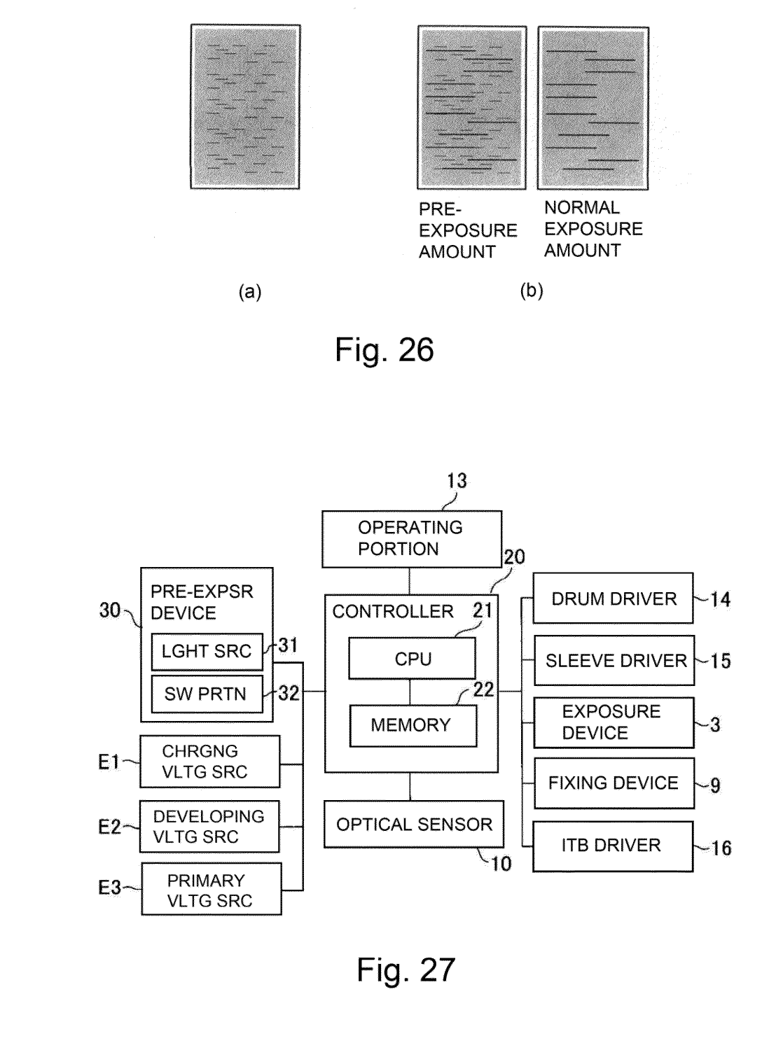

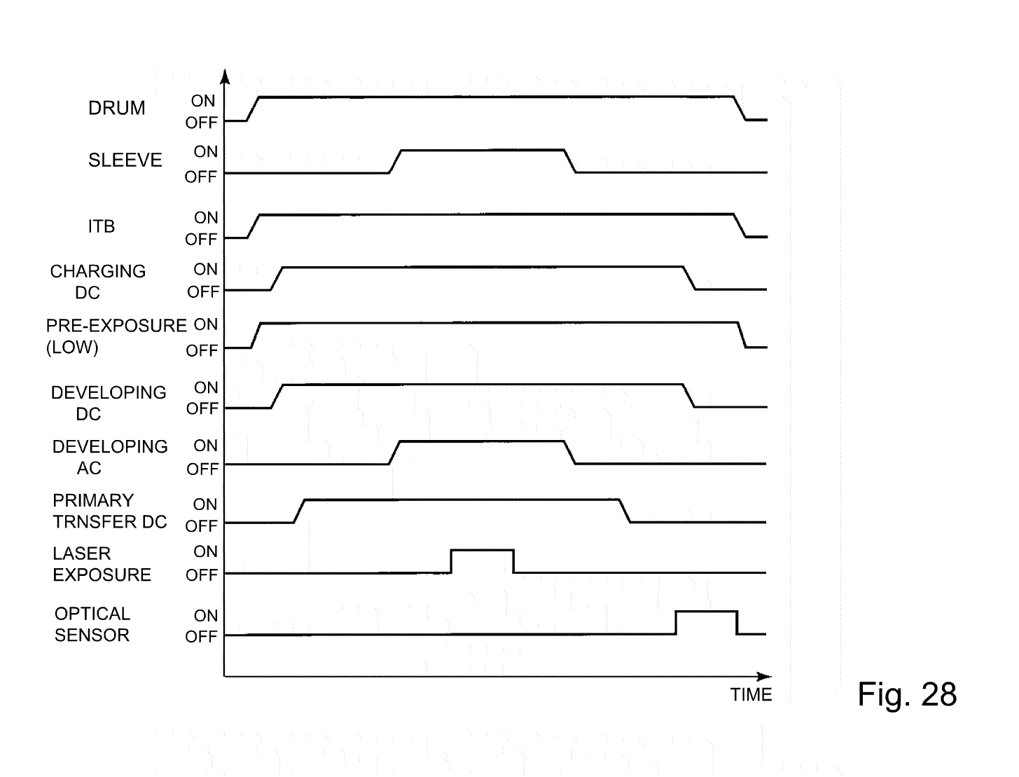

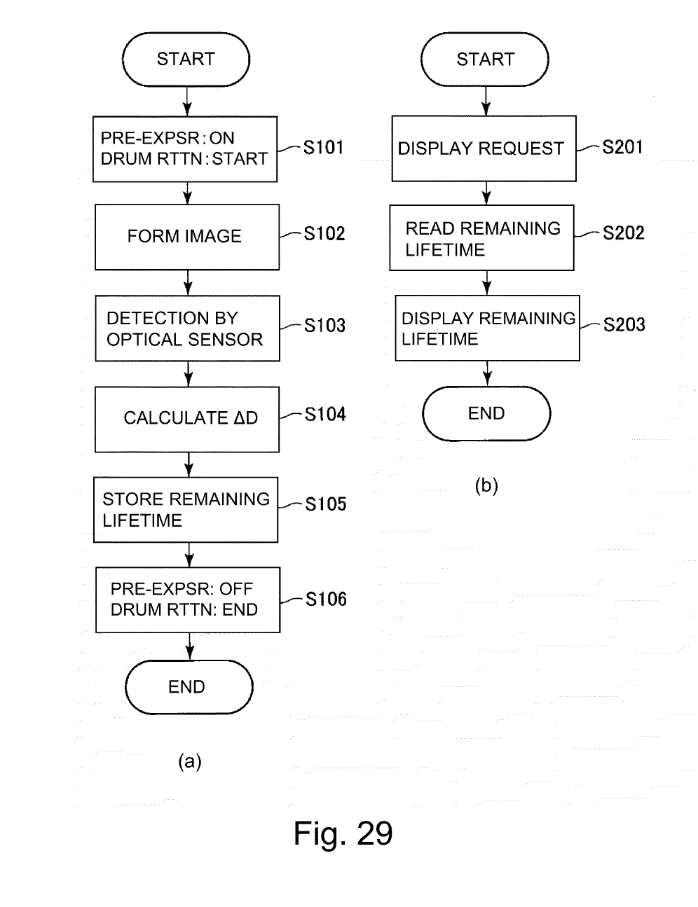

The test operation in this embodiment will be described with reference to FIGS. 27 and 28. FIG. 27 is a block diagram showing a schematic control embodiment of the image forming apparatus 100 in the test operation, and FIG. 28 is a timing chart showing an operation sequence of respective portions in the test operation.

A control embodiment in the test operation in this embodiment is similar to that in Embodiment 1, but particularly in relation with this embodiment, the optical sensor 10 and the intermediary transfer belt driving portion 16 are further connected with the controller 20. In this embodiment, the controller 20 executes the test operation (photosensitive member plurality detection mode) at predetermined timing and detects the remaining lifetime of the photosensitive member 1, and then stores a detection result thereof. Further, the controller 20 causes the stored information showing the remaining lifetime of the photosensitive member 1 to be displayed in accordance with an instruction of the operator.

The controller 20 goes to the test operation (photosensitive member remaining lifetime detection mode) when a main switch of the image forming apparatus 100 is turned on or the image forming apparatus 100 is restored from a sleep state. The controller 20 starts the rotation of the photosensitive member 1 by the photosensitive member driving portion 14, and starts the rotation of the intermediary transfer belt 6 by the intermediary transfer belt driving portion 16. Then, the controller 20 provides an instruction to the switching portion 32 of the pre-exposure device 30 so as to switch the pre-exposure amount to the low pre-exposure amount, so that the pre-exposure light irradiation at the low pre-exposure amount is started substantially at the same timing with start of rotation of the photosensitive member 1. Then, the controller 20 starts application of the charging DC voltage from the charging voltage source E1 to the charging roller 2. Then, the controller 20 starts application of the developing DC voltage from the developing voltage source E2 to the developing sleeve 41 of the developing device 4 and starts application of a primary transfer DC voltage from the primary transfer voltage source E3 to the primary transfer roller 5 immediately after the developing DC voltage application. Then, the controller 20 starts the rotation of the developing sleeve 41 by the developing device driving portion 15. Then, the controller 20 starts application of the developing AC voltage from the developing voltage source E2 to the developing sleeve 41 immediately after the start of the rotation of the developing sleeve 41. Then, the controller 20 starts irradiation of the photosensitive member 1 with the laser light from the exposure device 3. At this time, an exposure pattern by the laser light depends on the test image pattern described above in (a) of FIG. 17.

After the exposure by the exposure device 3 is ended, the controller 20 successively stops the application of the developing AC voltage, the rotation of the developing sleeve 41, the application of the primary transfer DC voltage, the application of the developing DC voltage and the application of the charging DC voltage in a reverse order to the procedure described above. Then, the controller 20 stops the rotation of the photosensitive member 1 after the surface of the photosensitive member 1 is sufficiently discharged (charge-removed), and substantially at the same time, also stops the pre-exposure irradiation by the pre-exposure device 30 and the rotation of the intermediary transfer belt 6.

Similarly as in the case of the normal image formation, the toner image for the test image formed on the photosensitive member 1 is primary-transferred from the photosensitive member 1 onto the intermediary transfer belt 6. Then, the optical sensor 10 receives the specularly reflected light as described above at timing when the toner image for the test image transferred on the intermediary transfer belt 6 passes through a detection region of the optical sensor 10. Then, the controller 20 converts the specularly reflected light into density information D on the basis of a light quantity of the light received by the optical sensor 10, and calculates a density difference ΔD which is a density difference component of the density D. Then, the controller 20 derives the remaining lifetime of the photosensitive member 1 from the calculated density difference ΔD using the information showing the relationship between the density difference ΔD and the remaining lifetime of the photosensitive member 1 as shown in FIG. 16, and stores the information showing the remaining lifetime of the photosensitive member 1 in the memory 22. Therefore, the toner image for the test image on the intermediary transfer belt 6 is removed and collected from the intermediary transfer belt 6 by the belt cleaning device 11.

In FIG. 29, (a) is a flowchart showing an outline of a flow of a procedure of the test operation. As described above, when the test operation is started, the controller 20 successively starts the rotation of the photosensitive member 1 and the like while effecting the pre-exposure at the low pre-exposure amount (S101), so that the toner image for the test image is formed on the intermediary transfer belt (S102). Then, the controller 20 causes the optical sensor 10 to detect the density of the toner image for the test image on the intermediary transfer belt 6 (3103), and calculates the density difference AD (S104) to obtain the remaining lifetime of the photosensitive member 1, and then stores the photosensitive member remaining lifetime in the memory (S105). Thereafter, the controller 20 ends the test operation (S106). In FIG. 29, (b) is a flowchart showing an outline of a procedure of an operation for providing notification of the remaining lifetime of the photosensitive member 1. In accordance with an instruction through an operation of an operating button, provided on the operating portion 13, by the operator (3201), the controller 20 reads the information showing the remaining lifetime of the photosensitive member 1 stored in the memory (S202). Then, the controller 20 sends the information showing a current remaining lifetime of the photosensitive member 1 to the operating portion 13 and then causes a display portion (display) provided on the operating portion 13 to display the information showing a current remaining lifetime of the photosensitive member 1 (S203).

In this embodiment, timing when the test operation is executed is the timing of the turning-on of the main switch and the timing of restoration from the sleep state, but is not limited thereto. For example, the test operation can be executed at predetermined timing set depending on a cumulative image output sheet number of the image forming apparatus 100. However, a degree of abrasion of the photosensitive member 1 does not change so large at a level of the image output sheet number in one day, and therefore also the surface recessed portion depth of the photosensitive member 1 does not charge so large. Accordingly, as in this embodiment, a progression of the abrasion of the photosensitive member 1 can be sufficiently grasped by executing the test operation only at the timing of the turning-on of the main switch and at the timing of the restoration from the sleep state. The test operation requires a certain time, and therefore when the test operation is excessively executed frequently, productivity of the image forming apparatus 100 is rather lowered. For this reason, in view of a balance with the productivity of the image forming apparatus 100, it is desirable that the test operation execution timing is determined.

The information showing the remaining lifetime of the photosensitive member 1 may also be stepwise advance notice (message) such as “Still usable sufficiently.”, “Lifetime ends soon. Please prepare for exchange.” or “Lifetime reaches the end. Please exchange the photosensitive member immediately.” A notification method of the information showing the remaining lifetime of the photosensitive member 1 is not limited to display using characters, but may also be in any form such as lighting of a warning lamp or voice.

According to this embodiment, the image forming apparatus 100 can automatically detect the remaining lifetime of the photosensitive member 1. Accordingly, the display is not limited to the display of the information showing the remaining lifetime of the photosensitive member 1 in accordance with the instruction from the operator, but the information showing the remaining lifetime of the photosensitive member 1 may also be automatically displayed at the operating portion 13. For example, in the case where the remaining lifetime is less than a predetermined threshold which is set in advance, the controller 20 can display the information showing the remaining lifetime of the photosensitive member 1 at the operating portion 13. In this case, a plurality of thresholds are provided stepwisely depending on the level of the remaining lifetime of the photosensitive member 1, so that the stepwise advance notice as described above can be displayed, for example.

The information showing the remaining lifetime of the photosensitive member 1 is not limited to that displayed at the display portion of the operating portion 13 provided in the apparatus main assembly of the image forming apparatus 100. For example, in the case where the image forming apparatus 100 is connect with a network, the controller 20 can send the information to a device, connected communicatably with the image forming apparatus 100, such as a device provided at a service station at predetermined timing automatically or in accordance with the instruction. As a result, for example, at the service station, it becomes possible to determine, on the basis of the information, whether or not a service person should be sent to a destination.

As described above, in this embodiment, the image forming apparatus 100 includes, as the sensor 10 for detecting the density of the toner image on the photosensitive member or a transfer-receiving member, the optical sensor for detecting the density of the toner image on the intermediary transfer member as the transfer-receiving member. The image forming apparatus 100 further includes the controller 20 for executing the test operation in which the test image for obtaining the information on the remaining lifetime of the photosensitive member 1 is formed and the toner image density of the test image is detected. In the image forming operation, the controller 20 causes the pre-exposure device 30 to irradiate the photosensitive member 1 with the discharge light at the first light quantity as the light quantity per unit time. Further, in the test operation, the controller 20 causes the pre-exposure device 30 to irradiate the photosensitive member 1 with the discharge light at the second light quantity different in light quantity per unit time from the first light quantity. Then, the controller 20 forms the test image by charging the photosensitive member 1 under application of the charging voltage consisting of the DC voltage to the charging member 2. On the basis of the detection result of the test image by the sensor 10, outputs the signal for providing notification of the information showing the remaining lifetime of the photosensitive member 1. The controller 20 is capable of outputting the signal for providing the notification to the storing portion for storing the information showing the remaining lifetime of the photosensitive member 1. The controller outputs the signal for providing the notification to the operating portion 13 provided on the image forming apparatus 100, and is capable of providing the notification showing the remaining lifetime of the photosensitive member 1 at the operating portion 13. The controller 20 outputs the signal for providing the notification to the device connected communicatably with the image forming apparatus 100, and is capable of providing the information showing the remaining lifetime of the photosensitive member 1 in the device.

As described above, according to this embodiment, it is possible for the operator to not only accurately grasp the remaining lifetime of the photosensitive member 1 similarly as in Embodiment 5 but also quickly obtain the information showing the remaining lifetime of the photosensitive member 1 held in the image forming apparatus 100 without forcedly outputting the test image.

### Embodiment 8

Next, another embodiment of the present invention will be described. In this embodiment, basic constitution and operation of the image forming apparatus are the same as those in Embodiment 7.

In this embodiment, in a single test operation, the test image using the low pre-exposure amount and the comparison test image using the normal pre-exposure amount are formed so that these test images can be compared with each other. For example, the test image and the comparison test image can be continuously formed on the intermediary transfer belt 6. Then, on the basis of a detection result of the toner Image density of the test image by the optical sensor 10 and a detection result of the toner image density of the comparison test image by the optical sensor 10, the remaining lifetime of the photosensitive member 1 is detected.

In this embodiment, evaluation can be made in such a manner that the density difference generating in the test image is superposed with the density difference generating in the comparison test image. Accordingly, in this embodiment, on the basis of a difference as the density difference (such as the maximum, the minimum or the average) between the respective test images, the remaining lifetime of the photosensitive member 1 can be obtained. That is, the density difference ΔD may be calculated by the formula: ΔD1−ΔD2. In this formula, ΔD1 is the density difference in the test image formed using the low pre-exposure amount, and ΔD2 is the density difference in the comparison test image formed using the normal pre-exposure amount.

As described above, in this embodiment, the controller 20 outputs the signal for providing the notification of the information showing the remaining lifetime of the photosensitive member 1 on the basis of the detection result of the test image by the sensor 10 and the detection result of the comparison test image by the sensor 10. Particularly, in this embodiment, the controller 20 obtains the information on the density non-uniformity in the test image and in the comparison test image on the basis of the detection results of the test image and the comparison test image, respectively, by the sensor 10. Then, on the basis of the difference between the information on the density non-uniformity in the test image and the information on the comparison test image, the controller 20 outputs the signal for providing notification of the information showing the remaining lifetime of the photosensitive member 1. In this embodiment, the information on the density non-uniformity is a magnitude of the density difference generating with respect to a reference density of the test image.

Similarly as described in the modified embodiment of Embodiment 5, for example, the density non-uniformity existing in both of the test image and the comparison test image can be evaluated as being not the lateral stripe generating depending on the recessed portion depth of the photosensitive member 1 in some cases. In this case, by comparing pieces of the information, obtained for the respective test images, showing the relationship between the detection time (detection position) and the image density D as shown in FIG. 15, the remaining lifetime of the photosensitive member 1 can be obtained on the basis of the density difference ΔD other than the detection time (detection position) generating in the test image and the comparison test image. Also in this case, on the basis of the maximum, the minimum, the average or the like of the density difference ΔD other than the factor to be excluded, the remaining lifetime of the photosensitive member 1 can be obtained from the relationship between the density difference ΔD and the remaining lifetime of the photosensitive member 1 as shown in FIG. 16.

As described above, Embodiments 5 to 8 are specifically explained, but the present invention is not limited thereto.

For example, in the above-described embodiments, a system, such as use of the photosensitive member having a large surface potential dark decay, in which a degree of the discharge in the downstream discharge region is large is described, but the present invention is not limited thereto. The present invention is also applicable to a system, such as use of the photosensitive member on which the surface potential dark decay does not readily generate, in which the discharge in the downstream discharge region is not generated to the possible extent. In this case, for example, the pre-exposure amount (first light quantity) during the normal image formation can be set at 3 μW, and the pre-exposure amount (second light quantity) during the test operation can be set at 30 μW higher than the first light quantity. That is, during the normal image formation, there is a system in which the photosensitive member 1 is charged to a predetermined charge potential by the discharge in the gap between the photosensitive member 1 and the charging member 2 on the downstream side of the contact portion between the photosensitive member 1 and the charging member 2 principally with respect to the movement direction of the surface of the photosensitive member 1. In this case, the second light quantity is made smaller than the first light quantity. On the other hand, during the normal image formation, in a system in which the photosensitive member 1 is charged to the predetermined charge potential by the discharge principally on the upstream side, the second light quantity is made larger than the first light quantity.

For example, in Embodiments 7 and 8, the density non-uniformity of the test image is detected on the intermediary transfer belt 6 as the transfer-receiving member, but the present invention is not limited thereto. The density non-uniformity of the test image may also be detected on the photosensitive member or on the transfer material as the transfer-receiving member. In the case where the density non-uniformity of the test image is detected on the transfer material, the detection can be made not only in a state in which the toner image is not fixed on the transfer material but also in a state in which the toner image is fixed on the transfer material.

In the above-described embodiments, the image forming apparatus of the intermediary transfer type is described, but the type of the image forming apparatus is not limited thereto. The image forming apparatus may also be of a type in which the toner image is directly transferred from the photosensitive member onto the transfer material. For example, a type in which a transfer material carrying member for carrying and feeding the transfer material is provided in place of the intermediary transfer member in the above-described embodiments and the toner images are successively transferred from the plurality of photosensitive members onto the transfer material carried on the transfer material carrying member is well known. As the transfer material carrying member, a transfer material carrying belt or the like similar to the intermediary transfer belt in the above-described embodiments is used. In this case, the transfer material carrying member, a transfer member contacting the transfer material carrying member toward the photosensitive member, and the like constitute a transfer device for transferring the toner image from the photosensitive member onto the transfer material. In such an image forming apparatus, in the case where the density non-uniformity of the test image is detected by the optical sensor as in Embodiments 3 and 4, the detection can be made on any one of the photosensitive member, the transfer material carrying member as the transfer-receiving member and the transfer material as the transfer-receiving member. The image forming apparatus is not limited to the color image forming apparatus, but may also be a monochromatic (single color) image forming apparatus for a single color such as black.

### Embodiment 9

Next, another embodiment of the present invention will be described. In this embodiment, basic constitution and operation of the image forming apparatus are the same as those in Embodiment 1.

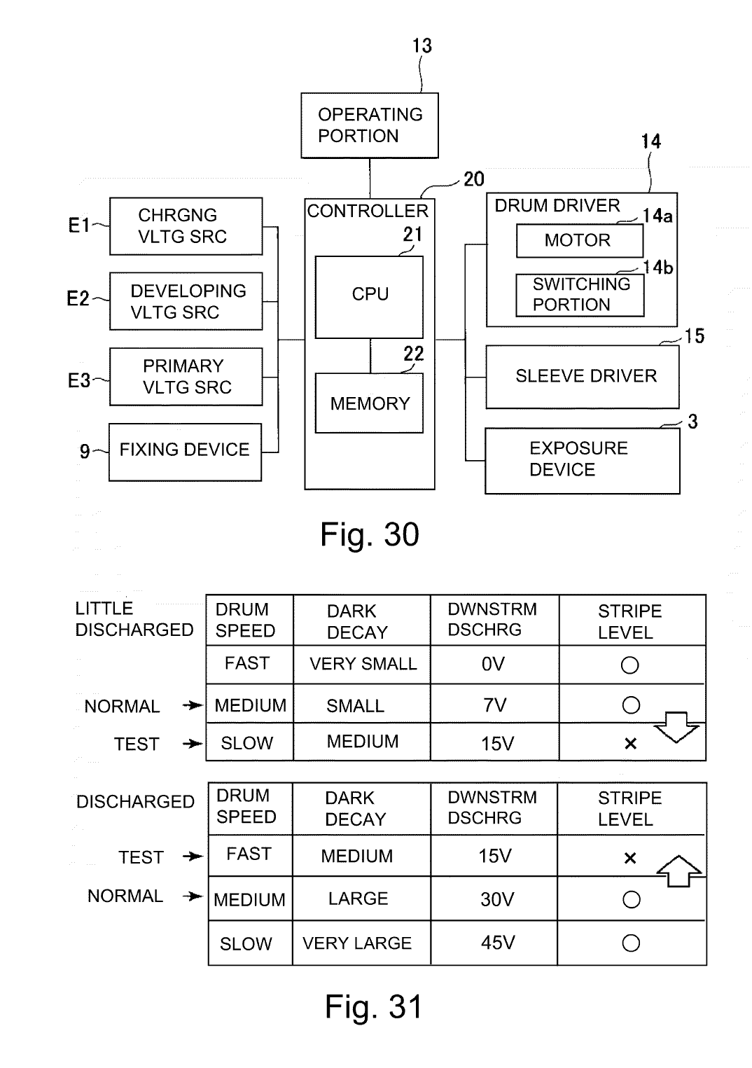

In this embodiment, the photosensitive member 1 is 340 mm in length with respect to the longitudinal direction (rotational axis direction) and 30 mm in outer diameter, and is rotationally driven about a center shaft in an arrow R1 direction in FIG. 1. In this embodiment, the photosensitive member 1 is capable of rotating at a plurality of different rotational speeds. As shown in FIG. 30, the photosensitive member 1 is rotationally driven by the photosensitive member driving portion 14. The photosensitive member driving portion 14 includes a motor 14a as a driving source and a switching portion 14b for switching the rotational speed of the photosensitive member 1. As specifically described later, the switching portion 14b switches the rotational speed of the photosensitive member 1 between during the normal image formation in which an image depending on arbitrary image information is transferred and outputted on the transfer material P and during a test operation described later. In this embodiment, the photosensitive member 1 is rotationally driven at the rotational speed (peripheral speed, process speed) of 300 mm/sec during the normal image formation.

### 1. Generation of Lateral Stripe

A lateral (horizontal) stripe (lateral stripe image, lateral stripe phenomenon) is a stripe density non-uniformity appearing on the image along the longitudinal direction (main scan direction) of the photosensitive member 1. The lateral stripe is a phernomenon appearing due to generation of a minute improper charging caused by insufficient charging power to the photosensitive member 1 at the gap between the photosensitive member 1 and the charging roller 2 in or in the neighborhood of the charging nip although the potential of the photosensitive member 1 reaches a desired potential. Accordingly, the lateral stripe is in general not readily generated on the image outputted using the charging voltage in the form of the charging DC voltage biased with the charging AC voltage. On the other hand, the lateral stripe is liable to generate on the image outputted using the charging voltage consisting only of the charging DC voltage.

In the case where the image is outputted using the charging voltage consists only of charging DC voltage, the image is influenced by a minute fluctuation in magnitude of the gap. For that reason, spark discharge intermittently generates from the charging roller 2, so that the photosensitive member 1 is liable to be in a minute improper charging state, and thus the spark discharge is liable to appear as the lateral stripe on the image as shown in (b) of FIG. 12, for example. On the other hand, in the case where the image is outputted using the charging voltage in the form of the charging DC voltage biased with the charging AC voltage, at the gap between the photosensitive member 1 and the charging roller 2, the spark discharge continuously generates and is a very stable state. This is because AC discharge generates. For that reason, the minute charge non-uniformity generated due to the minute fluctuation in magnitude of the gap or the like is immediately made uniform, so that the improper charging does not readily generate.

The surface recessed portions of the photosensitive member 1 have a large influence on an electric discharge state at the charging portion. Between the surface of the photosensitive member 1 and the charging roller 2, the gap between the photosensitive member 1 and the charging roller 2 is formed on each of an upstream side and a switch side of the charging nip with respect to the movement direction of the surface of the photosensitive member 1. In regions where the upstream-side gap and the downstream-side gap are formed, discharge regions (upstream discharge region and downstream discharge region) where the electric discharge generates exist.

In the case where the DC charging method is employed, even when the surface unevenness of the photosensitive member 1 generates, control is effected so as not to generate an abnormal image such as the lateral stripe by controlling the discharge state in the downstream discharge region. That is, first, in the case where the discharge state in the downstream discharge region is a state in which the discharge little generates, the potential of the photosensitive member 1 is not disturbed by the discharge of the charging roller 2, so that the abnormal image does not generate. Second, in the case where the discharge state in the downstream discharge region is a state in which the discharge stably generates, the potential of the photosensitive member 1 is not disturbed by the discharge of the charging roller 2, so that the abnormal image does not generates.

On the other hand, it is known that in the case where a potential difference between the photosensitive member 1 and the charging roller 2 in the downstream discharge region is, e.g., 10-20 V, where unstable discharge starts to generate between the charging roller 2 and the photosensitive member 1, abnormal discharge generates and thus the abnormal image generates. When such a surface unevenness of the photosensitive member 1 that the gap between the photosensitive member 1 and the charging roller 2 is abruptly generated exists in the downstream discharge region placed in the unstable discharge state, unstable discharge is started from the region as a starting point, so that the image defect such as the lateral stripe generates.

As a system constitution for suppressing the generation of the lateral stripe, the following two patterns exist. One is a system, such as use of the photosensitive member 1 which does not readily generate dark decay of the surface potential, in which the discharge in the downstream discharge region is not generated to the possible extent. Here, the photosensitive member 1 which does not readily generate the dark decay of the surface potential is a photosensitive member or the like showing a remarkably small value of dielectric loss tan δ in a frequency band corresponding to, e.g., a time in which a certain surface part of the photosensitive member 1 passes through the charging nip. Specifically, in the system in which the discharge is not generated to the possible extent, the potential difference between the photosensitive member 1 and the charging roller 2 in the downstream discharge region is set so as to be less than 10 V. The other one is a system, such as use of the charging roller 2 on which an electric resistance is high and the charge potential is not readily ensured in the upstream discharge region, in which the degree of the discharge in the downstream discharge region is large. Specifically, in the system in which the degree of the discharge in the downstream discharge region is large, the potential difference between the photosensitive member 1 and the charging roller 2 in the downstream discharge region is set so as to exceed 20 V. Here, the photosensitive member 1 having the large surface potential dark decay is, e.g., a photosensitive member 1 showing a remarkably large dielectric loss property tan 6 in a frequency band corresponding to a time in which a certain portion of the surface of the photosensitive member 1 passes through the charging nip.

In each of the systems in which the generation of the lateral stripe is suppressed as described above, the lateral stripe can be caused to be readily generated intentionally. A degree of the generation of the lateral stripe correlates with the surface unevenness of the photosensitive member 1, i.e., the surface recessed portion depth of the photosensitive member 1 as described above, and therefore the degree of the generation of the lateral stripe can be used for grasping the remaining lifetime of the photosensitive member 1.

In the system in which the discharge in the downstream discharge region is not generated to the possible extent, the rotational speed of the photosensitive member 1 is made slower than a normal rotational speed set so as not to generate the lateral stripe. As a result, a dark decay amount of the surface potential of the photosensitive member 1 during passing through the charging nip becomes large, and therefore the discharge state in the downstream discharge region can be changed to such a discharge state that the lateral stripe generates. In this case, specifically, the rotational speed of the photosensitive member 1 is made slow so that the potential difference between the photosensitive member 1 and the charging roller 2 in the downstream discharge region falls within a range from 10 V to 20 V.

In the system in which the degree of the discharge in the downstream discharge region is large, the rotational speed of the photosensitive member 1 is made higher than the normal rotational speed set so as not to generate the lateral stripe. As a result, a dark decay amount of the surface potential of the photosensitive member 1 during passing through the charging nip becomes small, and therefore the discharge state in the downstream discharge region can be changed to such a discharge state that the lateral stripe generates. In this case, specifically, the rotational speed of the photosensitive member 1 is made high so that the potential difference between the photosensitive member 1 and the charging roller 2 in the downstream discharge region falls within a range from 10 V to 20 V.

FIG. 31 shows a relationship between the rotational speed of the photosensitive member 1 and the lateral stripe generation level in the above-described two systems. The reason why the downstream discharge region is watched is that the discharge in the downstream discharge region finally has the influence on the lateral stripe on the image.

That is, in the constitution in which the image is formed by the DC charging method, when the photosensitive member 1 is placed in a state in which the lateral stripe does not generate at the rotational speed of the photosensitive member 1 during the normal image formation, the state is intentionally changed to a state in which the lateral stripe is liable to generate by changing the rotational speed of the photosensitive member 1. As a result, depending on the lateral stripe generation level, the surface recessed portion depth of the photosensitive member 1 is detected, so that the remaining lifetime of the photosensitive member 1 can be grasped.

As described above, in the case where a surface potential dark decay amount of the photosensitive member is large, an amount of the discharge generating between the photosensitive member 1 and the charging roller 2 in the downstream discharge region is made small by intentionally making the rotational speed of the photosensitive member 1 higher than that during the normal image formation. As a result, the photosensitive member 1 can be intentionally placed in a state in which the lateral stripe which is a barometer of the remaining lifetime of the photosensitive member 1 is liable to generate.

On the other hand, in the case where a surface potential dark decay amount of the photosensitive member is small, an amount of the discharge generating between the photosensitive member 1 and the charging roller 2 in the downstream discharge region is made large by intentionally making the rotational speed of the photosensitive member 1 slower than that during the normal image formation. As a result, the photosensitive member 1 can be intentionally placed in a state in which the lateral stripe which is a barometer of the remaining lifetime of the photosensitive member 1 is liable to generate.

### 2. Test Image and Test Operation

The test image and the test operation for obtaining the information on the surface recessed portion depth of the photosensitive member 1 in this embodiment will be described.

In this embodiment, with respect to the first to fourth portions SY, SM, SC, SK, in order to grasp the remaining lifetime of the photosensitive member 1, the substantially same test operation is continuously performed successively at the same timing by a single instruction. In the following description, in order to avoid redundancy, a single image forming portion S will be matched and described.

In this embodiment, a system, such as use of the photosensitive member 1 showing a large dark decay of the surface potential, in which the degree of the discharge in the downstream discharge region is large will be described. In this case, the rotational speed of the photosensitive member 1 in the test operation is changed from a rotational speed (first speed (normal rotational speed) in this embodiment) during the normal image formation to a rotational speed (second speed (nigh rotational speed in this embodiment) higher than the first speed.

As the test image, from the viewpoint of ease of check of a generation state of the lateral stripe, a halftone image having a predetermined density may preferably be used. In this embodiment, as the test image, a uniform halftone image was formed in an entire area in an A4-sized image forming region as shown in (a) of FIG. 8. However, the test image is not limited thereto, but may also be an image, formed in a part of the image forming region, such as a halftone image formed in a patch shape in a part of the A4-sized image forming region as shown in (b) of FIG. 8. The test image may also be a gradation pattern capable of checking the lateral stripe generation level in various density regions as shown in (c) of FIG. 8.

The surface of the photosensitive member 1 is not uniformly abraded in an entire region with respect to a main scan direction, but is non-uniformly abraded in same cases depending on a pressure (urging force) distribution of the cleaning blade 71, a pressure distribution of the primary transfer roller 5, and the like. For that reason, the test image may desirably be such an image that a tendency of abrasion of the photosensitive member 1 in the entire image forming region with respect to the main scan direction of the photosensitive member 1 can be grasped. For that purpose, the test image may preferably be formed at least a plurality of portions such as a central portion or both end portions of the image forming region with respect to the main scan direction of the photosensitive member 1, and may more preferably be formed in the entire image forming region with respect to the main scan direction.

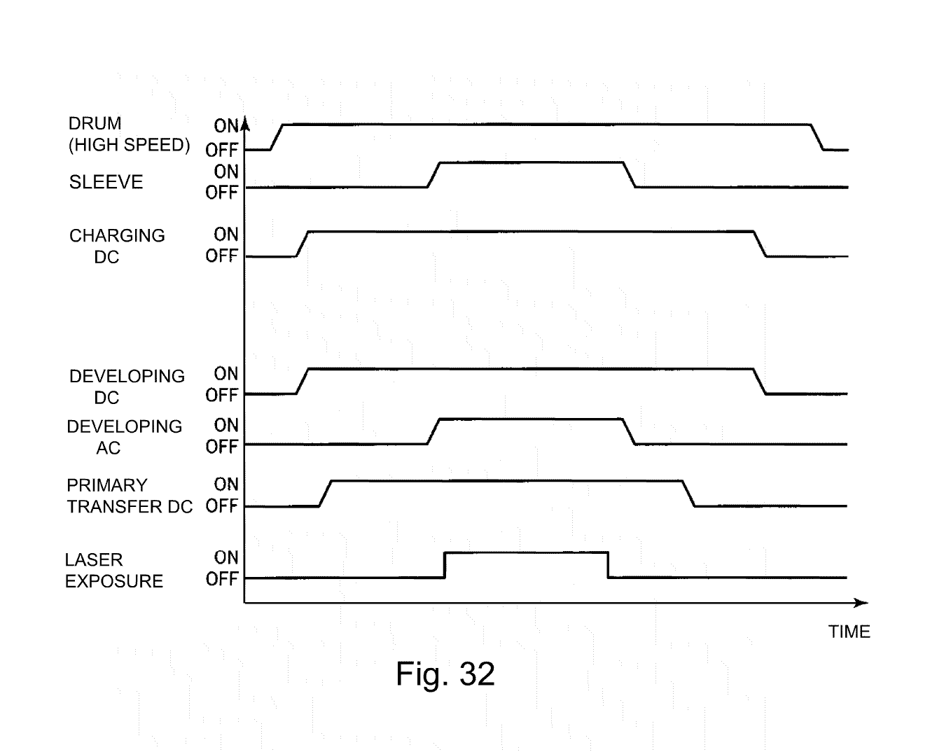

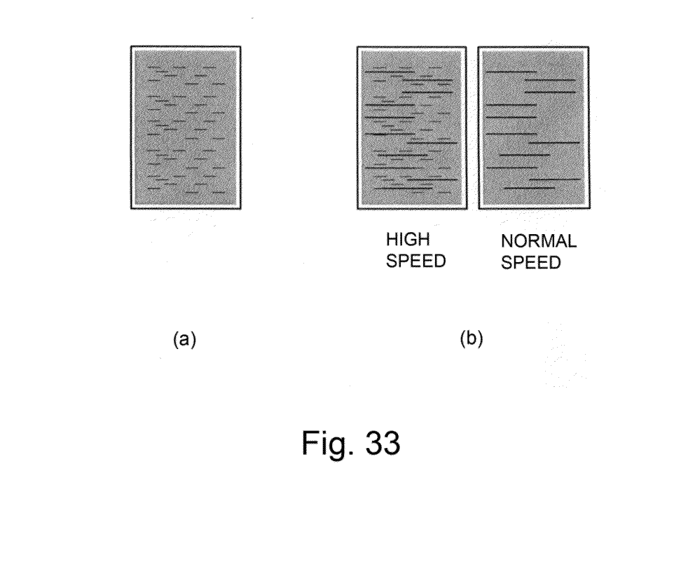

The test operation in this embodiment will be described with reference to FIGS. 30 and 32. FIG. 30 is a block diagram showing a schematic control embodiment of the image forming apparatus 100 in the test operation, and FIG. 32 is a timing chart showing an operation sequence of respective portions in the test operation.

A controller 20 as a control means provided in the image forming apparatus 100 is constituted by including CPU 21 which is a central element for effecting computation, a memory 22 such as RON or RAM which is storing element (storing portion), and the like. In the RAM, a detection result, a computation result and the like of a sensor are stored, and in the ROM, a control program, a preliminarily obtained data table, and the like are stored. In this embodiment, the controller effect integrated control of the respective portions of the image forming apparatus 100. Particularly, in this embodiment, with the controller 20, the charging voltage source E1, the developing voltage source E2, the primary transfer voltage source E3, an operating portion 13 provided on the apparatus main assembly of the image forming apparatus 100, a photosensitive member driving portion 14, a developing device driving portion 15, the exposure device 3, the fixing device 9, and the like are connected. In this embodiment, the controller 20 executes the test operation (test image outputting mode) depending on an instruction through the operating portion 13 by an operator such as a service person or a user, so that the test image is formed on the transfer material P and then is outputted from the image forming apparatus 100.

The controller 20 goes to the test operation (test image outputting mode) depending on the instruction of the operator through an operation of an operating button provided on the operating portion 13, and starts the rotation of the photosensitive member 1 by the photosensitive member driving portion 14. Then, the controller 20 provides an instruction to a switching portion 14b of the photosensitive member driving portion 14 so as to switch the rotational speed of the photosensitive member 1 to the high rotational speed, so that rotation of the photosensitive member 1 is started. In this embodiment, the rotational speed of the photosensitive member 1 is 300 mm/sec (normal rotational speed) during the normal image formation and is 450 mm/sec (high rotational speed) during the test operation. Then, the controller 20 starts application of the charging DC voltage (−1200 V in this embodiment) from the charging voltage source E1 to the charging roller 2. Then, the controller 20 starts application of the developing DC voltage (−450 V in this embodiment) from the developing voltage source E2 to the developing sleeve 41 of the developing device 4 and starts application of a primary transfer DC voltage (+700 V in this embodiment) from the primary transfer voltage source E3 to the primary transfer roller 5 immediately after the developing DC voltage application. The reason why the developing DC voltage is applied to the developing sleeve 41 in a state in which rotation of the developing sleeve 41 is not started is that transfer of the toner existing between the photosensitive member 1 and the developing sleeve 41 onto the photosensitive member 1 is suppressed. Then, the controller 20 starts the rotation of the developing sleeve 41 by the developing device driving portion 15. A time from start of the application of the charging voltage to the charging roller 2 and start of the rotation of the developing sleeve 41 is about 1 sec. This is because the charging roller 2 is rotated through two or three full circumferences to pass through the charging portion a two or three times until the surface potential of the photosensitive member 1 is stabilized. Then, the controller 20 starts application of the developing AC voltage (e.g., a rectangular wave, frequency: 10 kHz, peak-to-peak voltage: 1.4 kVpp) from the developing voltage source E2 to the developing sleeve 41 immediately after the start of the rotation of the developing sleeve 41. Incidentally, although the development is effected under application of only the developing DC voltage, in order to stabilize the density of the toner image, the developing DC voltage may preferably be biased with the developing AC voltage. Then, the controller 20 starts irradiation of the photosensitive member 1 with the laser light from the exposure device 3. At this time, an exposure pattern by the laser light depends on the test image pattern described above in (a) of FIG. 8.

After the exposure by the exposure device 3 is ended, the controller 20 successively stops the application of the developing AC voltage, the rotation of the developing sleeve 41, the application of the primary transfer DC voltage, the application of the developing DC voltage and the application of the charging DC voltage in a reverse order to the procedure described above. Then, the controller 20 stops the rotation of the photosensitive member 1 after the surface of the photosensitive member 1 is sufficiently discharged (charge-removed). In order to discharge the surface of the photosensitive member 1, the surface of the photosensitive member 1 may also be irradiated with light by using a pre-exposure means.

Similarly as in the case of the normal image formation, the toner image for the test image formed on the photosensitive member 1 is primary-transferred from the photosensitive member 1 onto the intermediary transfer belt and then is secondary-transferred from the intermediary transfer belt 6 onto the transfer material P, followed by fixation on the transfer material P by the fixing device 9. When the rotational speed of the photosensitive member 1 is switched to the high rotational speed, also the rotational speed of the intermediary transfer belt 6 is correspondingly made higher than that during the normal image formation. In this way, an output product on which the test image showing information on the surface recessed portion depth of the photosensitive member 1 is formed on the transfer material P can be obtained by the operator.

### 9. Test Image Output Product and Remaining Lifetime Discrimination of Photosensitive Member.

In FIG. 33, (a) schematically shows an example of the test image outputted by rotationally driving the photosensitive member 1 at the high rotational speed. In this case, the operator compares an actually outputted test image with a preliminarily prepared corresponding chart, e.g., as shown in FIG. 13, which is a reference image for associating the lateral stripe state (status) on the test image with the remaining lifetime of the photosensitive member 1. In the corresponding chart shown in FIG. 13, the lateral stripe state is associated with the surface recessed portion depth of the photosensitive member 1 and the remaining lifetime of the photosensitive member 1. The corresponding chart can be provided by obtaining a relationship between the lateral stripe state and each of the surface recessed portion depth of the photosensitive member 1 and the remaining lifetime of the photosensitive member 1 in advance through an experiment by a provider of the image forming apparatus 100. Then the operator can discriminate the depth (μm) of the recessed portions of the surface of the photosensitive member 1 during output of the test image and a level of the remaining lifetime of the photosensitive member 1 during the output of the test image.

For example, in the case where the generation level of the lateral stripe on the test image actually outputted is to the extent shown in (a) of FIG. 12, from the corresponding chart of FIG. 13, the operator can grasp that the surface recessed portion depth of the photosensitive member 1 is about 1.0 μm and that the remaining lifetime of the photosensitive member 1 is about 0%. The lateral stripe generation level in the test image of (a) of FIG. 12 is relatively low. That is, as described above, when the surface recessed portion depth of the photosensitive member 1 is about 1.0 μm or less, there is a liability that the image deletion generates and the turning-out and the abnormal noise of the cleaning blade 71 generate. For this reason, in this case, the operator can grasp that the photosensitive member 1 should be early exchanged (replaced).

For example, in the case where the generation level of the lateral stripe on the test image actually outputted is to the extent shown in (b) of FIG. 12, from the corresponding chart of FIG. 13, the operator can grasp that the surface recessed portion depth of the photosensitive member 1 is still about 2.0 μm and that the remaining lifetime of the photosensitive member 1 is about 66%. The lateral stripe generation level in the test image of (b) of FIG. 12 is relatively low. In this case, the operator can grasp that there is no need to exchange the photosensitive member 1 for some time.

In this way, the information on the surface recessed portion depth of the photosensitive member 1 is obtained by checking the test image formed using the high rotational speed, so that the remaining lifetime of the photosensitive member 1 can be grasped.

In FIG. 33, (b) schematically shows a test image (left side), as a modified embodiment, outputted by rotational driving the photosensitive member 1 at the high rotational speed in the test operation and a comparison test image (right side) outputted by rotationally driving the photosensitive member at the normal rotational speed. The test image and the comparison test image are successively outputted at the same timing in the test operation performed in accordance with a single instruction. In this example, the test image and the comparison test image are formed and outputted on separate transfer materials P. The comparison test image is formed substantially in the same condition, such as the density and pattern of the halftone image, as that in the case of the test image except that the normal rotational speed is used as the rotational speed of the photosensitive member 1. In this case, it becomes possible to detect a stripe density non-uniformity caused by a factor other than the lateral stripe generating depending on the surface recessed portion depth of the photosensitive member 1. That is, the comparison test image is outputted by rotationally driving the photosensitive member 1 at the normal rotational speed, and therefore the lateral stripe depending on the surface recessed portion depth of the photosensitive member 1 does not readily generate. Accordingly, it cart be discriminated that the stripe density non-uniformity generating correspondingly to both of the test image (left side) and the comparison test image (right side) generates independently of the surface recessed portion depth of the photosensitive member 1. For that reason, when the surface recessed portion depth of the photosensitive member 1 and the remaining lifetime of the photosensitive member 1 are discriminated through observation of the test image, the test image and the corresponding chart can De checked by the neglect of the stripe density non-uniformity. As a result, a level of accuracy of the remaining lifetime of the photosensitive member 1 grasped by the operator can be improved.

The output of the comparison test image can be performed subsequently to the output of the above-described test image in the test operation. However, the order of the output of the test image and the comparison test image may also be reverse order and the test image and the comparison test image may also be outputted on the same transfer material P it possible.

As described above, in this embodiment, the image forming apparatus 100 includes the controller 20 for executing the image forming operation and the test operation. In the image forming operation, the toner image depending on arbitrary image information is formed and then transferred and outputted on the transfer material P. In the test operation, the test image for obtaining the information on the remaining lifetime of the photosensitive member 1 is formed and then transferred and outputted on the transfer material P. Then, the controller 20 rotationally drives, during the image forming operation, the photosensitive member 1 at the first speed. Further, during the test operation, the controller 20 rotationally drives the photosensitive member at a second speed different from the first speed. Then, the controller 20 forms the test image in the test operation by charging the photosensitive member 1 under application of the charging voltage consisting only of the DC voltage to the charging member 2. Then, the controller 20 can transfer and output, on the transfer material P, the comparison test image which is capable of being compared with the test image and which is formed on the transfer material P by rotationally driving the photosensitive member 1 at the first speed.

According to this embodiment, the surface recessed portion depth of the photosensitive member 1 varying depending on the abrasion by use is detected with high accuracy, so that the remaining lifetime of the photosensitive member 1 can be grasped with high accuracy. As a result, the photosensitive member 1 is exchanged at proper timing, so that it is possible to suppress generation of the problems such as the image deletion, the turning-up and the abnormal discharge of the cleaning blade. In addition, the remaining lifetime of the photosensitive member 1 can be accurately grasped, and therefore necessity of the early exchange of the photosensitive member 1 with a margin is reduced, so that it can contribute to lifetime extension of the photosensitive member 1. Further, by such a simple method that the rotational speed of the photosensitive member 1 is changed without changing a hardware constitution of the image forming apparatus 100, the remaining lifetime of the photosensitive member 1 can be grasped with high accuracy, so that it can also contribute to simplification of the structure of the image forming apparatus 100.

### Embodiment 10

Next, another embodiment of the present invention will be described. In this embodiment, basic constitution and operation of the image forming apparatus are the same as those in Embodiment 9.

In this embodiment, similarly as in Embodiment 9, in the test operation for grasping the remaining lifetime of the photosensitive member 1, the test image formed by rotationally driving the photosensitive member 1 at the high rotational speed as shown in (a) of FIG. 8 for example is outputted. In addition, in this embodiment, in the test operation, the corresponding chart which is the reference image, e.g., as shown in FIG. 13, formed by rotationally driving the photosensitive member 1 at the normal rotational speed is outputted. In this embodiment, the test image and the corresponding chart are continuously outputted at the same timing in the test operation performed in accordance with a single instruction. The information of the corresponding chart is obtained in advance through an experiment or the like and is stored in the memory 22 of the controller 20.

As described above, in this embodiment, the test image and the corresponding chart used for discriminating the remaining lifetime of the photosensitive member 1 by the operator are outputted at the same timing in the test operation. That is, in this embodiment, the controller 20 transfers and outputs, on the transfer material P, the reference image which is formed by rotationally driving the photosensitive member 1 at the first speed in the test operation and which is capable of associating the density non-uniformity with the remaining lifetime of the photosensitive member 1. As a result, such a need that the operator prepares the corresponding chart in advance and then stores or carries the corresponding chart as in Embodiment 9 is eliminated, so that it becomes possible to grasp the remaining lifetime of the photosensitive member 1 with use of the corresponding chart outputted on that occasion as needed.

The corresponding chart is outputted by rotationally driving the photosensitive member 1 at the normal rotational speed, and therefore the lateral stripe depending on the surface recessed portion depth of the photosensitive member 1 does not readily generate and can be used as the reference image.

In the test operation, whether or not the corresponding chart is outputted in the test operation may also be selected by the operator through the operating portion 13 or the like for example. Further, similarly as in the modified embodiment of Embodiment 9, the comparison test operation may also be outputted in the test operation.

As described above, according to this embodiment, not only an effect similar to the effect in Embodiment 9 but also it becomes possible to grasp the remaining lifetime of the photosensitive member 1 without a hitch as needed while eliminating troublesomeness of the storage and carrying of the corresponding chart.

### Embodiment 11

Next, another embodiment of the present invention will be described. In this embodiment, basic constitution and operation of the image forming apparatus are the same as those in Embodiment 9.

In this embodiment, the density non-uniformity of the test image is detected using a sensor provided in the image forming apparatus 100, and the remaining lifetime of the photosensitive member 1 is automatically detected by the image forming apparatus 100, so that notification of a detection result thereof can be provided. Particularly, in this embodiment, the density non-uniformity of the toner image for the test image is detected on the intermediary transfer belt 6.

### 1. Test Image and Test Operation

The test image and the test operation for obtaining the information on the surface recessed portion depth of the photosensitive member 1 in this embodiment will be described.

In this embodiment, with respect to the first to fourth portions SY, SM, SC, SK, in order to grasp the remaining lifetime of the photosensitive member 1, the substantially same test operation is continuously performed successively at the same timing by a single instruction. In the following description, in order to avoid redundancy, a single image forming portion S will be matched and described.

Similarly as in the case of Embodiment 9, as the test image formed on the intermediary transfer belt 6, a halftone image having a predetermined density may preferably be used. In this embodiment, as the test image, a uniform halftone image was formed with a detectable width of the optical sensor 10 with respect to the main scan direction and in a length corresponding to one full circumferential length of the photosensitive member 1 as shown in (a) of FIG. 17. However, the test image is not limited thereto, but may also be a plurality of patch-shaped halftone images formed with respect to a sub-scan direction. As a result, toner consumption can be suppressed.

In this embodiment, the optical sensor 10 is provided in a fixed state at a central portion with respect to the main scan direction. Accordingly, the test image is formed at a central portion with respect to the main scan direction corresponding to a fixed position of the optical sensor 10.

Here, as described in Embodiment 9, the test image may desirably be such an image that a tendency of abrasion of the photosensitive member 1 in the entire image forming region with respect to the main scan direction of the photosensitive member 1 can be grasped. For that purpose, for example, the optical sensor 10 may be constituted so as to be movable in the main scan direction or may be provided at a plurality of positions with respect to the main scan direction, so that the density difference ΔD can be detected at the plurality positions, preferably in the entire region with respect to the main scan direction.

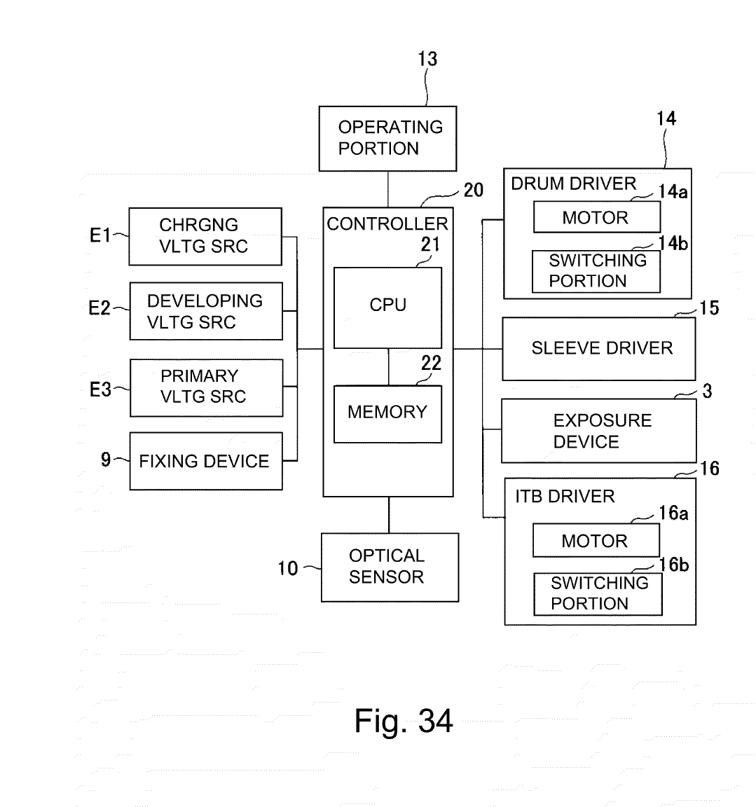

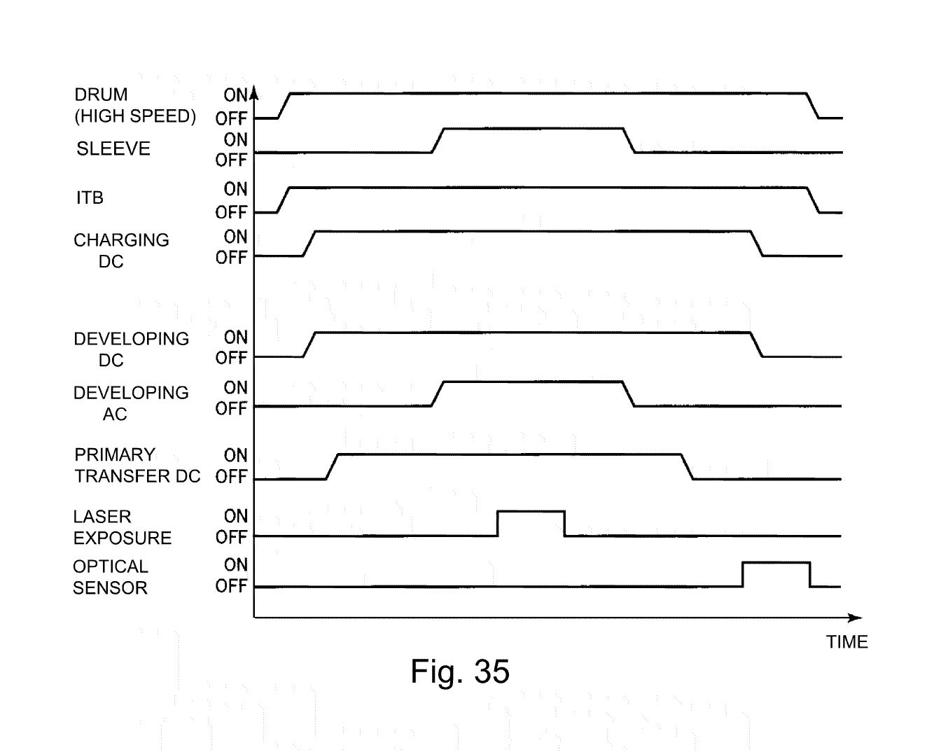

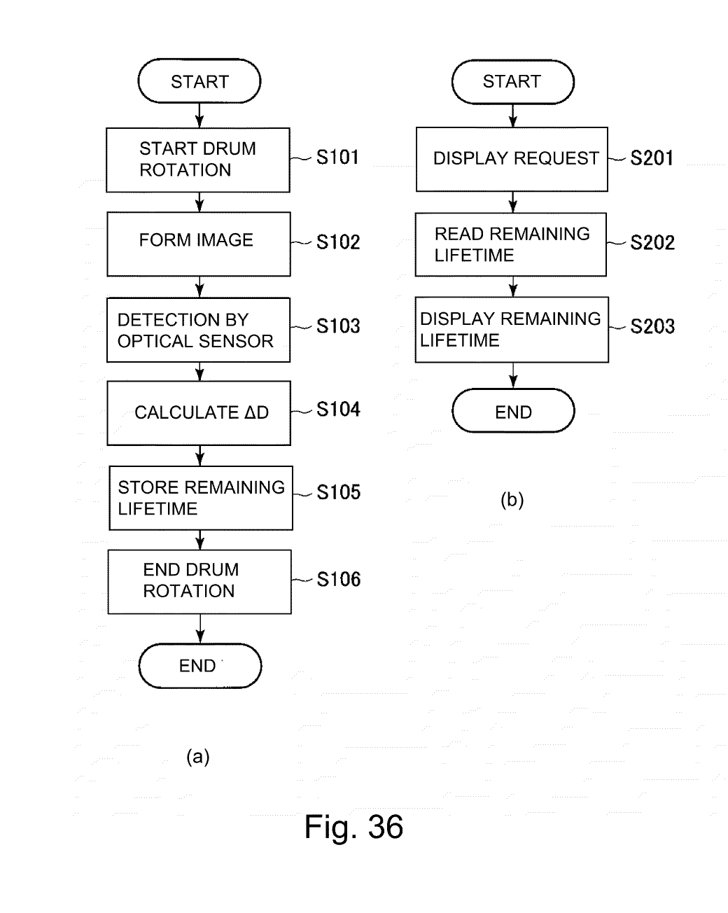

The test operation in this embodiment will be described with reference to FIGS. 34 and 35. FIG. 34 is a block diagram showing a schematic control embodiment of the image forming apparatus 100 in the test operation, and FIG. 35 is a timing chart showing an operation sequence of respective portions in the test operation.

A control embodiment in the test operation in this embodiment is similar to that in Embodiment 9, but particularly in relation with this embodiment, the optical sensor 10 and the intermediary transfer belt driving portion 16 are further connected with the controller 20. The intermediary transfer belt during portion 16 includes a motor 16a as a driving source and a switching portion 16b for switching the rotational speed of the intermediary transfer belt 6 between during normal image formation in which the image to be transferred and outputted on the transfer material P is formed and during the test operation. In this embodiment, the controller 20 executes the test operation (photosensitive member plurality detection mode) at predetermined timing and detects the remaining lifetime of the photosensitive member 1, and then stores a detection result thereof. Further, the controller 20 causes the stored information showing the remaining lifetime of the photosensitive member 1 to be displayed in accordance with an instruction of the operator.

The controller 20 goes to the test operation (photosensitive member remaining lifetime detection mode) when a main switch of the image forming apparatus 100 is turned on or the image forming apparatus 100 is restored from a sleep state. Then, the controller 20 provides an instruction to the switching portion 14b of the photosensitive member driving portion 14 so as to switch the rotational speed of the photosensitive member 1 to the high rotational speed, so that the rotation of the photosensitive member 1 is rotated. Further, at this time, the controller 20 provides an instruction to the switching portion 16b of the intermediary transfer belt 16 so as to make the rotational speed of the intermediary transfer belt 6 higher than that during the normal image formation correspondingly to the rotational speed of the photosensitive member 1. Then, the controller 20 starts application of the charging DC voltage from the charging voltage source E1 to the charging roller 2. Then, the controller 20 starts application of the developing DC voltage from the developing voltage source E2 to the developing sleeve 41 of the developing device 4 and starts application of a primary transfer DC voltage from the primary transfer voltage source E3 to the primary transfer roller 5 immediately after the developing DC voltage application. Then, the controller 20 starts the rotation of the developing sleeve 41 by the developing device driving portion 15. Then, the controller 20 starts application of the developing AC voltage from the developing voltage source E2 to the developing sleeve 41 immediately after the start of the rotation of the developing sleeve 41. Then, the controller 20 starts irradiation of the photosensitive member 1 with the laser light from the exposure device 3. At this time, an exposure pattern by the laser light depends on the test image pattern described above in (a) of FIG. 17.

After the exposure by the exposure device 3 is ended, the controller 20 successively stops the application of the developing AC voltage, the rotation of the developing sleeve 41, the application of the primary transfer DC voltage, the application of the developing DC voltage and the application of the charging DC voltage in a reverse order to the procedure described above. Then, the controller 20 stops the rotation of the photosensitive member 1 after the surface of the photosensitive member 1 is sufficiently discharged (charge-removed). In order to discharge the surface of the photosensitive member 1, the surface of the photosensitive member 1 may also be irradiated with light by using a pre-exposure means.

Similarly as in the case of the normal image formation, the toner image for the test image formed on the photosensitive member 1 is primary-transferred from the photosensitive member 1 onto the intermediary transfer belt 6. Then, the optical sensor 10 receives the specularly reflected light as described above at timing when the toner image for the test image transferred on the intermediary transfer belt 6 passes through a detection region of the optical sensor 10. Then, the controller 20 converts the specularly reflected light into density information D on the basis of a light quantity of the light received by the optical sensor 10, and calculates a density difference ΔD which is a density difference component of the density D. Then, the controller 20 derives the remaining lifetime of the photosensitive member 1 from the calculated density difference ΔD using the information showing the relationship between the density difference ΔD and the remaining lifetime of the photosensitive member 1 as shown in FIG. 16, and stores the information showing the remaining lifetime of the photosensitive member 1 in the memory 22. Therefore, the toner image for the test image on the intermediary transfer belt 6 is removed and collected from the intermediary transfer belt 6 by the belt cleaning device 11.

In FIG. 36, (a) is a flowchart showing an outline of a flow of a procedure of the test operation. As described above, when the test operation is started, the controller 20 successively starts the rotation of the photosensitive member 1 at the high rotational speed and the like (S101), so that the toner image for the test image is formed on the intermediary transfer belt (S102). Then, the controller 20 causes the optical sensor 10 to detect the density of the toner image for the test image on the intermediary transfer belt 6 (S103), and calculates the density difference ΔD (S104) to obtain the remaining lifetime of the photosensitive member 1, and then stores the photosensitive member remaining lifetime in the memory (S105). Thereafter, the controller 20 ends the test operation (S106). In FIG. 36, (b) is a flowchart showing an outline of a procedure of an operation for providing notification of the remaining lifetime of the photosensitive member 1. In accordance with an instruction through an operation of an operating button, provided on the operating portion 13, by the operator (S201), the controller 20 reads the information showing the remaining lifetime of the photosensitive member 1 stored in the memory (S202). Then, the controller 20 sends the information showing a current remaining lifetime of the photosensitive member 1 to the operating portion 13 and then causes a display portion (display) provided on the operating portion 13 to display the information showing a current remaining lifetime of the photosensitive member 1 (S203).

In this embodiment, timing when the test operation is executed is the timing of the turning-on of the main switch and the timing of restoration from the sleep state, but is not limited thereto. Pot example, the test operation can be executed at predetermined timing set depending on a cumulative image output sheet number of the image forming apparatus 100. However, a degree of abrasion of the photosensitive member 1 does not change so large at a level of the image output sheet number in one day, and therefore also the surface recessed portion depth of the photosensitive member 1 does not charge so large. Accordingly, as in this embodiment, a progression of the abrasion of the photosensitive member 1 can be sufficiently grasped by executing the test operation only at the timing of the turning-on of the main switch and at the timing of the restoration from the sleep state. The test operation requires a certain time, and therefore when the test operation is excessively executed frequently, productivity of the image forming apparatus 100 is rather lowered. For this reason, in view of a balance with the productivity of the image forming apparatus 100, it is desirable that the test operation execution timing is determined.

The information showing the remaining lifetime of the photosensitive member 1 may also be stepwise advance notice (message) such as “Still usable sufficiently.”, “Lifetime ends soon. Please prepare for exchange.” or “Lifetime reaches the end. Please exchange the photosensitive member immediately.” A notification method of the information snowing the remaining lifetime of the photosensitive member 1 is not limited to display using characters, but may also be in any form such as lighting of a warning lamp or voice.

According to this embodiment, the image forming apparatus 100 can automatically detect the remaining lifetime of the photosensitive member 1. Accordingly, the display is not limited to the display of the information showing the remaining lifetime of the photosensitive member 1 in accordance with the instruction from the operator, but the information showing the remaining lifetime of the photosensitive member 1 may also be automatically displayed at the operating portion 13. For example, in the case where the remaining lifetime is less than a predetermined threshold which is set in advance, the controller 20 can display the information showing the remaining lifetime of the photosensitive member 1 at the operating portion 13. In this case, a plurality of thresholds are provided stepwisely depending on the level of the remaining lifetime of the photosensitive member 1, so that the stepwise advance notice as described above can be displayed, for example.

The information showing the remaining lifetime of the photosensitive member 1 is not limited to that displayed at the display portion of the operating portion 13 provided in the apparatus main assembly of the image forming apparatus 100. For example, in the case where the image forming apparatus 100 is connect with a network, the controller 20 can send the information to a device, connected communicatably with the image forming apparatus 100, such as a device provided at a service station at predetermined timing automatically or in accordance with the instruction. As a result, for example, at the service station, it becomes possible to determine, on the basis of the information, whether or not a service person should be sent to a destination.

As described above, in this embodiment, the image forming apparatus 100 includes, as the sensor 10 for detecting the density of the toner image on the photosensitive member or a transfer-receiving member, the optical sensor for detecting the density of the toner image on the intermediary transfer member as the transfer-receiving member. The image forming apparatus 100 further includes the controller 20 for executing the test operation in which the test image for obtaining the information on the remaining lifetime of the photosensitive member 1 is formed and the toner image density of the test image is detected. In the image forming operation, the controller 20 rotationally drives the photosensitive member 1 at the first speed. Further, in the test operation, the controller 20 rotationally drives the photosensitive member 1 at the second light quantity different from the first speed. Then, the controller 20 forms the test image by charging the photosensitive member 1 under application of the charging voltage consisting of the DC voltage to the charging member 2. On the basis of the detection result of the test image by the sensor 10, outputs the signal for providing notification of the information showing the remaining lifetime of the photosensitive member 1. The controller 20 is capable of outputting the signal for providing the notification to the storing portion for storing the information showing the remaining lifetime of the photosensitive member 1. The controller outputs the signal for providing the notification to the operating portion 13 provided on the image forming apparatus 100, and is capable of providing the notification showing the remaining lifetime of the photosensitive member 1 at the operating portion 13. The controller 20 outputs the signal for providing the notification to the device connected communicatably with the image forming apparatus 100, and is capable of providing the information showing the remaining lifetime of the photosensitive member 1 in the device.

As described above, according to this embodiment, it is possible for the operator to not only accurately grasp the remaining lifetime of the photosensitive member 1 similarly as in Embodiment 9 but also quickly obtain the information showing the remaining lifetime of the photosensitive member 1 held in the image forming apparatus 100 without forcedly outputting the test image.

### Embodiment 12

Next, another embodiment of the present invention will be described. In this embodiment, basic constitution and operation of the image forming apparatus are the same as those in Embodiment 11.

In this embodiment, similarly as in the modified embodiment of Embodiment 9 in a single test operation, the test image and the comparison test image are formed so that these test images can be compared with each other. The test image is formed by rotationally arriving the photosensitive member 1 at the high rotational speed, and the comparison test image is formed by rotationally driving the photosensitive member 1 at the normal rotational speed. For example, the test image and the comparison test image can be continuously formed on the intermediary transfer belt 6. Then, on the basis of a detection result of the toner image density of the test image by the optical sensor 10 and a detection result of the toner image density of the comparison test image by the optical sensor 10, the remaining lifetime of the photosensitive member 1 is detected.

In this embodiment, evaluation can be made in such a manner that the density difference generating in the test image is superposed with the density difference generating in the comparison test image. Accordingly, in this embodiment, on the basis of a difference as the density difference (such as the maximum, the minimum or the average) between the respective test images, the remaining lifetime of the photosensitive member 1 can be obtained. That is, the density difference ΔD may be calculated by the formula: ΔD1−ΔD2. In this formula, ΔD1 is the density difference in the test image formed by rotationally driving the photosensitive member 1 at the high rotational speed, and ΔD2 is the density difference in the comparison test image formed by rotationally driving the photosensitive member 1 at the normal rotational speed.

As described above, in this embodiment, the controller 20 outputs the signal for providing the notification of the information showing the remaining lifetime of the photosensitive member 1 on the basis of the detection result of the test image by the sensor 10 and the detection result of the comparison test image by the sensor 10. Particularly, in this embodiment, the controller 20 obtains the information on the density non-uniformity in the test image and in the comparison test image on the basis of the detection results of the test image and the comparison test image, respectively, by the sensor 10. Then, on the basis of the difference between the information on the density non-uniformity in the test image and the information on the comparison test image, the controller 20 outputs the signal for providing notification of the information showing the remaining lifetime of the photosensitive member 1. In this embodiment, the information on the density non-uniformity is a magnitude of the density difference generating with respect to a reference density of the test image.

Similarly as described in the modified embodiment of Embodiment 9, for example, the density non-uniformity existing in both of the test image and the comparison test image can be evaluated as being not the lateral stripe generating depending on the recessed portion depth of the photosensitive member 1 in some cases. In this case, by comparing pieces of the information, obtained for the respective test images, showing the relationship between the detection time (detection position) and the image density D as shown in FIG. 15, the remaining lifetime of the photosensitive member 1 can be obtained on the basis of the density difference ΔD other than the detection time (detection position) generating in the test image and the comparison test image. Also in this case, on the basis of the maximum, the minimum, the average or the like of the density difference ΔD other than the factor to be excluded, the remaining lifetime of the photosensitive member 1 can be obtained from the relationship between the density difference ΔD and the remaining lifetime of the photosensitive member 1 as shown in FIG. 16.

As described above, Embodiments 9 to 12 are specifically explained, but the present invention is not limited thereto.

For example, in the above-described embodiments, a system, such as use of the photosensitive member having a large surface potential dark decay, in which a degree of the discharge in the downstream discharge region is large is described, but the present invention is not limited thereto. The present invention is also applicable to a system, such as use of the photosensitive member on which the surface potential dark decay does not readily generate, in which the discharge in the downstream discharge region is not generated to the possible extent. In this case, for example, the photosensitive member rotational speed (first speed) during the normal image formation can be set at 300 mm/sec, and the photosensitive member rotational speed (second speed) during the test operation can be set at 100 mm/sec slower than the first speed. That is, during the normal image formation, there is a system in which the photosensitive member 1 is charged to a predetermined charge potential by the discharge in the gap between the photosensitive member 1 and the charging member 2 on the downstream side of the contact portion between the photosensitive member 1 and the charging member 2 principally with respect to the movement direction of the surface of the photosensitive member 1. In this case, the second speed is made higher than the first speed. On the other hand, during the normal image formation, in a system in which the photosensitive member 1 is charged to the predetermined charge potential by the discharge principally on the upstream side, the second speed is made slower than the first speed.

For example, in Embodiments 11 and 12, the density non-uniformity of the test image is detected on the intermediary transfer belt 6 as the transfer-receiving member, but the present invention is not limited thereto. The density non-uniformity of the test image may also be detected on the photosensitive member or on the transfer material as the transfer-receiving member. In the case where the density non-uniformity of the test image is detected on the transfer material, the detection can be made not only in a state in which the toner image is not fixed on the transfer material but also in a state in which the toner image is fixed on the transfer material.

In the above-described embodiments, the image forming apparatus of the intermediary transfer type is described, but the type of the image forming apparatus is not limited thereto. The image forming apparatus may also be of a type in which the toner image is directly transferred from the photosensitive member onto the transfer material. For example, a type in which a transfer material carrying member for carrying and feeding the transfer material is provided in place of the intermediary transfer member in the above-described embodiments and the toner images are successively transferred from the plurality of photosensitive members onto the transfer material carried on the transfer material carrying member is well known. As the transfer material carrying member, a transfer material carrying belt or the like similar to the intermediary transfer belt in the above-described embodiments is used. In this case, the transfer material carrying member, a transfer member contacting the transfer material carrying member toward the photosensitive member, and the like constitute a transfer device for transferring the toner image from the photosensitive member onto the transfer material. In such an image forming apparatus, in the case where the density non-uniformity of the test image is detected by the optical sensor as in Embodiments 3 and 4, the detection can be made on any one of the photosensitive member, the transfer material carrying member as the transfer-receiving member and the transfer material as the transfer-receiving member. The image forming apparatus is not limited to the color image forming apparatus, but may also be a monochromatic (single color) image forming apparatus for a single color such as black.

As described above, the embodiments of the present invention are described, but the present invention is not limited thereto. The present invention can be modified in any manner within a technical concept of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications Nos. 2015-022736 filed on Feb. 6, 2015, 2015-022737 filed on Feb. 6, 2015 and 2015-022738 filed on Feb. 6, 2015, which are hereby incorporated by reference herein in their entirety.

What is claimed is:

1. An image forming apparatus comprising:
a photosensitive member provided with a plurality of independent recessed portions on a surface thereof;
a charging member, provided closely to or in contact with said photosensitive member, for electrically charging said photosensitive member;
a voltage source for applying, to said charging member, a charging voltage for electrically charging said charging members;
an exposure device for exposing, to light, said photosensitive member charged by said charging member to form an electrostatic image;
a developing device for developing the electrostatic image formed on said photosensitive member by said exposure device into a toner image with a toner;
a transfer device for transferring, onto a transfer material, the toner image formed on said photosensitive member by said developing device; and
a controller for executing an image forming operation in which the toner image is formed depending on an inputted image signal and then is transferred onto the transfer material which is then outputted and for executing a test operation in which a test image for obtaining information on a remaining lifetime of said photosensitive member is formed and transferred onto the transfer material which is then outputted,
wherein said controller applies a voltage in the form of a DC voltage biased with an AC voltage to said charging member during the image forming operation and applies only a DC voltage to said charging member to electrically charge said photosensitive member thereby to form the test image in the test operation.

2. An image forming apparatus according to claim 1, wherein in the test operation, said controller transfers the test image and an image, formed by applying the voltage in the form of the DC voltage biased with the AC voltage to said charging member, onto a sheet and outputs the sheet.

3. An image forming apparatus comprising:
a photosensitive member provided with a plurality of independent recessed portions on a surface thereof;
a charging member, provided closely to or in contact with said photosensitive member, for electrically charging said photosensitive member;
a voltage source for applying, to said charging member, a charging voltage for electrically charging said charging member;
an exposure device for exposing, to light, said photosensitive member charged by said charging member to form an electrostatic image;
a developing device for developing the electrostatic image formed on said photosensitive member by said exposure device into a toner image with a toner;
a transfer device for transferring, onto a transfer-receiving member, the toner image formed on said photosensitive member by said developing device;
a sensor for a density of the toner image on said photosensitive member or the toner image on said transfer-receiving member; and
a controller for executing an image forming operation in which the toner image is formed depending on an inputted image signal and then is transferred onto the transfer material which is then outputted and for executing a test operation in which a test image for obtaining information on a remaining lifetime of said photosensitive member is formed and detects a density of a toner image for the test image by said sensor,
wherein said controller applies a voltage in the form of a DC voltage biased with an AC voltage to said charging member during the image forming operation, and applies a charging voltage constituting only of a DC voltage to said charging member to electrically charge said photosensitive member and then outputs a signal for providing notification of information indicating a remaining lifetime of said photosensitive member on the basis of a detection result for the test image by said sensor during the test operation.

4. An image forming apparatus according to claim 3, wherein in the test operation, said controller forms a comparison test image by applying the voltage in the form of the DC voltage biased with the AC voltage to said charging member and detects a density of a toner image for the comparison test image by said sensor, and then outputs a signal for providing the notification of information indicating the remaining lifetime of said photosensitive member on the basis of a comparison between a detection result for the test image by said sensor and a detection result for the comparison test image by said sensor.

5. An image forming apparatus according to claim 4, wherein said controller obtains pieces of information on density non-uniformity in the test image and the comparison test image on the basis of detection results for the test image and the comparison test image, respectively, by said sensor, and then outputs the signal for providing the notification of information indicating the remaining lifetime of said photosensitive member on the basis of a difference between the information on density non-uniformity in the test image and the information on density non-uniformity in the comparison test image.

6. An image forming apparatus according to claim 5, wherein the information on density non-uniformity is a value of a density difference between the density for the test image and a reference density for the test image.

7. An image forming apparatus according to claim 3, wherein said controller stores the signal for providing the notification in a storing portion for storing the information indicating the remaining lifetime of said photosensitive member.

8. An image forming apparatus according to claim 3, wherein said controller outputs the signal for providing the notification to an operating portion provided on said image forming apparatus and provides the notification of information indicating the remaining lifetime of said photosensitive member at said operating portion.

9. An image forming apparatus according to claim 3, wherein said controller outputs the signal for providing the notification to a device communicatably connected with said image forming apparatus and provides the notification of information indicating the remaining lifetime of said photosensitive member in said device.

10. An image forming apparatus comprising:
a rotatable photosensitive member provided with a plurality of independent recessed portions on a surface thereof,
a charging member, provided in contact with said photosensitive member, for electrically charging said photosensitive member;
a voltage source for applying, to said charging member, a charging voltage for electrically charging said charging member;
an exposure device for exposing, to light, said photosensitive member charged by said charging member to form an electrostatic image;
a developing device for developing the electrostatic image formed on said photosensitive member by said exposure device into a toner image with a toner;
a transfer device for transferring, onto a transfer material, the toner image formed on said photosensitive member by said developing device;
a pre-exposure device for irradiating the surface of said photosensitive member with discharging light at a position downstream of a transfer portion of said transfer device and upstream of a charging portion of said charging member with respect to a rotational direction of said photosensitive member; and
a controller for executing an image forming operation in which the toner image is formed depending on an inputted image signal and then is transferred onto the transfer material which is then outputted and for executing a test operation in which a test image for obtaining information on a remaining lifetime of said photosensitive member is formed and transferred onto the transfer material which is then outputted,
wherein during the image forming operation, said controller causes said pre-exposure device to irradiate the surface of said photosensitive member with the discharging light having a first light quantity per unit time, and
wherein during the test operation, said controller causes said pre-exposure device to irradiate the surface of said photosensitive member with the discharging light having a second light quantity per unit time different from the first light quantity, and applies a charging voltage consisting only of a DC voltage to said charging member to electrically charge said photosensitive member thereby to form the test image.

11. An image forming apparatus according to claim 10, wherein in the test operation, said controller transfers the test image and the charging member test image, formed using the first light quantity of the discharging light, onto a sheet and outputs the sheet.

12. An image forming apparatus comprising:
a photosensitive member provided with a plurality of independent recessed portions on a surface thereof;
a charging member, provided in contact with said photosensitive member, for electrically charging said photosensitive member;
a voltage source for applying, to said charging member, a charging voltage for electrically charging said charging member;
an exposure device for exposing, to light, said photosensitive member charged by said charging member to form an electrostatic image;
a developing device for developing the electrostatic image formed on said photosensitive member by said exposure device into a toner image with a toner;
a transfer device for transferring, onto a transfer-receiving member, the toner image formed on said photosensitive member by said developing device;
a pre-exposure device for irradiating the surface of said photosensitive member with discharging light after transfer by said transfer device and before charging of said charging member;
a sensor for a density of the toner image on said photosensitive member or the toner image on said transfer-receiving member; and
a controller for executing an image forming operation in which the toner image is formed depending on predetermined image information and then is transferred onto the transfer material which is then outputted and for executing a test operation in which a test image for obtaining information on a remaining lifetime of said photosensitive member is formed and detects a density of a toner image for the test image by said sensor,
wherein during the image forming operation, said controller causes said pre-exposure device to irradiate the surface of said photosensitive member with the discharging light having a first light quantity per unit time, and
wherein during the test operation, said controller causes said pre-exposure device to irradiate the surface of said photosensitive member with the discharging light having a second light quantity per unit time different from the first light quantity, and applies a charging voltage consisting only of a DC voltage to said charging member to electrically charge said photosensitive member thereby to form the test image, and then outputs a signal for providing notification of information indicating a remaining lifetime of said photosensitive member on the basis of a detection result for the test image by said sensor.

13. An image forming apparatus according to claim 12, wherein in the test operation, said controller forms a comparison test image using the first light quantity of the discharging light and detects a density of a toner image for the comparison test image by said sensor, and then outputs a signal for providing the notification of information indicating the remaining lifetime of said photosensitive member on the basis of a detection result for the test image by said sensor and a detection result for the comparison test image by said sensor.

14. An image forming apparatus according to claim 13, wherein said controller obtains pieces of information on density non-uniformity in the test image and the comparison test image on the basis of detection results for the test image and the comparison test image, respectively, by said sensor, and then outputs the signal for providing the notification of information indicating the remaining lifetime of said photosensitive member on the basis of a difference between the information on density non-uniformity in the test image and the information on density non-uniformity in the comparison test image.

15. An image forming apparatus according to claim 14, wherein the information on density non-uniformity is a value of a density difference between the density for the test image and a reference density for the test image.

16. An image forming apparatus according to claim 12, wherein said controller stores the signal for providing the notification in a storing portion for storing the information indicating the remaining lifetime of said photosensitive member.

17. An image forming apparatus according to claim 12, wherein said controller outputs the signal for providing the notification to an operating portion provided on said image forming apparatus and provides the notification of information indicating the remaining lifetime of said photosensitive member at said operating portion.

18. An image forming apparatus according to claim 12, wherein said controller outputs the signal for providing the notification to a device communicatably connected with said image forming apparatus and provides the notification of information indicating the remaining lifetime of said photosensitive member in said device.

19. An image forming apparatus according to claim 10, wherein during the image forming operation, said photosensitive member is electrically charged to a predetermined charge potential by electric discharge at a gap between said photosensitive member and said charging member on a downstream side of a contact portion between said photosensitive member and said charging member principally with respect to a surface movement direction of said photosensitive member, and
wherein the second light quantity is smaller than the first light quantity.

20. An image forming apparatus according to claim 10, wherein during the image forming operation, said photosensitive member is electrically charged to a predetermined charge potential by electric discharge at a gap between said photosensitive member and said charging member on an upstream side of a contact portion between said photosensitive member and said charging member principally with respect to a surface movement direction of said photosensitive member, and
wherein the second light quantity is larger than the first light quantity.

21. An image forming apparatus according to claim 12, wherein during the image forming operation, said photosensitive member is electrically charged to a predetermined charge potential by electric discharge at a gap between said photosensitive member and said charging member on a downstream side of a contact portion between said photosensitive member and said charging member principally with respect to a surface movement direction of said photosensitive member, and
wherein the second light quantity is smaller than the first light quantity.

22. An image forming apparatus according to claim 12, wherein during the image forming operation, said photosensitive member is electrically charged to a predetermined charge potential by electric discharge at a gap between said photosensitive member and said charging member on an upstream side of a contact portion between said photosensitive member and said charging member principally with respect to a surface movement direction of said photosensitive member, and
wherein the second light quantity is larger than the first light quantity.

23. An image forming apparatus comprising:
a rotatable photosensitive member provided with a plurality of independent recessed portions on a surface thereof:
a driving portion for rotationally driving said photosensitive member;
a charging member, provided in contact with said photosensitive member, for electrically charging said photosensitive member;
a voltage source for applying, to said charging member, a charging voltage for electrically charging said charging member;
an exposure device for exposing, to light, said photosensitive member charged by said charging member to form an electrostatic image;
a developing device for developing the electrostatic image formed on said photosensitive member by said exposure device into a toner image with a toner;
a transfer device for transferring, onto a transfer material, the toner image formed on said photosensitive member by said developing device;
a controller for executing an image forming operation in which the toner image is formed depending on an inputted image signal and then is transferred onto the transfer material which is then outputted and for executing a test operation in which a test image for obtaining information on a remaining lifetime of said photosensitive member is formed and transferred onto the transfer material which is then outputted,
wherein during the image forming operation, said controller causes said driving portion to rotationally drive said photosensitive member at a first speed, and
wherein during the test operation, said controller causes said driving portion to rotationally drive said photosensitive member at a second speed different from the first speed, and applies a charging voltage consisting only of a DC voltage to said charging member to electrically charge said photosensitive member thereby to form the test image.

24. An image forming apparatus according to claim 23, wherein in the test operation, said controller transfers the test image and the charging member test image, formed by rotationally driving said photosensitive member at the first speed, onto a sheet and outputs the sheet.

25. An image forming apparatus comprising:
a rotatable photosensitive member provided with a plurality of independent recessed portions on a surface thereof;
a driving portion for rotationally driving said photosensitive member;
a charging member, provided in contact with said photosensitive member, for electrically charging said photosensitive member;
a voltage source for applying, to said charging member, a charging voltage for electrically charging said charging member;
an exposure device for exposing, to light, said photosensitive member charged by said charging member to form an electrostatic image;
a developing device for developing the electrostatic image formed on said photosensitive member by said exposure device into a toner image with a toner;
a transfer device for transferring, onto a transfer-receiving member, the toner image formed on said photosensitive member by said developing device;
a sensor for a density of the toner image on said photosensitive member or the toner image on said transfer-receiving member; and
a controller for executing an image forming operation in which the toner image is formed depending on inputted image signal and then is transferred onto the transfer material which is then outputted and for executing a test operation in which a test image for obtaining information on a remaining lifetime of said photosensitive member is formed and detects a density of a toner image for the test image by said sensor,
wherein during the image forming operation, said controller causes said driving portion to rotationally drive said photosensitive member at a first speed, and
wherein during the test operation, said controller causes said driving portion to rotationally drive said photosensitive member at a second speed different from the first speed, and applies a charging voltage consisting only of a DC voltage to said charging member to electrically charge said photosensitive member thereby to form the test image, and then outputs a signal for providing notification of information indicating a remaining lifetime of said photosensitive member on the basis of a detection result for the test image by said sensor.

26. An image forming apparatus according to claim 25, wherein in the test operation, said controller forms a comparison test image by rotationally driving said photosensitive member at the first speed and detects a density of a toner image for the comparison test image by said sensor, and then outputs a signal for providing the notification of information indicating the remaining lifetime of said photosensitive member on the basis of a detection result for the test image by said sensor and a detection result for the comparison test image by said sensor.

27. An image forming apparatus according to claim 26, wherein said controller obtains pieces of information on density non-uniformity in the test image and the comparison test image on the basis of detection results for the test image and the comparison test image, respectively, by said sensor, and then outputs the signal for providing the notification of information indicating the remaining lifetime of said photosensitive member on the basis of a difference between the information on density non-uniformity in the test image and the information on density non-uniformity in the comparison test image.

28. An image forming apparatus according to claim 27, wherein the information on density non-uniformity is a value of a density difference between the density for the test image and a reference density for the test image.

29. An image forming apparatus according to claim 25, wherein said controller stores the signal for providing the notification in a storing portion for storing the information indicating the remaining lifetime of said photosensitive member.

30. An image forming apparatus according to claim 25, wherein said controller outputs the signal for providing the notification to an operating portion provided on said image forming apparatus and provides the notification of information indicating the remaining lifetime of said photosensitive member at said operating portion.

31. An image forming apparatus according to claim 25, wherein said controller outputs the signal for providing the notification to a device communicatably connected with said image forming apparatus and provides the notification of information indicating the remaining lifetime of said photosensitive member in said device.

32. An image forming apparatus according to claim 25, wherein during the image forming operation, said photosensitive member is electrically charged to a predetermined charge potential by electric discharge at a gap between said photosensitive member and said charging member on a downstream side of a contact portion between said photosensitive member and said charging member principally with respect to a surface movement direction of said photosensitive member, and
wherein the second speed is higher than the first speed.

33. An image forming apparatus according to claim 23, wherein during the image forming operation, said photosensitive member is electrically charged to a predetermined charge potential by electric discharge at a gap between said photosensitive member and said charging member on an upstream side of a contact portion between said photosensitive member and said charging member principally with respect to a surface movement direction of said photosensitive member, and
wherein the second speed is lower than the first speed.

34. An image forming apparatus according to claim 23, wherein during the image forming operation, said photosensitive member is electrically charged to a predetermined charge potential by electric discharge at a gap between said photosensitive member and said charging member on a downstream side of a contact portion between said photosensitive member and said charging member principally with respect to a surface movement direction of said photosensitive member, and
wherein the second speed is higher than the first speed.

35. An image forming apparatus according to claim 25, wherein during the image forming operation, said photosensitive member is electrically charged to a predetermined charge potential by electric discharge at a gap between said photosensitive member and said charging member on an upstream side of a contact portion between said photosensitive member and said charging member principally with respect to a surface movement direction of said photosensitive member, and
wherein the second speed is lower than the first speed.
